(19) United States
(12) Patent Application Publication
(10) Pub. No.: US 2005/0033777 A1
(43) Pub. Date: Feb. 10, 2005

(54) Tracking, recording and organizing changes to data in computer systems

(76) Inventors: Mark A. Moraes, San Franciso, CA (US); James R. Soss, San Francisco, CA (US)

Correspondence Address: Mark A. Moraes, 280 Collingwood St., San Francisco, CA, 94114, US

(21) Appl. No.: 10/635,041

(22) Filed: Aug. 4, 2003

(51) Int. Cl. G06F 17/30

(52) U.S. Cl. 707/202

(57) ABSTRACT

A change tracing system detects and records changes made to data items by processes in a computer system. Processes and changes are organized as change sessions in a change history database and tagged with user-provided reasons and other identification fields. A query module provides detailed access to change history and selection of specific changes and items in order to analyze effects of changes, diagnose problems caused by changes, compare changes and change history, rollback from changes to previous item contents or package sets of changes to be repeated. Linkage between data items is recorded in order to document the impact of changes affecting dependent data items. Alerts and copies of change sessions may be transmitted automatically to designated users. Communication between change tracing systems running on networked computers detects and records remotely caused changes on the system where the data item resides as well as the system originating the change.

### COPYRIGHT STATEMENT

A portion of the disclosure of this patent document contains material subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright 2003, Pointrex Inc, All Rights Reserved.

### BACKGROUND OF INVENTION

1. Field of Invention

This invention relates generally to the management of digital computer systems, specifically to detecting and recording changes to data in such systems.

2. Prior Art

The functioning of hardware and software of modern digital computer systems is controlled by the values of a large number of data items or elements. There are typically tens of thousands to hundreds of thousands of such data items on any individual system. Any set of values of such data items is referred to as a configuration of the system. Configuration data item values represent the operating parameters of the hardware and software, stored collectively or individually in files or structured data formats on non-volatile storage media or in volatile memory. Values are encoded in many ways, typically as text strings or numbers, but also as complex sequences of data whose specific interpretation is determined by conventions and rules. Values vary in size and may directly or indirectly refer to other items.

Data items are sometimes organized in databases for easier access and efficient storage. Items are often grouped hierarchically for ease of management and reference. For example, all items referring to a particular function for a specific software component may be found in a single file. Many such files representing items controlling different functions in different but related software components may be grouped together in a single directory or folder.

Modification of existing item values, renaming or modification of item names, addition of new items, deletion of existing items or re-organization of the hierarchical structure of the items effect changes to system configuration. Software tools, either directly under control of a human administrator or indirectly using schedules or other rules to trigger the change, make these changes. These changes all constitute system management activity. Changes are made to improve system performance, fix problems with software, install new software, remove old software, or change system behavior in various desired ways.

Some changes result in undesired side effects or do not achieve the desired effects because of the complexity, variety and large number of items as well as the interdependencies and relationships between items. When multiple system administration personnel are working on the same systems, as happens in many computing environments, it is often unclear who made any particular change, or what logical high-level requirement or operation the change was part of. Therefore, organizations responsible for management of systems typically have guidelines, procedures and documentation to ensure that system administrators make changes to system configuration carefully and systematically. Undesirable changes are also sometimes made by unauthorized personnel or by intruders.

When a system exhibits undesirable behavior, a critical step in diagnosis of the source of such problems is an understanding of the history of changes made to the system's configuration items before the undesirable behavior is noticed. No tools exist that can provide access to a history of system configuration item changes automatically, organized with reasons for making the changes recorded as the changes occur.

Traditional change detection applications use periodic, after-the-fact snapshots, audits or backups of the values of a set of configuration files. In order to determine changes made to the system, system administrators have to compare various snapshots in sequence. Such comparison is time-consuming and tedious. Further, the storage of snapshots consumes considerable storage, since the storage required by any snapshot is proportional to the number of files being examined. Such snapshots also provide no differentiation between changes made by authorized and unauthorized personnel.

A manual process for recording changes uses version control systems such as Revision Control System (RCS), described in “RCS—A System for Version Control”, by Walter F. Tichy, Software—Practice & Experience, 1 5, 7 (July 1985). System administration personnel check-in or store a copy of any file in RCS before making any changes to the file as well as after making changes. RCS permits comments to be added with each check-in, to identify the reason for the change, and stores only the differences between copies of the files, for storage efficiency. This approach relies on system administration personnel knowing all the files that they are about to change before performing an administrative operation (such as upgrading or installing software), which is often impractical, since changes are often made via software tools that change many different files simultaneously. Since this approach records both the comments and the history of changes for any file in an associated history file, the only query and analysis capability is by raw text searches of the history files.

Tripwire, described in “The Design and Implementation of Tripwire: A File System Integrity Checker” by Gene H. Kim and Eugene H. Spafford, Purdue Technical Report CSD-TR-93-071 describes one of the earliest snapshot tools that uses signatures to identify changes in files by comparing a snapshot of file signatures with a previous “good” snapshot. Snapshot-based approaches have several disadvantages: first, creating a snapshot involves examining every file and computing its signature, an expensive and time-consuming operation. Since most computer operating systems are optimized to handle the common case where a small number of files is accessed frequently, and cache such files, a snapshot scan usually disrupts the cache activity since it scans all files, thus interfering with other activity on the machine. Some snapshots only record signatures, which show that a file changed but provide no information about the nature of the change. Another disadvantage is that all changes that occur between two snapshots are identified when the second snapshot is taken, but little or nothing is known about the sequence of those changes or any logical grouping of those changes. While one may assume that all changes taking place within a particular time interval like a few minutes are related, it is hard to categorize the activity without further information. For example, a bug-fix made by one system administrator to some piece of software may change many files, and a subsequent performance enhancement implemented by another system administrator to the same software may change some of the same files. Since snapshots are expensive in CPU and disk access when generated, creating or verifying them more frequently is often not practical. The storage cost of a snapshot or backup grows linearly with the number of files, and it is not practical to either backup or check a large number of files frequently. Therefore, such snapshots and checks would need to be restricted in number of files or frequency of check. Further, extracting information about the history of changes to a specific file from a series of snapshots is also an expensive operation in terms of computation and storage. Therefore, little or no history is available to determine how different changes to the same or related files at various times may have brought about a problem. There is no easy way to discriminate between authorized and unauthorized changes to configuration files, since all changes taking place between any two snapshots are reported together after the later snapshot.

Some change detection applications provide the operating systems with lists of specific directories or files and wait for the operating system to provide notification of changes to those files or files within those directories. U.S. Pat. No. 5,287,504 to Carpenter (1994) describes a File Alteration Monitor, in which client software may subscribe to a server to receive on-the-fly notice as files change. File Change Notification in Windows 95® accepts a list of files or registry entries to be monitored for changes. Such systems require knowledge of all files or registry entries to be changed before the change is made so that they can be monitored continuously for change. The performance of the system decreases as the number of files or registry entries being monitored grows—in fact, many such approaches limit the number of monitored files. System performance suffers all the time since such monitoring must be continuously on, and every system operation must be compared against the list of watched files. Such detection mechanisms do not maintain any history or logical organization of changes, they only provide notification of changes.

U.S. Pat. No. 6,189,016 to Cabrera (2001) describes a change journal for recording changes to files in a storage volume. Such a change journal describes a change session as a history of all changes made to a file between two selected events or conditions, with change records that record the source, transaction, update sequence number, change reason code and source history. However, system administrators may perform operations on computer systems that result in related changes to many files and frequently desire all such changed files to be grouped in a single session. Further, multiple system administrators working on the same system may make different changes in overlapping time periods that might be considered different change sessions. Further, changes for system configuration happen to different files within a storage volume, and recording everything within a storage volume may produce a large amount of file change to unrelated files.

None of the systems described in the prior art provide sufficient information in an environment where computers are networked or connected to remote computers by means of local area network connections or wide-area network connections, and one computer triggers or causes changes on another remote computer. Such remote change is commonly caused by software distribution systems used for sending and receiving software updates over a network. Some systems in prior art such as that in U.S. Pat. No. 5,287,504 to Carpenter (1991) only generate local change events even for remote files accessed from a different computer over a network. Further, none of the systems in prior art consider the interdependency or linkage between data items and take into account the impact of changes to such linked data items.

### Objects and Advantages

There remains a need for a more efficient and accurate approach that detects and records changes across all types of data items as they happen rather than after the fact, and automatically organize and group such changes according to higher-level operations being performed by the system administrator or user of this approach. For efficiency, additional processing must not be continuously required of the computer system except when changes are actually being made. To facilitate trouble-shooting and analysis of computer system operation, users need a flexible capability to search for specific changes based on arbitrary user-specified combinations of attributes such as the time of change, the type of change, the logical operation that caused the change, user-specified tag information associated with the logical operation (e.g. descriptive, authorization and authentication), the items that changed, or the actual content that changed within the configuration data item. If a computer causes a change on another remote computer, it is highly desirable for the remote computer being changed to record the history of the changes that affect it, as well as for the originating computer to record that it initiated such changes. If data items are linked or interdependent, it is important that such linkage be detected and changes to linked data items and the resulting impact or propagation of effect be recorded. Still further objects and advantages will become apparent from a consideration of the ensuing description and drawings.

### SUMMARY OF THE INVENTION

The present invention provides a system for determining and recording relevant changes made to data items in a computer system by tracing the activity of user-selected processes executing on that system. These traced changes are automatically organized in a change history according to the process that caused them and can also be automatically organized in logical groups or sessions by the user of the invention and annotated with user-provided information to permit correlation of such changes with external organizational procedures. The invention detects and records linkage or dependencies between data items as well as changes to such linkage, therefore it is capable of detecting, recording and reporting the impact of such changes as propagated via the linkage. The invention is very efficient as it is only activated when the user initiates a change session, and turns itself off when the user ends the change session. Since the invention traces and records all authorized and documented changes, it can easily and accurately identify and highlight any changes made outside defined organizational procedures by periodically scanning data items for all changes that are not made as part of traced change sessions. The invention provides a powerful query capability to search for changes that match user-provided parameters and boolean logical conditions on any data or metadata attributes of the items and changes were recorded. Changes selected by this query capability can be diagnosed, compared, reversed or repeated predictably and accurately on other systems. Alerts may be sent automatically to users of the invention whenever changes are detected that match user-specified conditions. The invention interconnects across a plurality of computer systems connected by a network and detects and records changes that are either pushed from one system to another, or pulled by one system from another, such that the history of changes on a computer is clearly identified with the source of such changes.

An example embodiment of the present invention is implemented under the UNIX® operating system and some similar systems such as Solaris® and Linux®. UNIX is a registered trademark of X/Open Co., Ltd. Solaris is a registered trademark of Sun Microsystems, Inc. Details of the UNIX® and similar systems are given in the references listed below, which are incorporated by reference as if fully set forth herein.

Bach, Maurice J., “The Design of the UNIX Operating System”, Prentice-Hall Software Series, Englewood Cliffs, N.J., 1986. Section 2.2.1 “An overview of the File Subsystem” and Section 2.2.2, “Processes” define key concepts in the operating system environment. Chapter 5 “System Calls for the File System” further describes how files are created and modified as well as file system abstractions to refer to other forms of data. Section 6.1 “Process States and Transitions” and Section 6.4.2 “System Call Interface” further describe the essentials of the interactions between processes and the operating system kernel. Chapter 11 “Interprocess Communication” describes communication between processes and computers.

Vahalia, Uresh, “UNIX® Internals: The New Frontiers”, Prentice-Hall, 1996. Chapter 2 “The Process and the Kernel” describes the essentials of the interactions between processes and the operating system kernel.

Bovet, Daniel P., and Cesati Marco, “Understanding the Linux Kernel”, 2nd Edition, O'Reilly, December 2002. Section 1.5 “An overview of the Unix filesystem”, Chapter 3, “Processes”, Chapter 9, “System Calls” describe the related concepts for the Linux™ operating system.

An example embodiment of the present invention is also implemented under the Windows® operating system. Windows® is a registered trademark of Microsoft Corporation. Details of the Windows® system are given in the references listed below, which are incorporated by reference as if fully set forth herein.

Solomon, David A. and Russinovich, Mark E., “Inside Microsoft® Windows® 2000, Third Edition”, Microsoft Press, 2000. FIG. 3-10 and the associated text in Chapter 3 illustrate system service dispatching and the kernel API call, and the section on Object Names starting on page 146 describes the hierarchical naming convention or namespace used for all objects or data items. In Chapter 5, “Management Mechanisms”, the first section titled “The Registry” starting on page 215 describes the structure and concepts of the Windows™ registry.

### BRIEF DESCRIPTION OF DRAWINGS

FIG. 1 shows a diagram of the hardware and operating environment in conjunction with which the embodiments of the invention may be practiced.

FIG. 2 shows an example of an operating system process environment within which the embodiments of the invention may be operated.

FIG. 3A and FIG. 3B illustrate the interaction of an example embodiment of the invention within an operating system process environment.

FIG. 4 illustrates the interaction of an example embodiment of the invention with remotely accessible storage.

FIG. 5 illustrates the interaction of an example embodiment of the invention with a remote operating system process environment.

FIG. 6 shows the modules of one example embodiment of the invention and the messages used to communicate with other instances of this embodiment.

FIG. 7 illustrates an example embodiment of the database tables according to the example embodiment of FIG. 6.

FIG. 8 is a simplified flow chart describing the configuration module according to the example embodiment of FIG. 6.

FIG. 9, FIG. 10, FIG. 11, FIG. 12, FIG. 13 and FIG. 14 are simplified flow charts describing one example embodiment of the observer module according to the example embodiment of FIG 6.

FIG. 15, FIG. 16 and FIG. 17 are simplified flow charts describing one example embodiment of the recorder module according to the example embodiment of FIG. 6.

FIG. 18 is a simplified flow chart describing one example embodiment of the query module according to the example embodiment of FIG. 6.

FIG. 19, FIG. 20, FIG. 21, FIG. 22, FIG. 23, FIG. 24, FIG. 25, FIG. 26, FIG. 27 and FIG. 28 are simplified flow charts describing one example embodiment of the session module according to the example embodiment of FIG. 6.

### DETAILED DESCRIPTION

Preferred Embodiment

In the following detailed description of the preferred embodiment of the present invention, reference is made to specific embodiments in the accompanying drawings. Structural changes may be made and other embodiments may be utilized without departing from the scope of the present invention.

Hardware and Operating Environment

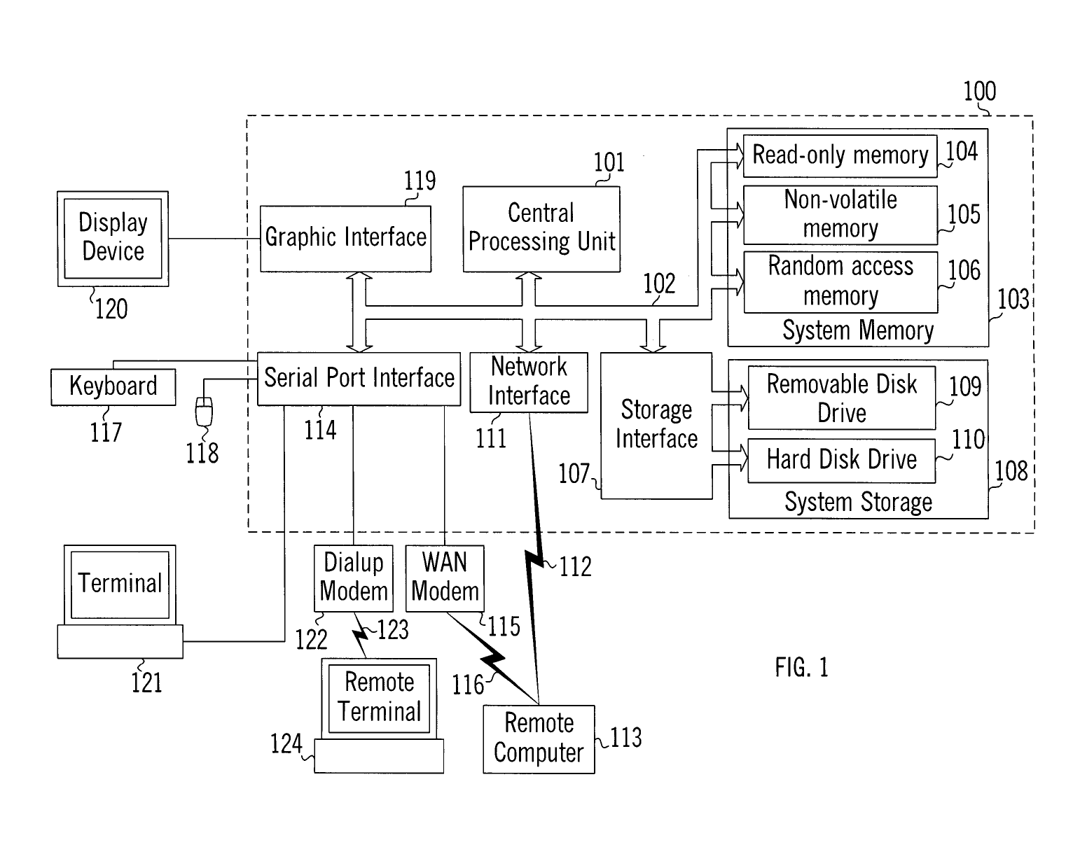

FIG. 1 shows a diagram of an example of the hardware and operating environment in conjunction with which the embodiments of the invention may be practiced. The description of FIG. 1 is intended to provide a brief description of a suitable computing environment in conjunction with which the invention may be implemented. Although not required, the invention is described in the general context of computer-executable instructions, such as program modules being executed by a computer. Generally, such modules include functions, subprograms, data structures, objects, records, algorithms, data formats, indices, tables, etc. that implement particular abstract data types and operations.

The invention may be practiced with other computing environments, including portable devices, multi-processor systems, programmable logic devices, personal computers, midrange computers, mainframe computers, embedded microprocessors within controllers for applications such as network routing, and the like. The invention may be also be practiced in distributed or networked computing environments where tasks are performed by remote processing devices that are interconnected through one or more data communications networks. In such environments, program modules may be located in both local and remote memory storage devices.

The hardware and operating environment illustrated in FIG. 1 includes a general-purpose computing device in the form of a computer system 100 including a central processing unit 101, linked by a system bus 102 to system memory 103. The present invention is not limited to this specific configuration. The computer system 100 may contain a plurality of processing units and system memory components, interlinked by one or more than one system bus. In this example, system memory 103 includes read-only memory (ROM) 104, non-volatile memory (NVRAM) 105 and random access memory (RAM) 106. The ROM 104 typically contains a basic input/output system (BIOS) for transferring data between components of the computer system 100 and the NVRAM 105 typically contains parameters that control the operation of the BIOS and operating system. The central processing unit 101 communicates via the storage interface 107 to system storage 108, which consists of a removable disk drive 109 and a hard disk drive 110. Instructions from program modules contained within system storage 108 are loaded into RAM 106 and then executed by the central processing unit 101 to access data from system memory 103 and system storage 108. A plurality of system storage devices may be used in the exemplary operating environment and that any media which can store data that is accessible by a computer, such as flash memory cards, magnetic cartridges, optical disks etc. may be used instead of the devices shown without departing from the scope of the present invention.

The system bus 102 also connects to network interface 111, which is attached to local area network link 112. The computer 100 may connect via such a network link to one or more remote computers, such as remote computer 113 shown in the exemplary operating environment. Such remote computers will typically include many or all of the elements described as part of computer 100 and are not limited to the specific configuration described here. Such network communications is typically bi-directional in that either computer 100 or remote computer 113 may initiate communication. Office networks, intranets, extranets, the Internet are all forms

Another form of network connection is via the serial port interface 114, which can be used to interconnect to a wide-area-network (WAN), typically using a WAN modem 115 attached to a WAN link 116 to also interconnect to remote computer 113. It will be appreciated that either or both of the LAN and WAN links may be used to communicate between computer 100 and remote computer 113. Communications programs may be used to access the computer 100 from remote computer 113. Also, remote storage or memory on the remote computer 113 may be presented or mounted with the appearance of local storage on the computer 100, such that programs executing on computer 100 may transparently access data stored on the remote computer 113. Such networking environments are common in office networks, intranets, extranets, the Internet and other types of networks. It will be appreciated that the exemplary network connections shown are not the only ones available and that the scope of the present invention is not limited to a particular form of communications device or network connection.

Users of the computing environment may interact with the computer 100 via keyboard 117, mouse 118, and a graphic interface 119 connected to a display device 120. Users may also interact with the computer 100 via a terminal 121 directly connected to the serial port interface 114. Another form of interaction is provided by a dialup modem 122 connected to a dialup network 123 which can be accessed by users on a remote terminal 124. One or more of these methods of user interaction may exist, and many users may interact simultaneously with computer 100. Communications software running on remote PCs may be used as remote terminal emulators instead of remote terminal 124. Other forms of interaction may include console teletype, keypads, magnetic and optical card readers, pens, handwriting recognition systems, voice recognition systems or other command protocols communicated to computer 100, etc. The form of interaction that users may use does not limit the present invention.

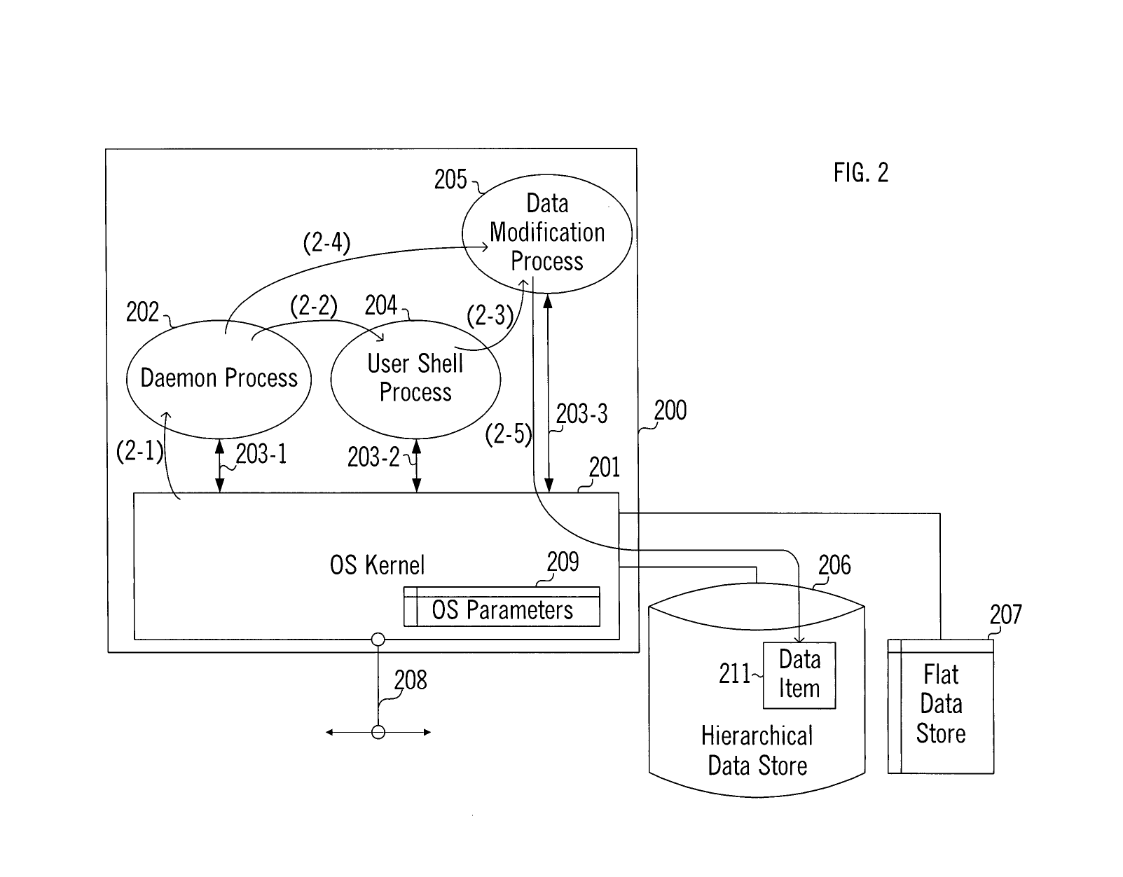

In the exemplary operating environment of FIG. 1, the operating system (OS) is one of the first program modules loaded into system memory when the computer 100 starts up and thereafter controls all the subsequent operation of the environment by creating a process environment within which other program modules may execute. FIG. 2 illustrates this OS process environment 200. A process refers to an executing instance of program modules, libraries, subroutines, subprograms etc. within the OS process environment 200. After startup, the OS kernel 201 constructs logical abstractions representing the physical computer components earlier described in FIG. 1. System storage 108 is represented as either a hierarchical data store 206 or a flat data store 207. Modern OS kernels (e.g. UNIX®, Windows®, Solaris®, Linux®, other POSIX® compliant systems) support many forms of hierarchical data store 206 including filesystems containing data items such as directories and files within the directories, web sites with a hierarchy of Uniform Resource Locators, databases containing tables and records within the tables, registry hives containing keys and entries within keys, Lightweight Directory Access Protocol (LDAP) or other directory service information stores, structured configuration files containing sections and configuration entries within sections (INI files, XML files), lists of local or remote services, processes or users, etc. The example embodiment is described in terms of directories and files within filesystems, but it works equally on databases or registry hives, and is not limited in scope only to these forms of hierarchical data store. Modern OS kernels support many forms of flat data store 207, such as the BIOS parameters stored in NVRAM 105, the structured contents of configuration files used by program modules for modifying the behavior of applications, the raw physical data blocks on removable disk drives 109 or other forms of storage media like cartridges, tapes etc. One or more physical network links 112 or 116 may be represented as a logical network interface 208 from which, for example, the OS kernel may receive commands from a remote user or program module. The configuration of the logical abstractions presented by OS kernel 201 is controlled by a set of OS parameters 209. The example embodiment of the present invention uses a naming convention to treat any element of the hierarchical data store 206, flat data store 207, or OS parameters 209 as a data item 211, shown in this exemplary OS process environment within the hierarchical data store. The scope of the present invention is not limited only to data items within the storage forms shown in the example embodiment and that any identifiable element or object may be treated as a data item, organized if necessarily as virtual filesystems or namespaces.

Once the OS kernel 201 has started up and created various logical abstractions, the OS begins loading program modules from either system storage 108 or from any of the network interfaces represented by 208 and executing these modules as processes, transparently managing the sharing of the resources of computer 100 across all concurrently or sequentially executing processes. Executing processes access the OS kernel by means of a system call API which provides the means by which any process within the operating system process environment requests and receives data from the OS kernel and utilizes the various logical abstractions presented by the OS kernel. An example of a common sequence of operations is shown beginning with step 2-1 in which the OS kernel starts a daemon process 202 which communicates with the OS kernel over a system call application program interface (API) 203-1. Using the system call API 203-1, in step 2-2, daemon process 202 may start a user shell process 204, which provides interactive command services to a user. The user shell process 204 uses system call API 203-2 to interact with the OS kernel 201 to receive user data, perform data access and start other processes. In step 2-3, the user shell process 204 starts a data modification process 205, which uses the system call API 203-3 to communicate with the OS kernel. An alternative step 2-4 shows the data modification process 205 being directly started by the daemon process 202. The data modification process 205 proceeds in step 2-5 to make changes to data item 211 via the system call API 203-3.

Change Tracer

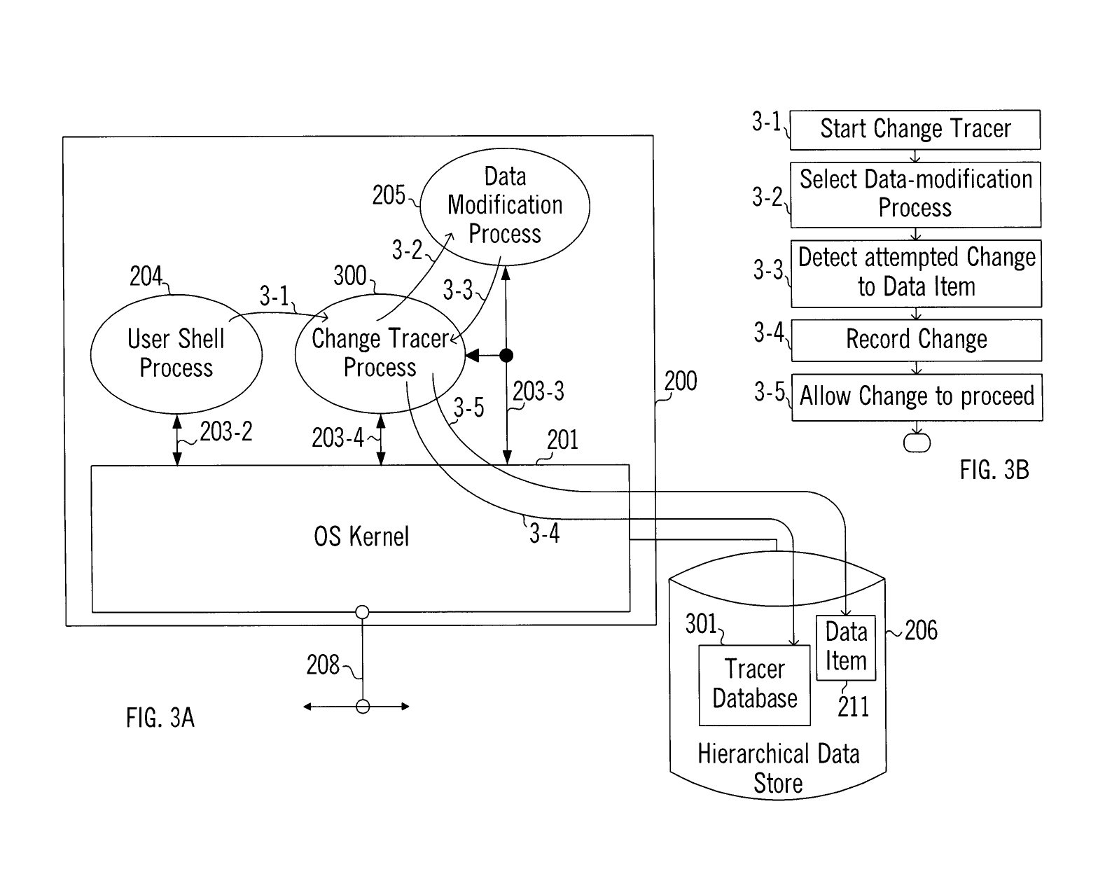

FIG. 3 through FIG. 5 provide an overview of an example embodiment of the present invention and its operation within an exemplary operating system process environment. Referring to FIG. 3A and the accompanying flow chart in FIG. 3B, an example embodiment of the present invention is shown within a process environment similar to the one described previously in FIG. 2. The example embodiment of the present invention is referred to in this description as a change tracer and represented as a change tracer process 300, which is started in step 3-1 by the user shell process 204 as a wrapper around the data modification process 205. Next, in step 3-2, change tracer process 300 uses system call API 203-4 to start data modification process 205. The change tracer process 300 then sets itself up to receive notifications of any system call activity by the data modification process 205 via system call API 203-3. Since all changes made to the exemplary operating environment by data modification process 205 happen through the system call API 203-3, tracer process 300 has the unique ability to observe in step 3-3 the change that the data modification process 205 attempts to make to data item 211. The change tracer process 300 permits the change to happen in step 3-5 and records the change to its change tracer database 301 in step 3-4. The change tracer database 301 is part of the example embodiment of present invention. While this sequence is representative of a wide range of common tasks within the exemplary operating environment and the present invention is described in terms of a process executing within the operating system environment and interacting with the operating system via an system call API, the scope of the present invention is not limited to only such interactions. The present invention may be used in operating system environments with different process models or operating system interface models, as part of the OS kernel, embedded within a BIOS or outside an operating system process environment without departing from the scope of the invention.

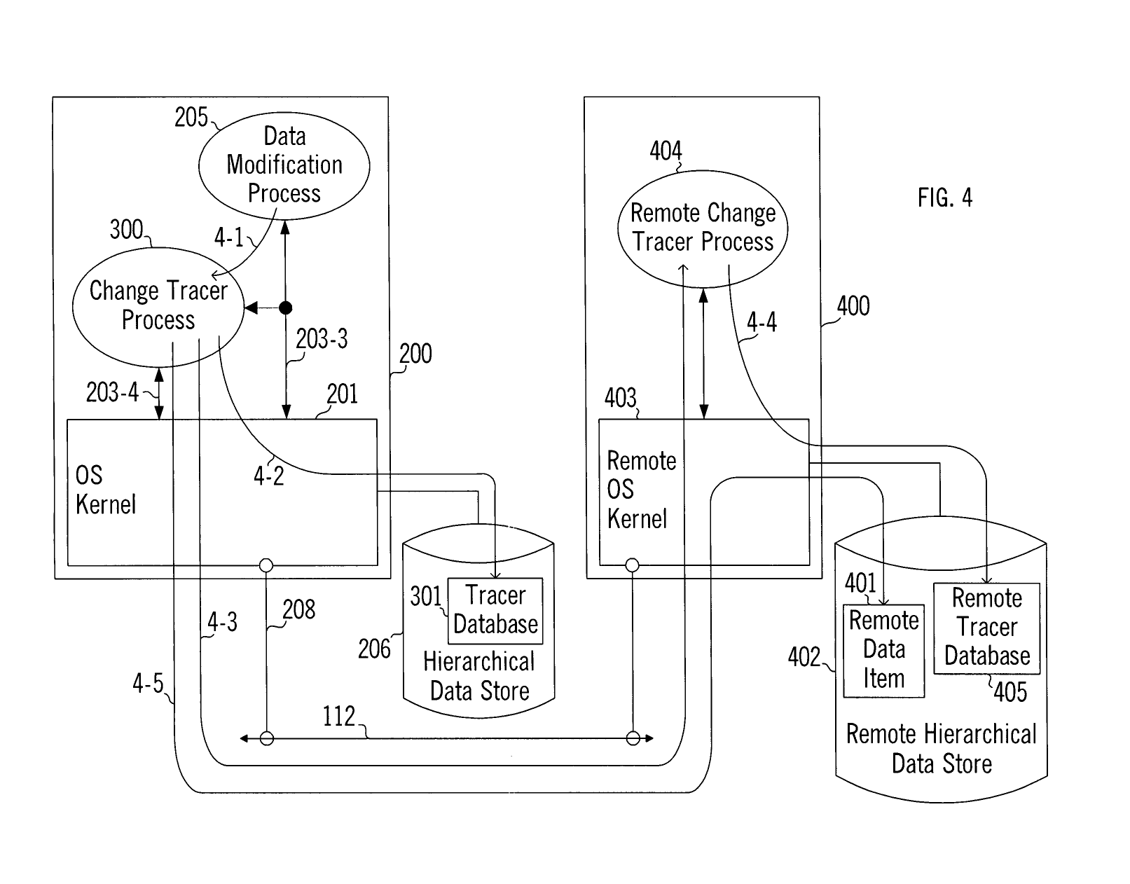

FIG. 4 illustrates the interaction of an example embodiment of the invention with remotely accessible storage in a remote operating system process environment 400 which would typically run on a remote computer 113 as illustrated in FIG. 1. An alternative term of art used to describe a remote operating system process environment is remote host. A remote data item 401 in the remote hierarchical data store 402 is presented by remote OS kernel 403 to the OS kernel 201 over the logical network interface 208 and LAN link 112, such that remote data item 401 is accessible to processes executing within the OS process environment 200. In step 4-1 of the illustrated interaction, data modification process 205 in the OS process environment 200 attempts to modify the remote data item 401. In step 4-2, the change tracer process 300 is showing recording this remote data modification attempt in its change tracer database 301. Next, in step 4-3, change tracer process 300 notifies a remote change tracer process 404 running in the remote operating process environment 400 about the attempted change to remote data item 401. The remote change tracer process 404 records the change in its remote change tracer database 405 in step 4-4. The change tracer process 300 permits the change to proceed in step 4-5 which may happen either sequentially after or concurrently with steps 4-3 or 4-4. Communication between the change tracer process 300 and remote change tracer process 404 is symmetric and bi-directional. The interaction shown in FIG. 4 is typical of a wide range of common tasks but that the scope of the invention is not limited to only such interactions. Remote computing environments of all kinds, whether they are servers, desktops, clusters of distributed nodes, network nodes, embedded devices, etc. are all covered in the scope of the present invention. The present invention is not limited if remote operating system environment has a flat data store instead of a hierarchical data store, or some other form of data item. The present invention works whether there are one or more than one remote computer involved in remote access and multiple remote accesses take place sequentially or concurrently.

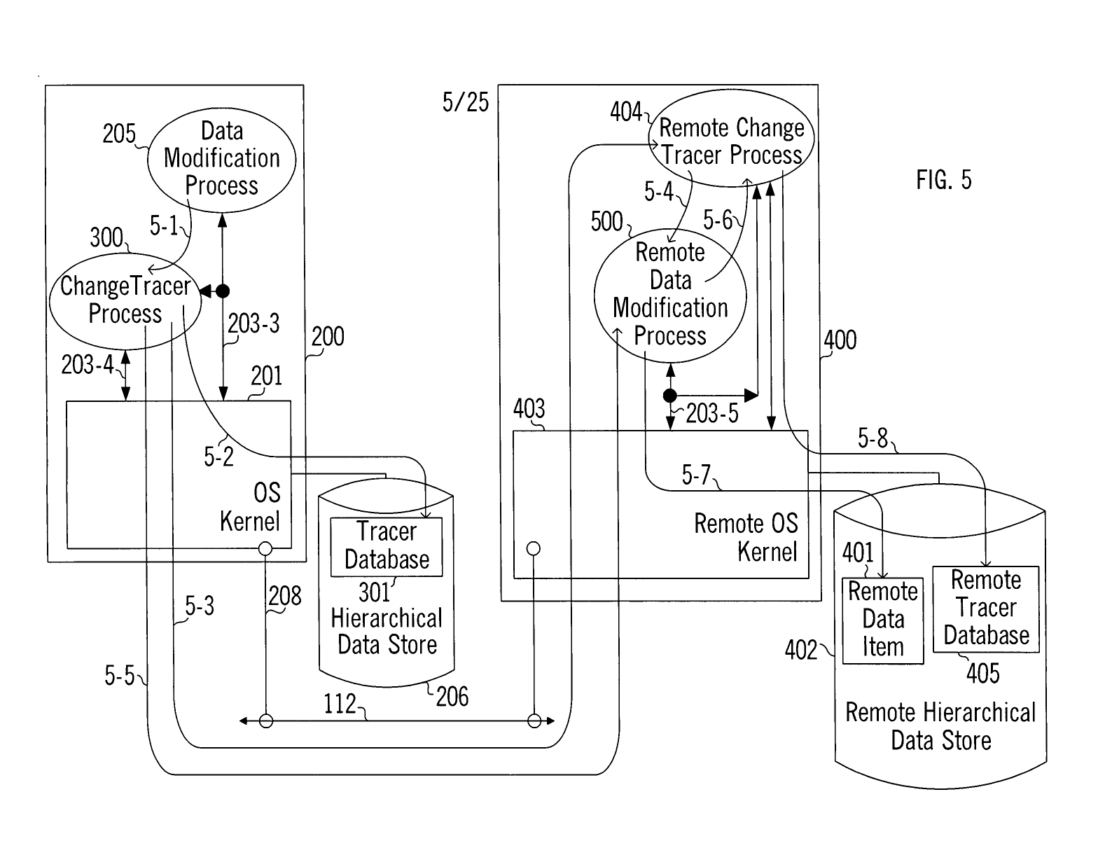

Referring to FIG. 5, an exemplary environment is shown where the data modification process 205 communicates with a remote data modification process 500 executing within the remote operating system process environment 400. In step 5-1, data modification process 205 attempts a communication to remote data modification process 500, which is observed by change tracer process 300. The change tracer process 300 records this remote change initiation in its change tracer database 301 as step 5-2 and then, in step 5-3, notifies remote change tracer process 404 of the communication attempt. The remote change tracer process 404 locates the remote data modification process 500 and sets itself up in step 5-4 to receive notifications of any of remote data modification process 500's system call API activity 203-5. Either sequentially after or concurrently with steps 5-3 and 5-4, change tracer process 300 permits the communication attempt to continue in step 5-5. As a result of this communication, remote data modification process 500 attempts to modify remote data item 401. This attempt is reported to remote change tracer process 404 in step 5-6. The remote change tracer process 404 permits the change to continue in step 5-7 while recording the change in its remote change tracer database 405 in step 5-8. Depending on the details of the underlying operating system process environment, steps 5-7 and 5-8 may occur sequentially, concurrently or their order may even be reversed within the scope of the present invention.

Terms like change tracer process, change tracer database and operating system process environment in FIG. 4 and FIG. 5 are used from the point of view of operating system process environment 200 and change tracer process 300. If one were to consider FIG. 4 and FIG. 5 from the perspective of remote change tracer process 404 executing in operating system process environment 400, then the roles and the term “remote” would be reversed, such that change tracer process 300 would be considered a remote change tracer process as seen by a change tracer process 404. This symmetry means that the same program modules implementing the example embodiment of the present invention may execute on multiple remote computers to form a distributed change tracer system within the scope of the present invention. The reports or messages exchanged by different change tracers in a distributed change tracer system are referred to as remote change tracer activation, distributed change tracer activation or dynamic distributed change tracer activation in the example embodiment of the present invention.

The form of remote change tracer activation described in the example embodiment of the present invention is not limited only to the illustrated example and that such remote change tracer activation can be implemented in all kinds of networked, clustered, distributed or parallel computing environments executing on any computing device across any form of communicative coupling.

Change Tracer Structure and Organization

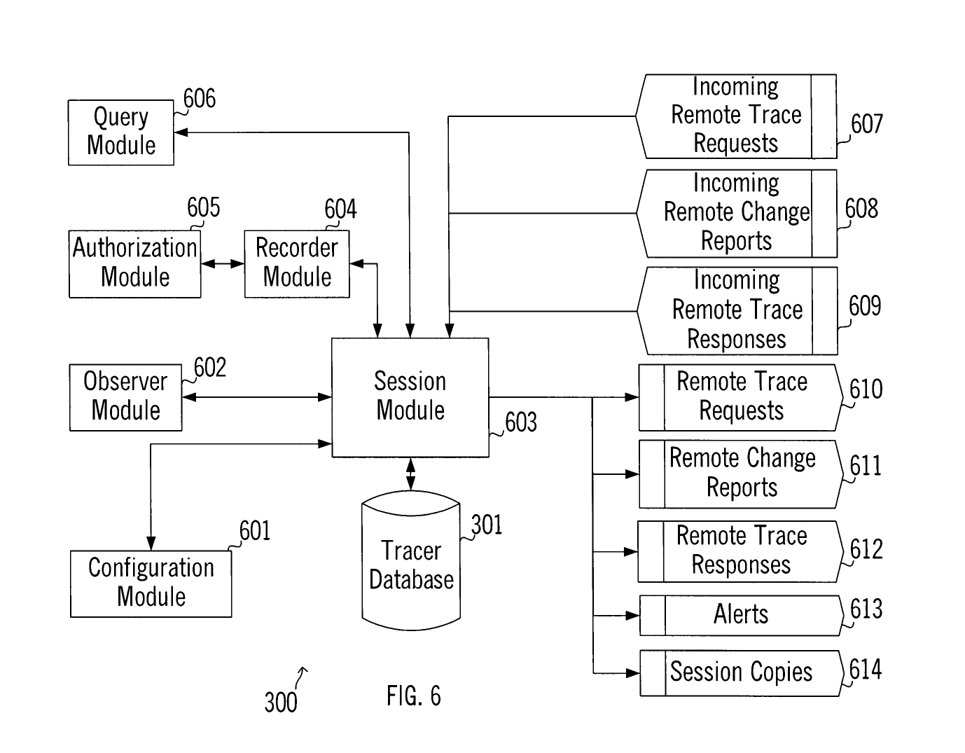

FIG. 6 through FIG. 29 provide a detailed specification and structure of an example embodiment of the invention. Referring to FIG. 6, there is shown in simplified form a block diagram of an example embodiment of the change tracer 300 according to the present invention, storing change records in change tracer database 301. The configuration module 601 determines the values of several variable parameters that control the functioning of the change tracer 300, particularly the set of data items that the change tracer 300 is attentive to and rules that determine actions that the change tracer 300 should invoke when certain changes are detected in specified data items. The observer module 602 is used to observe initial baseline values of the set of data items that the change tracer 300 is attentive to. In the present embodiment, the observer module 602 may also be executed periodically to determine if changes outside the change tracer have been made to any specified data items. The baseline values of data items and any changes outside the change tracer are reported by the observer module 602 to a session module 603, which organizes all changes to data items into change sessions and is responsible for all transactions required to store and retrieve change session data from the change tracer database 301 in the example embodiment of the present invention. Alternative embodiments possible within the scope of the invention could include different modules communicating directly with the database, partitioning the database across various modules, etc.

A recorder module 604 attaches to user-specified processes within the operating system process environment 200 and traces all system call activity of those processes that might create, modify or delete any data items in any way. Before starting any traces, the recorder module 604 validates with authorization module 605 that the processes being traced fall within the defined policies for the change tracer 300. The recorder module 604 analyzes the traced system call activity, determines what changes are made to data items and reports those changes to the session module 603 which organizes these changes into change sessions and performs all transactions required to store and retrieve data from the change tracer database 301.

A query module 606 is provided so that users of the invention have the capability to examine the history of changes recorded in the change tracer database 301 via the session module 603. The query module 606 provides a flexible query language for users to construct complex and detailed queries from combinations of boolean logical conditions on any attribute of the data items recorded in the change tracer database 301 as well as the capability to store and re-use previously stored queries. The transparent recording of changes by the change tracer and the powerful diagnostic and analytic insight into change history made available for query are uniquely useful in managing the computer system 100.

In the example embodiment, communication between the session module 603 and all other modules is described using messages and responses between the various modules. Such messages may be implemented as function calls within a single process or with any form of multi-threaded or multi-process message protocol using any form of inter-process communication without departing from the scope of the invention. Such messages may be compressed, encrypted, digitally signed, integrity-checked or formatted in many ways without departing from the scope of the invention. Messages may comprise multiple sub-messages and replies. Embodiments of the present invention may permit or require multiple instances of various modules that run concurrently or sequentially using widely understood synchronization and inter-process communication models. The example embodiment of the present invention permits users to invoke the modules directly by interactive command, graphical user interface and scheduled or batch command execution facilities. Different architectural models and user-interface may be used for embodiments of the present invention without departing from the scope of the invention.

The session module 603 is capable of receiving communications in the form of incoming remote trace requests 607, incoming remote change reports 608 and incoming remote trace responses 609 from any other change tracer process e.g. (4-3) previously shown in FIG. 4 or (5-3) in FIG. 5. Remote trace requests 610 are sent from the session module 603 to other remote change tracer processes such as 404 in FIG. 5 whenever a process 205 being traced attempts communication to a remote operating system environment 400. These remote trace requests result in recorder module activation within the remote change tracer processes 404 to follow remote data modification processes such as 500 in FIG. 5. Such remote recorder modules create remote change sessions within remote change tracer databases such as 405 to record changes to remote data item 401 in FIG. 5. Remote change reports 611 are sent to other remote change tracers by the session module 603 whenever a traced process 205 changes a remote data item 401 as in FIG. 4. Such remote change reports 611 cause remote session modules in remote change tracers such as 404 in FIG. 4 to create remote change sessions within remote change tracer databases such as 405 in FIG. 4 to record the changes to remote data item 401. Remote trace responses 612 are sent whenever a trace requested by a prior incoming remote trace request 607 is saved or committed to the change tracer database 301 and contain statistics about the trace.

Whenever certain rules determined by the configuration module 601 are detected in a change session by the session module 603, associated alert actions are triggered by those rules. Such alert actions may include the transmission of e-mail, Simple Network Management Protocol (SNMP) trap messages, the execution of specified program modules on the computer that take corrective or diagnostic action, etc. Based on certain rules, the session module 603 can also transmit changes as session copies 614 to specified destinations, using various data transmission protocols and formats like e-mail, file transfer, or network transmission. Such alerts 613 and session copies 614 provide effective ways for the present invention to be integrated with other software like network management or workflow management tools used to control and maintain computers and networks.

Change Tracer Database Organization and Schema

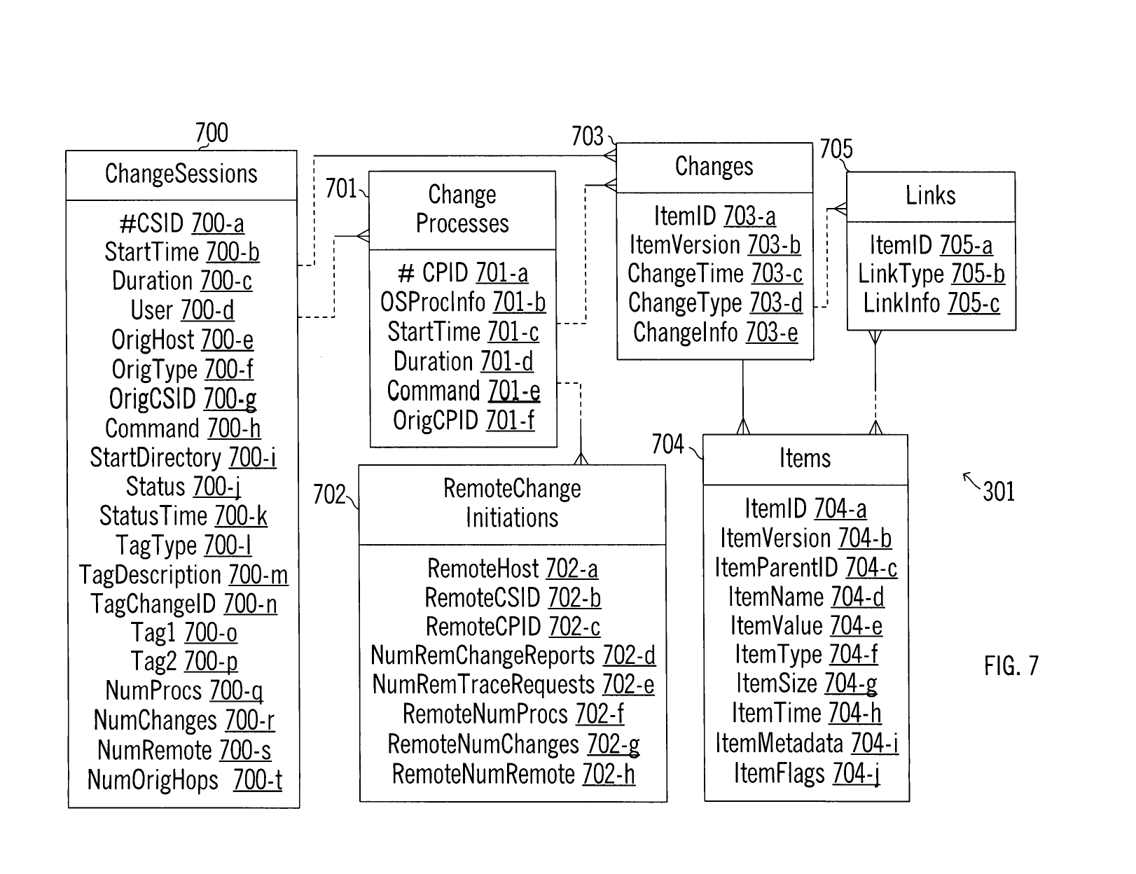

FIG. 7 illustrates in simplified entity-relationship form the organization of the change tracer database 301 in an example embodiment of the present invention. The organization of change tracer database 301 is described in relational database terms using tables and records, but the entities and relationships described can be implemented using many other kinds of persistent data storage e.g. object databases, object relational databases, persistent object stores, in-memory data storage within the scope of the present invention. A record, as used herein, may refer to either a record within a table in a relational database as in the example embodiment of the present invention, or an entry or object within other forms of data storage representation such as object databases or key-value data store in other possible embodiments of the present invention. Unique record keys for tables, prefixed by “#”, and foreign keys to implement relationships within tables are only explicitly shown in FIG. 7 if they are explicitly used in the detailed description of the example embodiment of the present invention, but those skilled in the art will recognize that additional unique record and foreign keys will be necessary for many database implementations without departing from the scope of the present invention. Attributes or fields with the same name in different tables contain the same type of information in every table in which they appear, but their names refer uniquely to the table in which they are shown.

Records in a ChangeSessions table 700 each represent a single change session, created by the session module 603. Conversely, every change session has a single record in the ChangeSessions table 700. A change session represents a group of one or more changes or remote changes, caused by zero or more processes in the local operating system process environment or reported by a remote operating system process environment. Change sessions represent user-defined transactions by recording user-defined boundaries around groups of changes. Therefore, change sessions provide a powerful and easy capability for users of the present invention to organize large numbers of changes happening to data items on computer systems such that analysis and diagnosis can be performed about changing relationships between all aspects of the operating system process environment. Such analysis and diagnosis is an important tool for identifying the causes of many problems that occur in computing environments. All fields within a single change session record in the ChangeSessions table 700 refer to the same change session.

In the example embodiment, every unique execution of the recorder module 604 creates a new change session. Hence, a change session corresponds to a single trace in the example embodiment of the present invention. Aggregating multiple traces within a single change session, or splitting a single trace into multiple change sessions does not depart from the scope of the present invention. A new change session is also created by every unique execution of the observer module 602. Further the first incoming remote message from a unique change session on a remote operating system environment creates a new change session. Such an incoming remote message may be either an incoming remote trace request 607 or remote change report 608. Users of the present invention may also create special change session records as comments or notes. A unique change session on a remote operating system process environment is referred to as a remote change session within this description of the example embodiment of the present invention, while the change session on the local operating system process environment may be referred to as a local change session to emphasize the distinction. Changes traced or recorded because of multiple incoming remote messages from the same remote change session will all be considered part of the same local change session. New local change sessions, and consequently, new records in the ChangeSessions table 700 are only created when the first incoming message from a remote change session is received. The automatic creation and organization of change sessions by the present invention makes it possible to follow changes to large numbers of data items efficiently, promptly and selectively, even in an environment of distributed, networked computers.

Each record in the ChangeSessions table 700 contains a CSID key 700-a that uniquely and permanently identifies a change session record, generated by the change tracer database 301 when the record is created. A StartTime field 700-b is recorded as the date and time when the session starts, to the highest precision supported by the operating system. A Duration field 700-c is recorded after the session ends as the difference between the time the session ended and the StartTime field 700-b. A User field 700-d records a unique identifier representing the user who initiated the change session record. An OrigHost field 700-e contains a unique identifier representing a remote host from which the change session was initiated and will only be set to a non-null value if the change session represented by the record was created in response to an Incoming Remote Trace Request message 607 or Incoming Change Report message 608. An OrigType field 700-f indicates whether the change session was initiated because of a direct command from a user, an incoming remote trace request 607 or an incoming remote change report 608. An OrigCSID field 700-g contains the same value as the CSID field 700-a of a remote change session record in a remote change tracer database from which the change session represented by this record was initiated. The OrigCSID field 700-g will only be set and contain a non-null value if the change session represented by the record was created in response to an Incoming Remote Trace Request message 607. A Command field 700-h indicates the name, location and any options, arguments or parameters used to start the program module that initiated the change session. A StartDirectory field 700-i stores the current working directory of the initiator of the change session at the time the change session was started. A Status field 700-j is used to note the reason for the most recent update to the change session record and a StatusTime field 700-k is used to note the date and time of the most recent update to the change session record with the highest precision supported by the operating system. Many possible alternative data field structures may be used within the scope and spirit of the present invention to record changes to data items.

In order to classify changes for subsequent analysis, users are provided the capability to store tag data as user-specified fields with each change session record. The users of the present invention may use such tag data for description, identification, authorization, authentication, control or any other information that they choose to associate with change session data. Several tags are provided in the example embodiment of the present invention for convenience. A TagType field 700-l may be used to classify the type of change session according to any scheme convenient to the user for subsequently analyzing change session records. A TagDescription field 700-m may be used for notes about the change session represented by a record. A TagChangeID field 700-n may be used to store a unique workflow identifier like an order number or a ticket code commonly used by personnel who manage computers and networks. The Tag1 field 700-o and Tag2 field 700-p are for additional notes; different organizations managing computers may use different conventions to annotate change sessions as part of their documentation guidelines. Tag fields may be used to store authorization codes or identifiers, as well as authentication information such as digital signatures, security tokens or keyed hash (e.g. HMAC) of change session data to establish identity and integrity of part or all of the change session. In the example embodiment of the present invention, all the tag fields 700-l, 700-m, 700-n, 700-o and 700-p are unrestricted length data fields. Those skilled in the art may choose different names for such fields, different types of storage, different conventions for using the tag fields, more tag fields or fewer tag fields within the scope of the present invention. Further, tag fields may be associated with records in other tables within the change tracer database.

Additionally, the example embodiment of the present invention keeps count of various statistics for each change session record to provide additional insight to users of the invention about change session activity. A NumProcs field 700-q is used to store the total number of processes traced within a change session, a NumChanges field 700-r is used to store the total number of changes to data items recorded by a change session and a NumRemote field 700-s is used to record the number of remote messages sent by a change session. A NumOrigHops field 700-t is used to track how many remote computers consecutively sent an incoming remote trace request resulting in a change session. Fewer fields or more fields may be used to record statistics associated with each change session without departing from the scope of the present invention.

Each change session record in the ChangeSessions table 700 may be associated with one or more processes in an operating system process environment. Processes are represented as records in a ChangeProcesses table 701. Each record represents a single trace of the activity of a process within the operating system process environment for a period of time. Each record contains a CPID key 700-a that uniquely and permanently identifies a change process record, generated by the change tracer database 301 when the record is created. Each field in a record refers to the same specific process trace. An OSProcInfo field 701-b contains information obtained from the operating system about the process, including any operating system identifier for the process and any process attributes commonly used to refer to the process within the context of the operating system process environment. On most operating systems, such identifiers are only unique during the lifetime of the process and may be re-used by other processes, so this field may not be unique on its own. A single process may be traced for multiple non-overlapping periods in a single change session as well as in different change sessions. This is possible, for example, if the process being traced is long-lived and the change tracer is attached and detached several times for different change sessions. Additional information such as the working directory of the process, the permissions, capabilities and privileges of the process such as user and group information, etc. may be added to or removed from the OSProcInfo field 701-b or encoded in many different ways without departing from the scope of the invention.

A StartTime field 701-c contains the time that the process trace starts to the highest precision supported by the operating system environment that the process is executing in. A Duration field 701-d stores the difference between the time that the process trace ends and the StartTime field 701-c value. A Command field 701-e contains the name and possibly any parameters, options or arguments that identify the program module for the process. An OrigCPID field 701-f identifies the CPID field 701-a of a remote change process record in a remote change tracer database that corresponds to this change process record. The OrigCPID field 701-f will only be set to a non-null value in those change process records that represent remote change processes, and will null in those change process records that represent local processes. Change process records representing remote change processes are created as a result of Incoming Remote Change Reports 608. Additional relevant fields can be added to this table or the definition of the fields modified in various ways without departing from the scope of the present invention.

Each change session record in the ChangeProcesses table 701 may be associated with one or more remote change initiations. Remote change initiation is a term used in the example embodiment of the present invention to refer to any remote change session created on a remote change tracer as a result of sending either a remote trace request 610 or a remote change report 611 to the remote change tracer. Remote change initiation records are created in a RemoteChangeInitiations table 702 upon the first remote message sent during a change process to a remote host or remote operating system environment 400 as shown previously in FIG. 4 or FIG. 5. Each unique <change process, remote host> tuple corresponds to a single remote change initiation. Hence, each record in the RemoteChangeInitiations table 702 in a change tracer database 301 refers to a change session record in a remote change tracer's database 405.

Each field in a record in the RemoteChangeInitiations table 702 refers to the same remote change initiation. A RemoteHost field 702-a contains a unique identifier referring to the remote change tracer 404 executing within the remote operating system process environment 400. Every change tracer within a distributed change tracer system generates for itself a single unique identifier when the change tracer database is first created such that there is no practical probability that any two change tracers may have the same identifier. Numerous well-understood techniques such as hashing and partitioning an identifier space exist for generating such unique identifiers in a distributed system and any such technique may be used without limiting the scope of the present invention. The example embodiment of the present invention always checks all communication messages to ensure that two change tracers do not have the same identifier.

A RemoteCSID field 702-b within the RemoteChangeInitiations table 702 in the change tracer database 301 provides the linkage to a record in the ChangeSessions table 700 in remote change tracer database 405. The RemoteCSID field 702-b contains the CSID field 700-a of the remote change session stored in the corresponding record in the remote change tracer database 405. Even though the CSID field 700-a is unique within the ChangeSessions table 700 in any particular change tracer database 301, CSID fields 700-a need not be unique across multiple change tracer databases such as change tracer database 301 and remote change tracer database 405. If the same CSID value exists in the ChangeSessions table 700 in both local change tracer database 301 and remote change tracer database 405, that CSID value will refer to different change sessions that are completely unrelated. Since the RemoteCSID field 702-b does not refer to the CSID field 700-a within the same change tracer database 301 but refers to the CSID field 700-a on a different, remote change tracer database 405, the RemoteCSID field 702-b is not unique within the RemoteChangeInitiations table 702 in any particular change tracer database 301.

A RemoteCPID field 702-c within the RemoteChangeInitiations table 702 in the change tracer database 301 provides the linkage to a record in the ChangeProcesses table 701 in remote change tracer database 405. The RemoteCPID field 702-c contains the CPID field 701-a of the remote change session stored in the corresponding record in the remote change tracer database 405. Even though the CPID field 701-a is unique within the ChangeProcesses table 701 in any particular change tracer database 301, CPID fields 701-a need not be unique across multiple change tracer databases such as change tracer database 301 and remote change tracer database 405. If the same CPID value exists in the ChangeProcesses table 701 in both local change tracer database 301 and remote change tracer database 405, that CPID value will refer to different change processes that are completely unrelated. Since the RemoteCPID field 702-c does not refer to the CPID field 701-a within the same change tracer database 301 but refers to the CPID field 701-a on a different, remote change tracer database 405, the RemoteCPID field 702-c is not unique within the RemoteChangeInitiations table 702 in any particular change tracer database 301.

However, the <RemoteHost field 702-a, RemoteCSID field 702-b, RemoteCPID field 702-c> tuple is unique within the RemoteChangeInitiations table of change tracer database 301 and maps uniquely to a <CSID field 700-a, CPID field 701-a> tuple within some remote change tracer database such as 405. Further, any <OrigHost field 700-a, OrigCSID field 700-b, OrigCPID field 701-f> tuple in change tracer database 405 will refer uniquely back to change tracer database 301. Different embodiments of the present invention may contain other forms to represent and maintain the linkage between local and remote change tracer databases within the scope of the present invention. It will also be appreciated that well-known synchronization techniques may be used between multiple change tracer databases to keep all database identifiers such as CSID and CPID unique across the different change tracer databases.

In order to provide users with effective statistics about any remote change sessions initiated by a local change session, some statistics fields from the remote change session may be duplicated in the corresponding RemoteChangeInitiations record. In the example embodiment of the present invention, a NumRemChangeReports field 702-d contains a count of the number of Remote Change Report messages sent as part of this remote change initiation record, while a NumRemTraceRequests 702-e contains a count of the number of Remote Trace Request messages 610 sent as part of this remote change initiation record. A RemoteNumProcs field 702-f contains the same value as the NumProcs field 700-q in the remote change tracer database 405. A RemoteNumChanges field 702-g contains the same value as the NumChanges field 700-r in the remote change tracer database 405. A RemoteNumRemote field 702-h contains the same value as the NumRemote field 700-s in the remote change tracer database 405. Alternate representations or aggregations of such statistics do not limit the scope of the present invention.

Each change process record in the ChangeProcesses table 701 may be associated with one or more changes to data items. Each record in the Changes table 703 represents a single change to a data item within a change session. Each record in the Changes table 703 must be associated with only one record in the ChangeSessions table 700. Additionally, each change process record in the ChangeProcesses table 701 may also be associated with one or more records in the Changes table 703. A record in the Changes table 703 may be associated with only one record in the ChangeProcesses table 701.

Each field in a record in the Changes table 703 refers to the same change. An ItemID field 703-a is a unique, permanent identifier for the specific data item that results from the change represented by the change record. Item identifiers are generated when a data item is first seen by the change tracer 300 and are stable thereafter. Any changes to an item, even to its name or parent, do not cause its ItemID to change, but they do cause the ItemVersion field 703-b to change. In the example embodiment of the present invention, the ItemVersion field 703-b is incremented on every change, but any sequence function that generates a new unique version from an old version may be used within the scope of the present invention. In the example embodiment of the present invention, the tuple <ItemID field 703-a, ItemVersion field 703-b> is unique in the Changes table 703 and is referred to as an item version. When a new item is created, the ItemID field 703-a refers to the newly created item, the ItemVersion field 703-b is set to the initial value of the sequence function used for item versions, which is zero in the example embodiment of the present invention.

A ChangeTime field 703-c contains the date and time that the change record was created, to the highest precision supported by the operating system. A ChangeType field 703-d indicates whether the record represents an item creation, modification, deletion, link, rename, device parameter manipulation or a communication attempt, signal, etc. A ChangeInfo field 703-e contains additional information about the change in the item. Examples of the contents of the ChangeInfo field 703-e include details about the location of the change, identification of specific subattributes of the item that may have changed, or any analytic information such as the importance of the change determined by rules from the configuration module 601. The set of types supported by the ChangeType field 703-d and the information stored in the ChangeInfo field 703-e may be expanded or reduced as suitable for the computing environment and the types of data items being managed by the present invention without departing from the scope of the present invention.

Each change record in the Changes table 703 may be associated with a corresponding data item because a change record represents a change to the item version <ItemID field 703-a, Itemversion field 703-b> as well as implicitly associated with all item versions with the same ItemID field 703-a. Each record in the Items table 703 represents a single item version and therefore, contains an ItemID field 704-a and an ItemVersion field 704-b. Each field within a record in the Items table 703 refers to the same item version. The tuple <ItemID field 704-a, ItemVersion field 704-b> is unique within the Items table 704. To support hierarchical data stores, each item record contains an ItemParentID field 704-c, which contains the ItemID of an item that is the immediate superior of the item record. For filesystems, the ItemParentID field 704-c of a file item would be the same as the ItemID field 704-a of the item record of the directory item containing the file item. For registry hives, the ItemParentID field 704-c of a registry entry item would be the same as the ItemID field 704-a of the item record of the registry key item containing the registry entry. An infinite depth of hierarchy may be represented this manner for directories within directories, registry keys within registry keys, etc. Other forms of hierarchical data can be represented in this model within the scope of the invention. Further, various changes may be made in the way that hierarchical data is represented within the relational model of the change tracer database 301 for convenience or speed of implementation without departing from the spirit or scope of the invention.

The corresponding item record for the data item resulting from a change represented by a specific change record in the Changes table 703 is found by searching the Items table 704 for an item record such that the ItemID field 703-a in the Changes table is the same as the ItemID field 704-a in the Items table and the ItemVersion field 703-b in the Changes table 703 is the same as the ItemVersion field 704-b in the Items table. The corresponding old item record is found by searching the Items table 704 for an item record such that the ItemID field 703-a in the Changes table 703 is the same as the ItemID field 704-a and the ItemVersion field 703-b in the Changes table 703 is the next sequential value from the ItemVersion field 704-b, a difference of 1 in the example embodiment of the present inventionDifferent forms of indexing and linking may be used without departing from the scope of the present invention.

An ItemName field 704-d contains the name of the item. For hierarchical data stores, the ItemName field 704-d contains only the final component of the path name of the item, since the full path name of an item may be obtained by consecutively prefixing the ItemName field 704-d with the names of all its parents, demarcated by an appropriate separator (a slash for POSIX®-style pathnames and web site URLs, a backslash for Window® file and registry pathnames, etc.) Different mappings and representations of names of data items may be used within the scope of the present invention.

An ItemValue field 704-e contains a representation of the value or contents or information within the item version. For efficiency in storing values of large items such as files, the example embodiment of the present invention may instead store one or more highly compressed, probabilistically unique hash codes or only store the differences or deltas from the preceding version of the same item. The format of stored differences is stored as an instruction sequence identifying added, deleted and replaced segments within the item contents, such that a complete version may be constructed from another version by applying the additions, deletions or replacements in sequence. The example embodiment of the present invention uses a reverse difference model for efficiency, in which the most recent version of an item always contains the complete contents of the item, while previous versions only hold the difference from a more recent item. The example embodiment of the present invention may choose to store a reverse delta difference whenever the storage required for the reverse delta difference is smaller than the new full value. When a new item version of an item version whose preceding version has a full value is stored, the Itemvalue field 704-e of the preceding version is replaced with a difference between the new item version and that preceding version, while the new version always has a full value. Reverse differences are efficient because the most recent version is more likely to be accessed frequently, while older versions may be constructed by successive application of the differences to previous items in reverse order. The encoding of the ItemValue field 704-e indicates whether the field contains no value, the full value, a hash code or a difference. Many efficient encodings and formats are possible for representing the values or contents of items without departing from the scope of the present invention. Deltas need not only be computed from the preceding version but may be chosen from any item version in the change tracer database 301 that minimizes storage without departing from the scope of the present invention.

The format and representation of the ItemValue field 704-e also depends on an ItemType field 704-f, which stores the type of the item, e.g. whether it is a registry item, a file, a symbolic link, a device node, a process, a comment or note, etc. An ItemSize field 704-g contains the size of the item. An ItemTime field 704-h contains the time that the operating system environment indicates that item was most recently modified. This may differ from the ChangeTime field 703-c in the corresponding change record in the Changes table 703 because there may be delays in when the change tracer 300 detects and records the change, or because an item was created with an old or future timestamp, as is possible in many operating system environments. An ItemMetaData field 704-i contains additional information about the item, including timestamp, permission and ownership information. Other additional information about the item may include any of the information returned by the stat( ) system call for file objects in Linux®, Solaris®, Unix® or POSIX®-compatible operating systems, the acl( ) system call on Solaris®, the access list control function acl_get_file( ) on those operating systems that follow the model proposed by the POSIX® 1003.1 e draft standard, the FindFirstFileEx( ), GetFileInformationByHandle( ) and GetNamedSecurityInfo( ) for files in Windows®, and the RegQueryInfoKey and GetNamedSecurityInfo( ) functions for registry entries in Windows®. Item metadata and values, as well the techniques for obtaining and encoding them, though diverse across different types of items and computing environments, may vary without departing from the scope of the present invention.

An ItemFlags field 704-j is a bitmask or flags field, where each bit may be independently set or cleared to indicate boolean true or false status. The example embodiment of the present invention uses two bits, ItemDeleted and ItemLinked. The ItemDeleted bit or flag is set if the item no longer exists in the data store that the change tracer is recording. Records are still maintained for deleted items within the change tracer database 301 in order to show an accurate history and to allow records in the Changes table 703 to refer to such deleted items. The ItemLinked bit or flag is set to indicate that the item has been linked or is in some way interconnected to or interdependent on another data item or is known by multiple names, as indicated by corresponding records in the Links table 705. For example, items representing hard links created with the link( ) system call or symbolic links with the symlink( ) system call on any POSIX® filesystem will have the ItemLinked bit set.

Any item with the ItemLinked bit set in their ItemFlags field 704-j is also represented by a record in a Links table 705. All items that are linked to each other form a single set in the Links table. Therefore, when accessing a record in the Items table 704 that has a the ItemLinked flag set in the ItemFlags field 704-j, a single query on the Links table 705 may be used to retrieve all other items that are linked to the item represented by the record in the Items table. Since POSIX™ hard links represent multiple names for the same item and metadata, any changes to one item can therefore be reflected in and reported in all other items. Since POSIX™ symbolic links and Windows™ shortcuts may both point at non-existent items, the unresolvable or dangling nature of such links may be reported. The ItemID field 705-a identifies the item that each record in the Links table 705 represents, while a LinkType field 705-b identifies the type of link. The example embodiment of the preferred invention recognizes hard and symbolic links in POSIX™ filesystems, shortcuts in Windows filesystems and registry links, linkage caused by the dependency of program executables on dynamically loaded libraries, references from within one data item such as a file or registry entry to another data item, dependency of a program executable on a local or network service or dependency of a local or network service on another local or network service. The LinkInfo field 705-c indicates if an item is the target in an asymmetric link, whether the link is unresolved because the referenced target item is missing, or various other link status elements. More link or dependency types and additional link information may be added, and embodiments may recognize and process other forms of linkage, interdependency or relationship between data items without departing from the scope of present invention.

The ItemValue field 704-e may contain the entire contents or value of an item, only a hash code, multiple combinations of hash codes, differences or deltas of various forms or no value within the scope of the present invention and decisions about what is stored in this field may be made based on storage, performance, user-interface considerations etc. New types of items may be added or supported within embodiments of the present invention without departing from the scope of the present invention. Subsets or alternate representations of item metadata or value may be used in embodiments of the present invention, and the fields in the item record may be processed in different formats and representation without departing from the scope of the present invention.

The scope of the present invention is not limited by decisions to normalize or de-normalize the entities and tables of the change tracer database 301 to create additional entities or tables, change the formats or representations of various entities and their attribute fields, create indices to increase the speed of access to individual fields within such tables, partition tables to deal with size or performance restrictions of underlying database technology or make the table structure more suitable for any particular programming language, virtual machine, user interface or other software development technology used to implement the embodiments of the present invention. Many forms exist for the efficient storage of names and other strings using compression, reference counting of common names, string tables, etc. without departing from the scope of the present invention.

Configuration Module

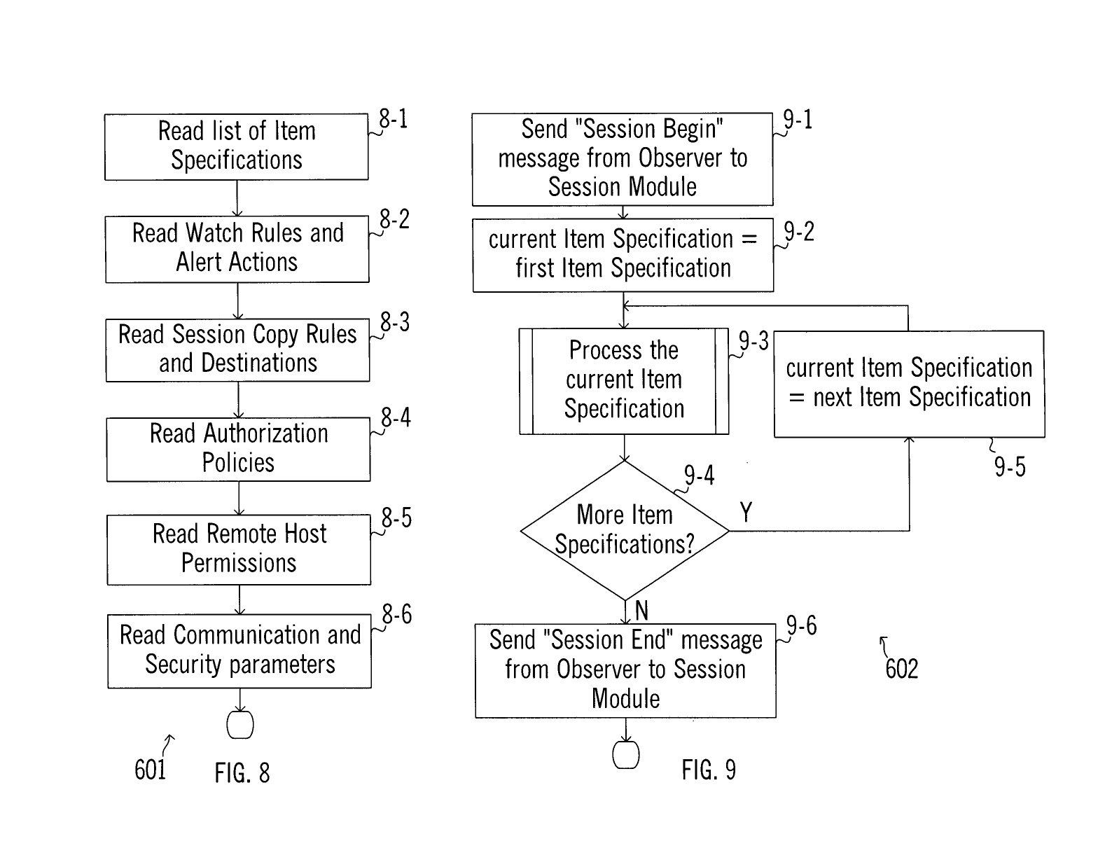

FIG. 8 is a simplified flow chart describing the configuration module 601 according to the example embodiment of FIG. 6. The configuration module is a component of the change tracer 300 responsible for reading and parsing configuration data provided by users of the example embodiment of the present invention, and making this configuration data available to all other modules of the change tracer process 301 for controlling certain user-modifiable aspects of the behavior of those modules.

In step 8-1, the configuration module 601 reads in a list of Item Specifications from some form of system storage 108 according to FIG. 1. While the example embodiment of the present invention uses a structured text file in the INI file format and is described as such, any form of persistent storage media will be suitable for a configuration, depending on the embodiment chosen for the present invention. Configuration data may be provided from many sources commonly available within operating systems, including data files, registry hives, non-volatile memory, command-line options, environment variables and network information services without departing from the scope of the present invention. An Item Specification defines a set of Items that the change tracer should be attentive to during execution. Item Specifications may describe sets of items by path names and item types, may specify both item names and wild-card patterns for inclusion or exclusion. If inclusion names or patterns are specified, then the change tracer process 301 will consider only items with those names or matching any of those patterns. If exclusion names or patterns are specified, then the change tracer process 301 will not consider any items with those names or matching those patterns. If an item matches both an exclusion and inclusion, the example embodiment of the system considers the exclusion to take priority and does not consider that item. Embodiments of the present invention may provide other forms of item specification syntax or pattern matching as well as alternative priority rules for inclusion and exclusion without departing from the scope of the present invention. For user convenience and clarity, the example embodiment of the present invention requires a unique name for each Item Specification. Items on a computer system that do not match an inclusion of any Item Specification will not be have their initial values recorded, need not have any changes recorded for them and need not be traced.

In step 8-2, the configuration module 601 reads in a set of watch rules and corresponding alert actions. Watch rules are specified by users of the example embodiment of the present invention as expressions evaluating boolean logic conditions in terms of entities and fields within the change tracer database 301 and item specifications as well as references to executable program modules, functions or scripts that may be executed to return values that may be used within expressions. Alert actions specify forms and targets of actions that would provide direct or indirect notice to users. The session module 603 executes the specified alert actions if the conditions specified by corresponding watch rules are met during a change session. In the example embodiment of the present invention, alert actions include e-mail to user-specified addresses, Simple Network Management Protocol (SNMP) trap messages or the execution of any user-specified program modules. The choice and implementation of the rule evaluation program code as well as the set of supported alert actions are not limited by the present invention. Many algorithms for compression, encryption and integrity, protocols for transmission and data formats for representation may be chosen for alerts without departing from the scope of the present invention.

In step 8-3, the configuration module 601 reads in a set of session copy rules and corresponding destinations. Session copy rules are specified by users of the example embodiment of the present invention as expressions evaluating boolean logic conditions in terms of entities and fields within the change tracer database 301 and item specifications as well references to executable program modules or scripts that may be executed to return values that may be used within expressions. Session copy destinations are specified in terms of various data transmission protocols and formats like e-mail, file transfer, or network transmission. The session module 603 sends copies of a change session, including all associated change process records, remote change initiation records, change and item records to the specified session copy destinations if the conditions specified by the corresponding session copy rule are met during that change session. Many algorithms for compression, encryption and integrity, protocols for transmission and data formats for representation may be chosen for session copies without departing from the scope of the present invention.

In step 8-4, the configuration module 601 reads in a set of authorization policies. Authorization policies are specified by users of the example embodiment of the present invention as expressions evaluating boolean logic conditions in terms of entities and fields within the change tracer database 301 and item specifications as well as references to executable program modules or scripts that may be executed to return values that may be used within expressions. Evaluation of authorization policies may result in communication with programs or services executing on the computer system or remote computer systems. The recorder module 604 checks these authorization policies before it begins tracing a new change process or change session. The session module checks these authorization policies when it processes an incoming trace request 607. The results of the authorization policy check determine for the change tracer whether or not it is desirable to trace a process, and may be used to provide data to control the subsequent tracing and recording of the process, including tags to be added or modified within any change sessions.

In step 8-5, the configuration module 601 reads in a set of remote host permissions which can be used to enable or disable remote tracing for the specified remote hosts as desired by users of the example embodiment of the present invention. In step 8-6, the configuration module 601 reads in a set of communication and security parameters used for establishing communication within different modules of the change tracer process 300 as well as between the change tracer process 300 and remote change tracer processes 404 executing on remote hosts. Such communication parameters include time period durations, intervals or timeouts that are used by other modules to wait for messages or detect idleness or other exceptional conditions during communication. Security parameters may select encryption, authentication and integrity algorithms to be used for recording and verifying user identity, ensuring data integrity and privacy during storage as well as communication. Communication and security parameters may be varied without departing from the scope of the invention.

The example embodiment of the present invention permits the configuration to be changed at any time, upon which the configuration module is re-executed. Many forms may be used for the configuration data read in by the configuration module 601, the forms of expressing boolean logic, the sets of functions made available for the expressions for various rules within the scope of the present invention.

Observer Module

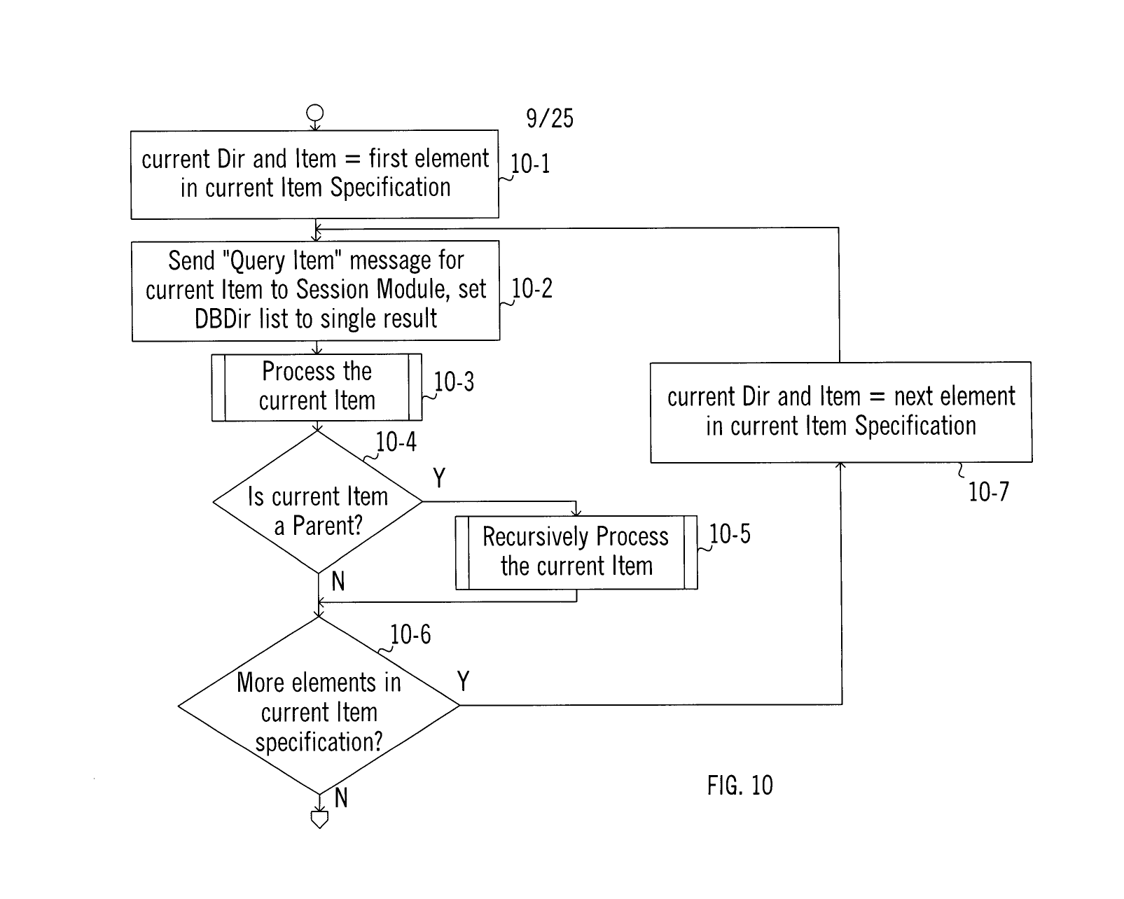

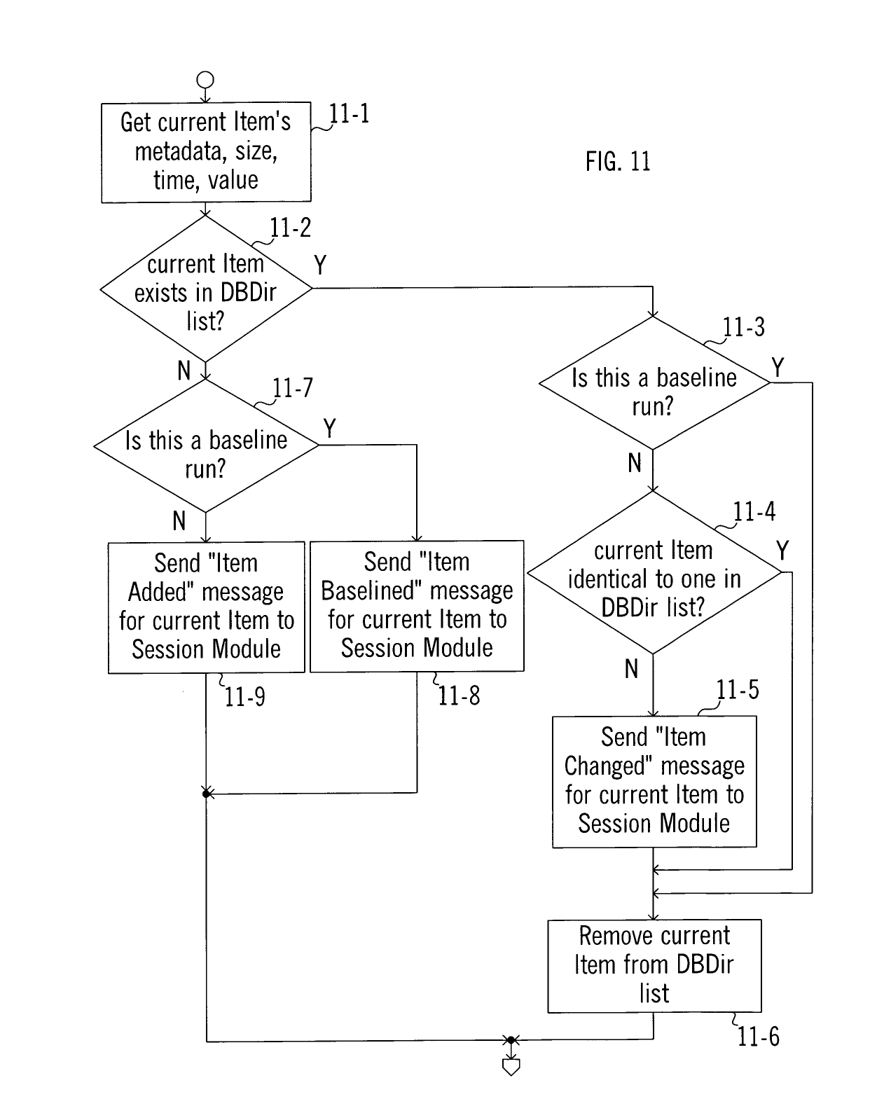

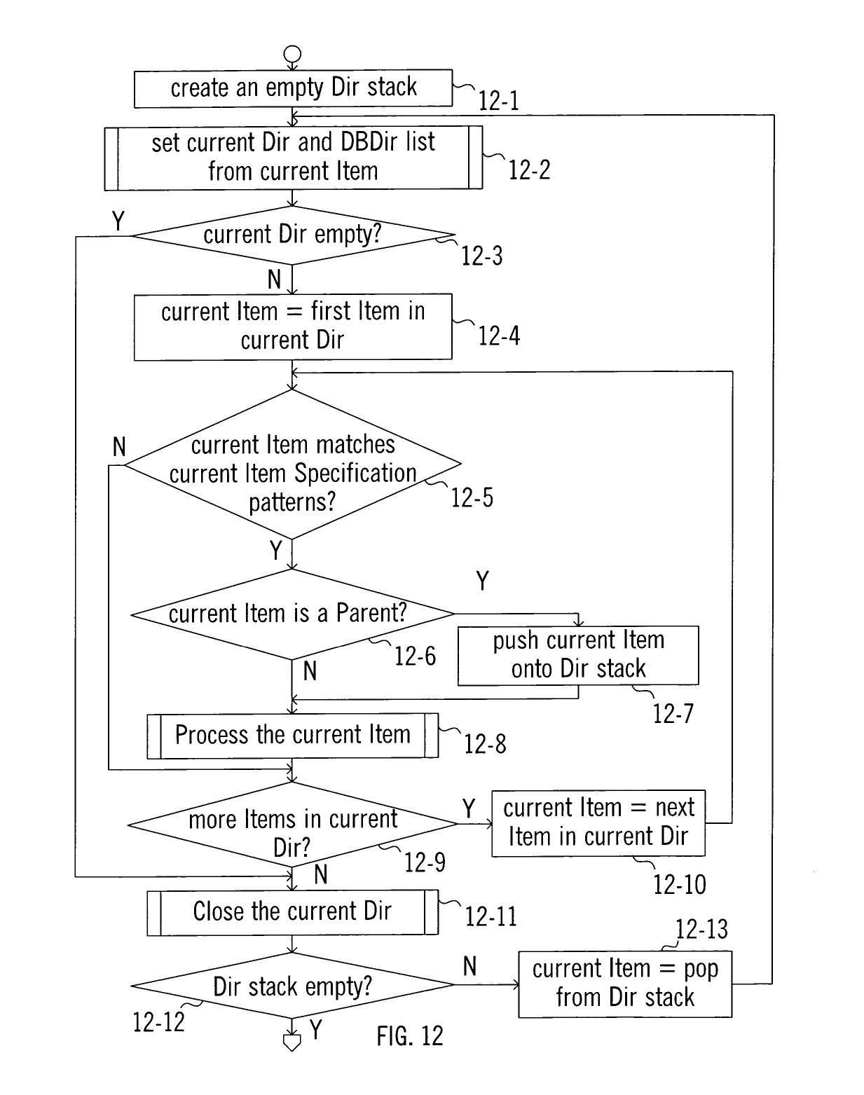

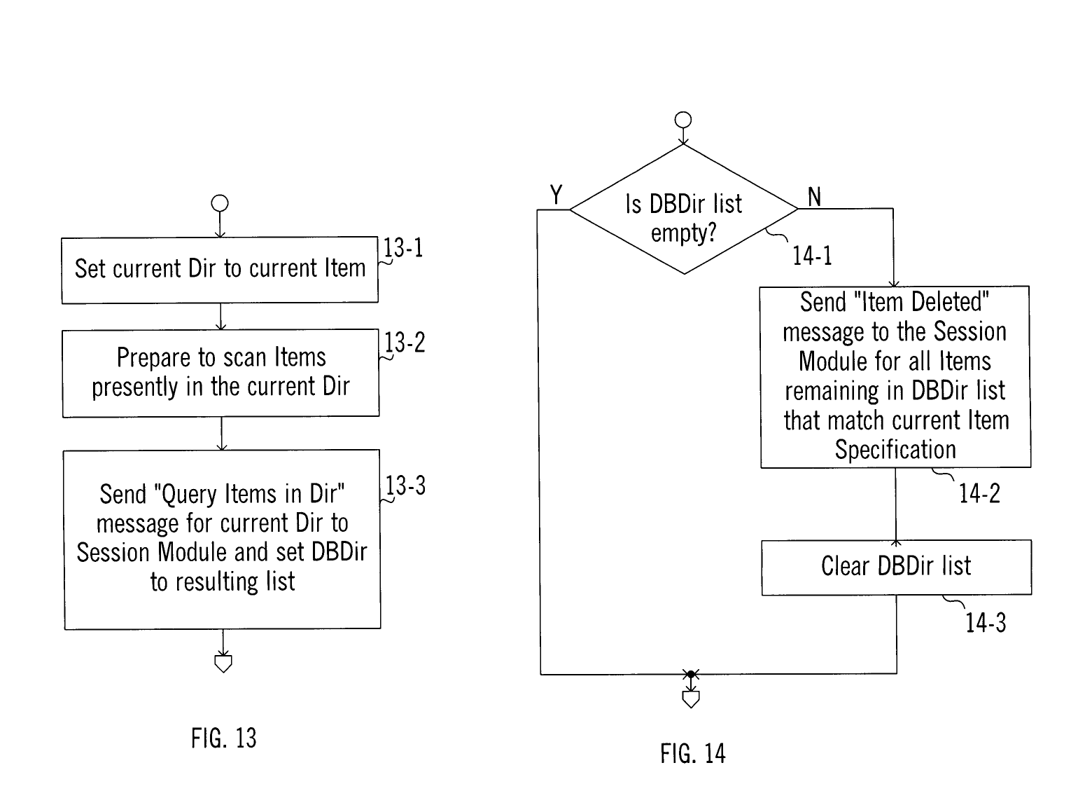

FIG. 9 is a simplified flow chart describing the observer module 602 according to the example embodiment of FIG. 6, with sub-functions described in simplified flow charts as FIG. 10, FIG. 11, FIG. 12, FIG. 13 and FIG. 14. The observer module 602 is used when the change tracer database is first created to construct a baseline of initial information about all items that the change tracer process 300 is required to be attentive to by the Item Specifications read in by the configuration module 601. Such a baseline run is also repeated whenever the configuration module 601 detects a change in configuration. Whether or not to construct a baseline is indicated to the observer module when it is started. A baseline does not detect or report any changes since it is only ensuring that an initial value exists in the change tracer database 301 for any item that the change tracer is required to be attentive to during execution.

The observer module 602 can also be used as a backstop for the recorder module 604 by periodic execution of the observer module 602 to detect and record any changes that were not made in a change session traced by the recorder module 604. Such changes may be unauthorized by the policies governing the computing environment and are likely sources of problems. The symbiosis and contrast between the change sessions created by the observer module 602 and recorder module 604 is therefore capable of selectively differentiating between large numbers of changes that would otherwise remain undifferentiated and hard to analyze.

Referring to FIG. 9, in step 9-1, the observer module 602 sends a “Session Begin” message to the session module 603. This message requests the creation of a new change session by the session module 603, which returns a unique identifier for the new change session, now referred to as a current session within the observer module 602. The observer module 602 also passes along any user-specified tag data for description, authorization, identification, digital signature, security, privacy or authentication of the change session. Multiple steps, sub-messages and replies may be used within the “Session Begin” as needed for authentication. In the example embodiment of the present invention, the unique identifier for the current session is identical to the unique CSID field 700-a corresponding to the new change session created in the change tracer database 301. Many forms of constructing a one-to-one mapping between the unique identifier for the current session and the unique CSID field 700-a exist within the scope of the present invention. All subsequent messages from the observer module 602 to the session module 603 that refer to items or changes within the context of the current session will include the unique identifier for the current session.

In step 9-2, the observer module 602 starts examining the first Item Specification from the configuration module. The Item Specification being processed is referred to as the current Item Specification. In step 9-3, the current Item Specification being processed is handled by a sub-module, which will be described subsequently in FIG. 10. A following step 9-4 checks if there are any more Item Specifications. If there are, execution proceeds to step 9-5 in which the Item Specification sequentially following the current Item Specification is now referred to as the current Item Specification, after which execution loops back to step 9-3 to be repeated as long as there are still Item Specifications to be processed. If step 9-4 determines that there are no more Item Specifications left to process, execution proceeds to step 9-6 in which the observer module 602 sends a “Session End” message to the session module 603. The “Session End” message notifies the session module 603 that the execution of the observer module 602 has completed and that any post-processing for the current change session may now be performed. The observer module 602 may also pass along any final user-specified tag data for description, authorization, identification, digital signature, security, privacy or authentication of the change session. At this point, execution of the observer module ends.

FIG. 10 illustrates in simplified block diagram form the sub-module for the processing of the current Item Specification by the observer module 602. The set of items in the current Item Specification is processed sequentially, one element at a time. In step 10-1, the first element from the set of items in the Item Specification is extracted and parsed into a current Dir and current Item. The current Dir refers to the path in a hierarchical data store leading up to the current Item and is therefore referred to as the parent of the current Item within the hierarchical data store. For flat data stores, the current Dir will be null. In step 10-2, the observer module 602 sends a “Query Item” message to the session module 603 requesting detailed information about the current Item. Parameters included with the “Query Item” message include the current Dir and the unique identifier for the current session. The session module 603 returns a response to each “Query Item” message containing all information about the most recent version of the current Item found in the change tracer database 301. If the current Item is not found within the change tracer database 301, the session module 603 returns a null indicator to the observer module 602. The observer module 602 constructs a single element list from this response, referred to as DBDir. DBDir therefore contains the state of the currentItem as presently recorded in the change tracer database 301. Execution then proceeds to step 10-3 in which the current Item is processed by the observer module. This step 10-3 is shown as a sub-module and described subsequently in FIG. 11. After the processing of step 10-3, execution proceeds to step 10-4, which uses the results in the DBDir list as returned in step 10-2 to determine if the current Item is itself a parent within a hierarchical data store. In this description of the example embodiment of the present invention, any type of item with descendant, child or inferior items within any hierarchical data store is referred to as a Parent. The example embodiment of the present invention does not restrict the type of hierarchical data store, and that examples of Parents include directories within filesystems, registry keys within registry hives, tables within databases, sections within structured configuration file formats, nodes within XML data formats or LDAP directory data, etc.

If the current Item is determined to be a Parent, then execution proceeds to step 10-5 in which a sub-module handles the recursive processing of the current Item in order to ensure that all descendant items and any further descendants are examined. This recursive processing will be described in FIG. 12. After the recursive processing of the current Item completes, execution proceeds along the same path to step 10-6 as if the current Item were not a Parent. Step 10-6 checks if there are any more elements in the Item Specification. If there are, execution proceeds to step 10-7, in which the element following the current element is extracted from the current Item Specification into the current Dir and current Item, after which execution loops back to step 10-2, to be repeated until all elements of the current Item Specification have been processed. If step 10-6 determines that there are no more elements in the current Item Specification remaining to be processed, then execution of the sub-module ends and execution returns to the module that invoked this sub-module.

FIG. 11 illustrates in simplified block diagram form the sub-module for the processing of the current Item by the observer module 602. Step 11-1 queries the operating system to obtain detailed information about the current Item including its size, last time that it was changed, any metadata associated with it like ownership, links, dependencies, prerequisites and permissions, and the value or contents. The present invention is not limited to only the detailed information described herein. If the metadata, value or contents are large, the example embodiment of the present invention may compute one or more highly compressed, probabilistically unique hash codes over part or all of the metadata and contents as a substitute for the actual metadata or contents. Step 11-2 checks if the current Item exists within the DBDir list. If the current Item exists within DBDir, then execution proceeds to step 11-3, else to step 11-7. Step 11-3 determines if the observer module 602 is presently performing a baseline run. If it is, then execution skips ahead to step 11-6 because there is no need to detect changes during this run. If the observer module is not presently performing a baseline run, then control moves to step 11-4, which checks if the information about the current Item in the DBDir list is the same as the information obtained in step 11-1 from the operating system. If this information is identical, then execution skips ahead to step 11-6. If the information is not identical, a change has been detected and execution proceeds to step 11-5, in which an “Item Changed” message is sent to the session module along with the new information that was obtained from the operating system in step 11-1. In step 11-6, the current Item is removed from the DBDir list after which execution of the sub-module is complete and execution returns to the module that invoked this sub-module.

If the current Item does not exist in the DBDir list when checked in step 11-2, the observer module has detected a new item that was not previously recorded in the change tracer database 301. Execution proceeds to step 11-7, which checks if the observer module 602 is presently performing a baseline run. During a baseline run, execution proceeds to step 11-8 to add the current Item to the baseline. In step 11-8, the observer module 602 sends an “Item Baselined” message to the session module 603 with the information about the current Item obtained in step 11-1. After step 11-8, execution of the sub-module is complete and execution returns to the module that invoked this sub-module.

If step 11-8 determined that the observer module 601 not a baseline run, execution proceeds to step 11-9 to record a change that added the current Item. In step 11-9, the observer module 602 sends an “Item Added” message to the session module 603 with the information about the current item obtained in step 11-1. After step 11-9, execution of the sub-module is complete and execution returns to the module that invoked this sub-module.

FIG. 12 illustrates in simplified block diagram form the sub-module for the recursive processing of the current Item by the observer module 602. The description herein uses a stack data structure for clarity and efficiency but various other forms of implementation exist within the scope of the present invention. Step 12-1 creates and initializes an empty stack data structure called the Dir stack. This stack is used to temporarily hold any Parent items encountered until they can be processed in their turn.

Since the reason for this sub-module's invocation is that the current Item is known to be a Parent node, step 12-2 initializes the current Dir and the DBDir list from the current Item using a sub-module that is shown in FIG. 13. Referring now to FIG. 13, in step 13-1, the current Dir is set to the current Item. Step 13-2 performs any preparatory initialization required by the operating system in order to examine all Items in the current Dir. Step 13-3 sends a “Query Items in Dir” message to the session module 603 to request the detailed information for all items that are descendants of the current Dir as recorded in the change tracer database 301. The session module 603 responds with a list of elements in which each element represents a descendant item and the information about that item from the change tracer database 301. The list provided by the session module 603 is referred to as DBDir and execution of the sub-module completes, returning back to the sub-module for the recursive processing of the current Item shown in FIG. 12.

Referring back to FIG. 12, execution proceeds to step 12-3 which checks with the operating system if the Parent item represented by the current Dir is empty. If current Dir is empty, execution skips ahead to step 12-11. If the current Dir is not empty, then the observer module 602 can proceed to compare all items in DBDir with the items reported by the operating system in the current Dir. Execution therefore proceeds to step 12-4, where the first item in the current Dir is extracted and referred to as the current Item. Step 12-5 checks the inclusion and exclusion patterns of current Item Specification to see if the current Item should be considered for further processing. If the current Item matches an inclusion pattern and if the current Item does not match any exclusion pattern within the current Item Specification, then the current Item is considered a match and execution proceeds to step 12-6, otherwise the current item is considered not to match and execution skips ahead to step 12-9. Step 12-6 checks if the current Item is a Parent. If the current Item is a parent, execution proceeds to step 12-7, in which the current Item is added or pushed onto the Dir stack to be temporarily stored until it can be processed. Execution then proceeds to step 12-8. If step 12-6 determined that the current item is not a parent, execution also proceeds to step 12-8. In step 12-8, the sub-module to process the current Item is invoked as already described in FIG. 11. Execution then proceeds to step 12-9. Step 12-9 checks if there are any items remaining in current Dir that have not already been be processed. If so, execution proceeds to step 12-10, in which the item following the current Item is extracted from the current Dir and now referred to as the current Item. Execution then loops back to step 12-5, to be repeated until no more items remain to be processed in the current Dir. If step 12-9 determines that no more items remain to be processed remain in current Dir, execution proceeds to step 12-11.

Step 12-11 invokes a sub-module to close and finish any processing on the current Dir. This sub-module is described subsequently in FIG. 14. After closing the current Dir, execution proceeds to step 12-12, which checks if the Dir stack is empty. If the Dir stack is empty, then execution of this sub-module that recursively processes the current Item is complete and execution returns to the module that invoked this sub-module.

If the Dir stack is not empty, then execution proceeds to step 12-13, in which an item is popped off the stack and referred to as the current Item. This will be the item most recently pushed onto the stack according to the well-known semantics of a stack data structure. Execution then loops back to step 12-2, in order to repeat processing until no more all items remain in the stack.

FIG. 14 shows in simplified block diagram form a sub-module to close the current Dir. Step 14-1 checks if the DBDir list is empty. If it is empty, execution of this sub-module completes immediately and execution returns to the sub-module that invoked this sub-module because this means that all items in the DBDir list have already been processed. If any items remain in the DBDir list, records for those items exist in the change tracer database 301 but no longer exist in the operating system process environment 200. Therefore, execution proceeds to step 14-2, which sends an “Item Deleted” message to the database for all items that remain in the DBDir list, provided that such items match the current Item Specification. Items not matching the Item Specification can be ignored.Execution proceeds to step 14-3, in which the DBDir list is cleared. Execution of the sub-module is now complete and execution returns to the sub-module that invoked this module.

The observer module 602 processes Item Specifications in separately and sequentially in the example embodiment of the present invention, though embodiments of the present invention may combine and optimize Item Specifications or process Item Specifications concurrently without departing from the scope of the present invention. Multiple instances of the observer module 602 may be executed concurrently using widely understood concurrency control and synchronization models within the scope of the present invention.

Recorder and Authorization Module

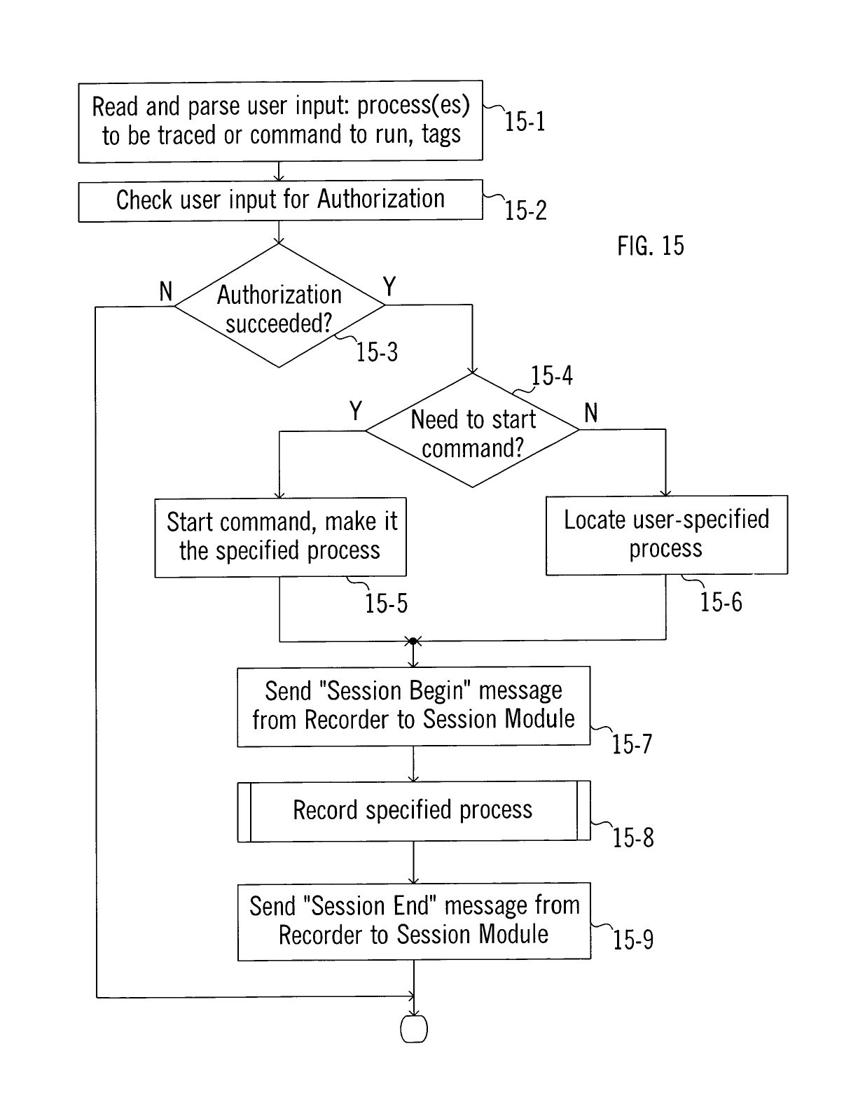

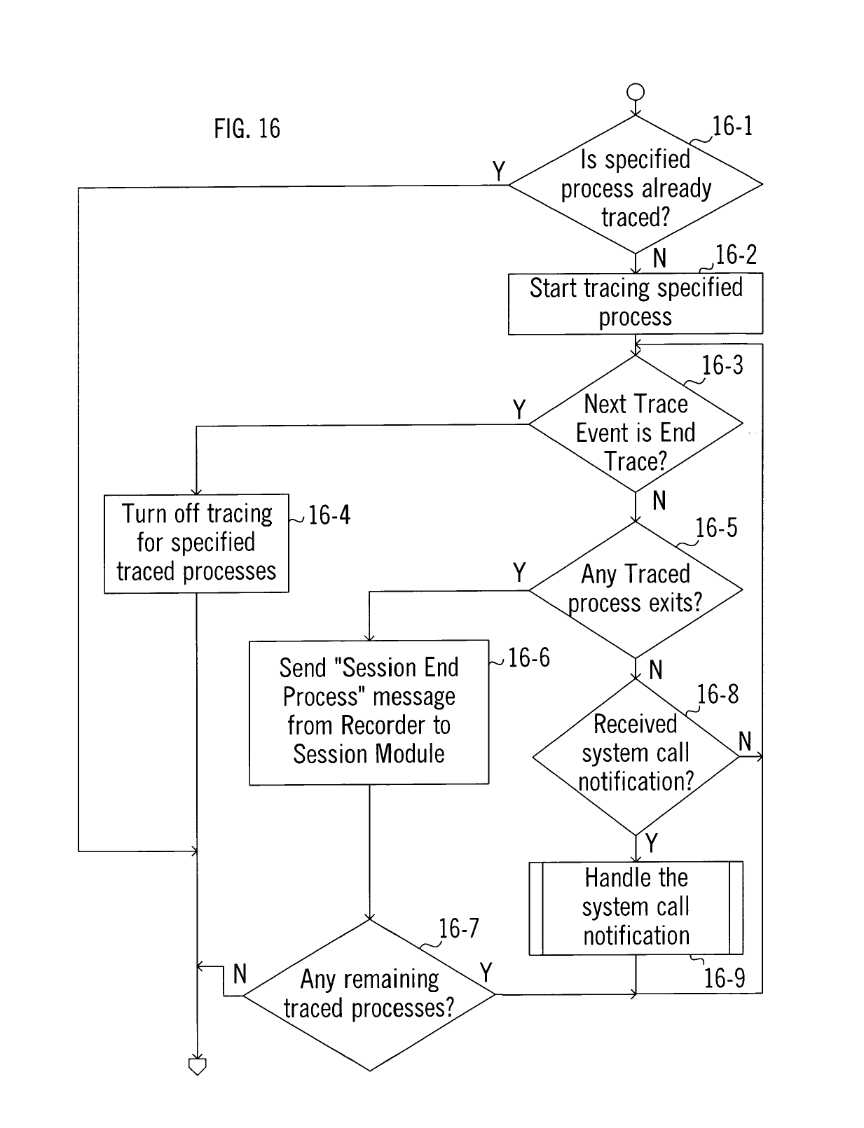

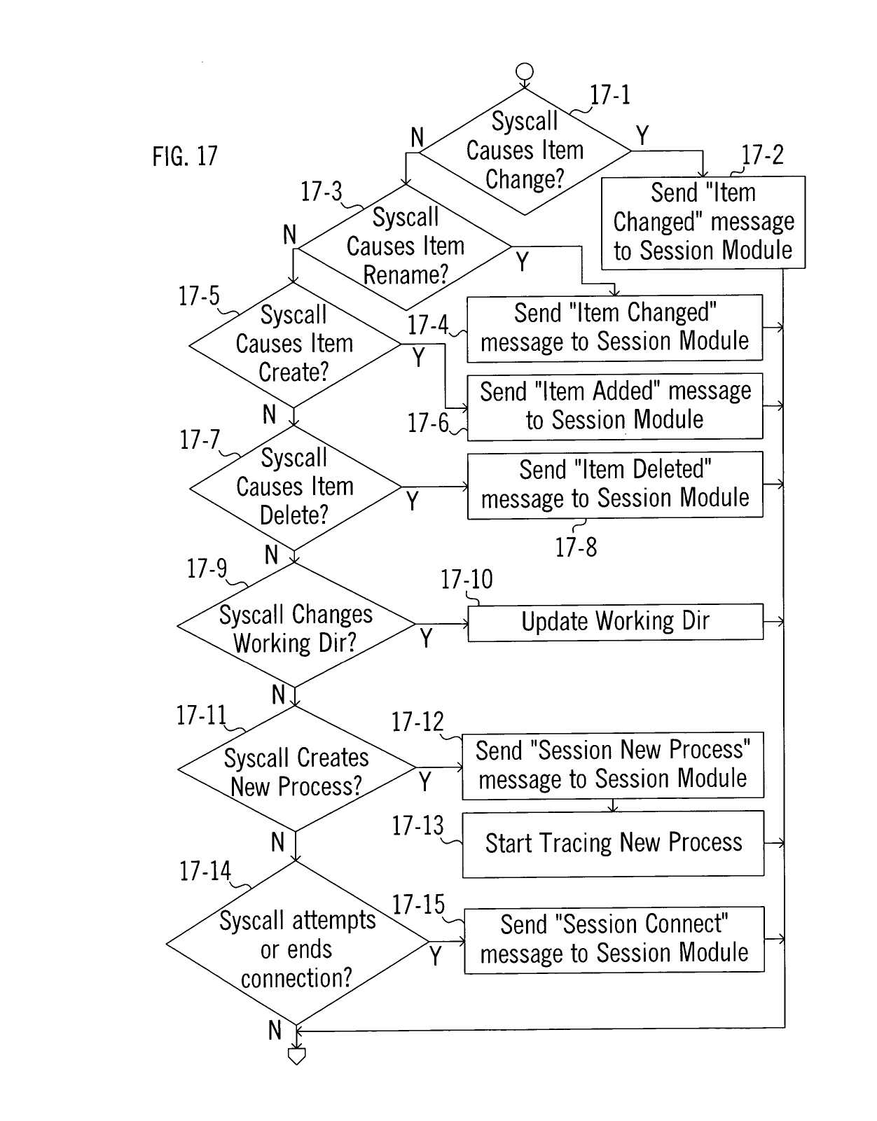

FIG. 15 is a simplified flow chart describing the recorder module 604 according to the example embodiment of FIG. 6, with sub-functions further described in simplified flow charts as FIG. 16 and FIG. 17. In step 15-1, the recorder module 604 reads and parses any user input provided to it. This user input data includes the specification of one or more processes to be traced. User input may be provided in many forms, including data input through a command-line interface, data files, network stream data or from a graphical user interface with selection lists, text entry fields, menus, buttons, radio-buttons, checkboxes or other widely used input forms. The form of user input does not restrict the scope of the present invention. The processes to be traced may already be executing within the operating system process environment, and may be specified by the user via process number or other unique operating system identifier, by name, by some criteria. Such criteria include wild-card patterns or logical rules expressed in terms of process attributes such as number, identifier, name, parameters or environmental data associated with processes. The processes to be traced may not yet be executing, in which case the recorder may wait for processes matching the user input specification to begin executing. The user input specification may request that processes be started by the recorder module 604 by providing the names or paths and parameters of executable commands, scripts, applications, utilities, software tools or other program modules that can be started as processes by the recorder module 604. The user input also includes any tag information to be stored in the change session record in the ChangeSessions table 700 in the change tracer database 301 as fields 700-l, 700-m, 700-n, 700-o and 700-p as described previously in FIG. 7.

In Step 15-2, the recorder module 603 provides the authorization module 605 with all the user-input parameters. The authorization module 605 checks all authorization policies read in by the configuration module 601. The authorization policies are in the form of executable Boolean expressions and may include the execution of external user-provided program modules, scripts or commands. In step 15-3, the results of the authorization policies are examined to determine if the authorization succeeds and the trace is permissible. If the trace is not permissible, the recorder module 603 completes execution immediately.

If the trace is permissible, execution proceeds to step 15-3, which checks if user-input included any names and parameters of executable commands, scripts or program modules that need to be started by the recorder module 604. If so, execution proceeds to step 15-5, in which the specified executable command is started and the resulting process within the operating system process environment is now referred to as the specificed process. If there were no executable commands specified, some already-executing processes will have been specified instead, therefore execution proceeds to step 15-6 in which the recorder module 604 locates the user-specified process to be traced. After either step 15-5 or step 15-6 executes, step 15-7 sends “Session Begin” message to the session module 603. The “Session Begin” message requests creation of a new change session record within ChangeSessions table 700 of the change tracer database 301, identified by a unique identifier returned by the session module 603 to the recorder module 604 and now referred to as the current session in the recorder module 604. The “Session Begin” message also results in the creation of a new change process record in the ChangeProcesses table 701 within the change tracer database 301, associated with the current change session, identifying the user-specified process being traced by the recorder module. The “Session Begin” message includes all the information needed to create the new change session and change process records, including any tag information, the command being run, the user making the request, any operating system process environment information about the process being traced, and the current time. The recorder module 604 also passes along any user-specified tag data for description, authorization, identification, digital signature, security, privacy or authentication of the change session. Multiple steps, sub-messages and replies may be used within the “Session Begin” as needed for authentication. The session module 603 returns a unique identifier for the newly created change process record. All subsequent messages from the recorder module 604 to the session module 603 that refer to items or changes by the used-specified process within the context of the current session will include the unique identifiers for the current session and process being traced. Execution proceeds to step 15-8, in which a sub-module is invoked to trace and record the specified process. The sub-module is described subsequently in FIG. 16. After the sub-module completes, execution proceeds to step 15-9, which sends a “Session End” message to the session module. The “Session End” message notifies the session module 603 that the execution of the recorder module 604 has completed and that any post-processing for the current change session may now be performed. The recorder module 604 also passes along any final user-specified tag data for description, authorization, identification, digital signature, security, privacy or authentication of the change session. At this point, execution of the recorder module 604 ends.

FIG. 16 shows in simplified block diagram form a sub-module to trace and record a specified process as part of the recorder module 604 of the example embodiment of the present invention. Step 16-1 checks if the specified process is already being traced. If so, execution of the sub-module completes and execution returns back to the module that invoked this sub-module. If the process is not already being traced, step 16-2 begins tracing the specified process. The mechanisms for tracing processes vary across operating system to operating system and many such approaches are available to those skilled in the art. The present embodiment uses the ptrace and/proc facilities provided by the Linux®, Solaris® and other Unix®-compatible operating systems and makes use of the NT Kernel Logger facilities of the Windows Management Interface (WMI) Kernel Event Tracer. Two commonly used models for tracing processes are interception and logging. In interception models, a tracer intercepts system calls and the traced processes may only proceed with their execution after the tracer processes the intercepted notification of the system call and enables the traced process to proceed. In such interception models of system call tracing, tracing is synchronous with the execution of the traced process. The ptrace facility is one example of an interception model. Further details and examples of the use of the ptrace may be found in the manuals for the Linux™, Solaris™ or other UNIX™-compatible operating systems, and in the following reference articles:

R. Rodriguez, “A System Call Tracer for UNIX”, by, Usenix Summer Conference, 1986, Atlanta, Ga. Padala, Pradeep, “Playing with ptrace, Part I and 11”, Linux Journal, November 2002.

In the Windows™ operating system family, several forms of an interception model called system-call or API hooking are described in the Microsoft™ documentation, as well as in the following reference article:

Ivanov, Ivo, “API Hooking Revealed”, available from

http://www.codeguru.com/system/apihook.html

In logging models, the tracer receives system call notifications in a stream but the system calls of the traced processes are permitted to proceed without waiting for the tracer. Such logging models of system call tracing are asynchronous with the execution of the traced process. The NT Kernel Logger facility is one example of a logging model, described within the Microsoft™ Windows™ NT manuals and in:

Tunstall, Craig and Cole, Gwyn, “Developing WMI Solutions: A Guide to Windows Management Instrumentation”, Addison-Wesley, 2003. (Chapter 13: High-Performance Instrumentation and Event Tracing)

The present invention is capable of operating with both interception and logging facilities. Many facilities exist or may be constructed for tracing processes within modern operating system process environments, kernels, hardware or firmware, and may be used for embodiments of the present invention without departing from the scope of the present invention.

Step 16-3 waits for the next trace event to occur and checks if the next trace event is a request or signal that tracing should be ended on any processes presently being traced. If so, execution proceeds to step 16-4 in which tracing for any specified processes is terminated as requested. The example embodiment of the present invention also terminates any processes that result from commands started by the recorder module 604 as indicated in step 15-5 in FIG. 15, but allows any traced processes to continue that were not started directly or indirectly by the recorder module 603. Referring to FIG. 16, after step 16-4, execution completes and returns to the module that invoked this sub-module.

If step 16-3 detected no requests or signals for tracing to be ended, execution proceeds to step 16-5, which checks if any traced processes have terminated or exited independently of the recorder module 604. If so, execution proceeds to step 16-6, in which the recorder module 604 sends a “Session End Process” message to the session module 603 to indicate the termination of a traced process, so that the session module 603 may update any relevant records in the ChangeProcesses table 701. After the “Session End Process” message is sent, execution proceeds to step 16-7, which checks if any processes are still being traced by the recorder module 604. If so, control loops back to step 16-3 to continue tracing any remaining processes. If step 16-7 determines that no more processes remain to be traced, then execution of this sub-module completes and returns to the module that invoked this sub-module.

If step 16-5 detected that no traced processes have terminated since the last time the check was executed, then execution proceeds to step 16-8, which checks if a system call notification has been received from any process being traced by the recorder module 604. If so, execution proceeds to step 16-9 in which a sub-module is invoked to handle the system call notification, described subsequently in FIG. 17. After the sub-module completes and returns, execution loops back to step 16-3 to continue tracing. If no system call notification was received in step 16-8, execution loops back to step 16-3 to continue tracing.

Recorder Module System Call Handling

FIG. 17 shows in simplified block diagram form a sub-module to handle system call notifications received by the recorder module 604 of the example embodiment of the present invention. Since the list of system calls varies across operating systems, the example embodiment of the present system contains lists of system calls categorized by their effect on data items. Step 17-1 checks if the system call in the notification is one that would cause a change to an existing data item. Such system calls include any calls that open a data item to write or append data, result in truncation or extension of a data item, modify the metadata or attributes of a data item, send a signal to another process or process group, manipulate device or system parameters, change dynamic linkage between items, etc. If the system call in the notification is one that would cause any kind of change to a data item including changes to the item's metadata such as ownership, linkage, dependencies, prerequisites or permissions, or the item's contents, step 17-2 parses the system call parameters to determine the item name and type of change, verifies that the item matches one of the item specifications read in by the configuration module 601, and then sends an “Item Changed” message to the session module 603, identifying the item, the changes made to it, the type of change and any additional information about the change as well as the current session and the process that made the change. After step 17-2 completes, execution of the sub-module completes and returns to the invoking module.

If the system call is not one that would cause a change in an item, execution proceeds from step 17-1 to step 17-3, which checks if the system call is one that would cause an item to be renamed, including any changes to the item's parentage within a hierarchy. If so, step 17-4 parses the system call parameters to determine the item's old and new names, verifies that at least one of those names matches one of the item specifications read in by the configuration module 601, and then sends an “Item Changed” message to the session module 603, identifying the item's old and new names, as well as the current session and the process that made the change. After step 17-4 completes, execution of the sub-module completes and returns to the invoking module.

If the system call is not one that would cause an item rename, execution proceeds from step 17-3 to step 17-5, which checks if the system call is one that would cause an item or a new link to an item to be created. Such system calls include those that create, open, configure, link or memory map items. If so, step 17-6 parses the system call parameters to determine the item's name, verifies that the name matches one of the item specifications read in by the configuration module 601, and then sends an “Item Created” message to the session module 603, identifying the item's name, the type of the item, any additional information about the item as well as the current session and the process that made the change. If the item being created is a link to or dependency on another item, then both items are verified against the item specifications and if either one matches, the “Item Created” message will be sent in this step, with the item being linked to as the new item value and the type of the item indicating the type of link, whether a symbolic, shortcut, name reference, a direct or indirect reference to another item, hard link, library loading, memory mapping, device binding or other type of linkage or dependency. After step 17-6 completes, execution of the sub-module completes and returns to the invoking module.

If the system call is not one that would cause an item creation, execution proceeds from step 17-5 to step 17-7 which checks if the system call is one that would cause an item to be deleted. If so, step 17-6 parses the system call parameters to determine the item's name, verifies that the name matches one of the item specifications read in by the configuration module 601, and then sends an “Item Deleted” message to the session module 603, identifying the item's name, as well as the current session and the process that made the change. After step 17-6 completes, execution of the sub-module completes and returns to the invoking module.

If the system call is not one that would cause an item deletion, execution proceeds from step 17-7 to step 17-9, which checks if the system call is one that would change the current working directory or any other context of the process being traced. Since system calls may refer to item names with an absolute or full pathname, or a pathname that is relative to the working directory or some other context of the process, the change tracer has to keep track of the working directory of any process being traced as well as all other context that may be referenced by item names, and use this context to properly normalize any item names seen in the system call parameters to create an accurate item name. If step 17-9 determines that the context changed, execution proceeds to step 17-10, which parses the system call parameters to determine the new working directory or context and updates a copy of all context that the recorder module 604 keeps about each process being traced. After step 17-10 completes, execution of the sub-module completes and returns to the invoking module.

If the system call is not one that would change the current working directory or other context of the process, execution proceeds from step 17-9 to step 17-11, which checks if the system call is one that would create a new process. If so, step 17-12 sends a “Session New Process” message to the session module 603 with the operating system process identifier and any other process parameters. Execution then proceeds to step 17-13, which starts tracing the newly created process in addition to all processes presently being traced. The identifying details of the newly created process are also added to the details of all processes presently being traced, kept within a data structure in the recorder module 604. After step 17-13 completes, execution of the sub-module completes and returns to the invoking module.

If the system call is not one that would create a new process, execution proceeds from step 17-11 to step 17-14, which checks if the system call is one that would initiate or terminate communication from the process being traced to another process not currently being traced. The recorder module 604 maintains a list of all communication attempts by a process being traced and identifies the targets of such communication. Since much communication between processes is between parent and child processes that are created by the parent process, many of the processes being communicated will already be traced because of earlier invocations of step 17-13 when those child processes were created. If step 17-14 determines that communication is being attempted to a process that is not traced that could cause a change to a data item, or communication is being terminated to a process that is already being traced, execution proceeds to step 17-15, which sends a “Session Connect” to the session module 603 containing information about the source process and destination of the connection. The destination of the communication may either be local in the same operating system process environment as the process being traced, or may be on a remote host in a different operating system environment from the process being traced. This “Session Connect” enables the session module 603 to determine whether the change tracer should be activated or deactivated across more processes in order to trace change and thus automatically expand and shrink its coverage as necessary to cover the inter-process communication that is typical and pervasive in modern distributed systems. Such automatic trace coverage is part of the dynamic, distributed change tracer activation within the present invention. After step 17-15 completes, execution of the sub-module completes and returns to the invoking module.

If step 17-14 determines that the system call is not one that would attempt communication, execution of the sub-module completes and returns to the invoking sub-module.

Changes may be made to the sequence or implementation of system call notification processing within this sub-module based on the defined semantics of system calls in different operating system process environments without departing from the scope of the present invention. Even though the example embodiment of the present invention has been described in terms of a system call API in which a system call affects a single operation or change, system call APIs in which system calls cause multiple operations or changes can be handled by decomposition and iteration within the scope of the present invention. The example embodiment of the present invention permits multiple invocations of the recorder module 604 to execute simultaneously and concurrently for different sets of processes as desired by the user. Many choices for implementation exist within the scope of the present invention such as a single recorder module that traces all processes, or one recorder module per process. Further, the present invention is not restricted by any particular form of inter-process communication and that many communication protocols and formats may be analyzed and traced to detect changes caused by groups of processes communicating with each other without departing from the scope of the present invention.

Query Module

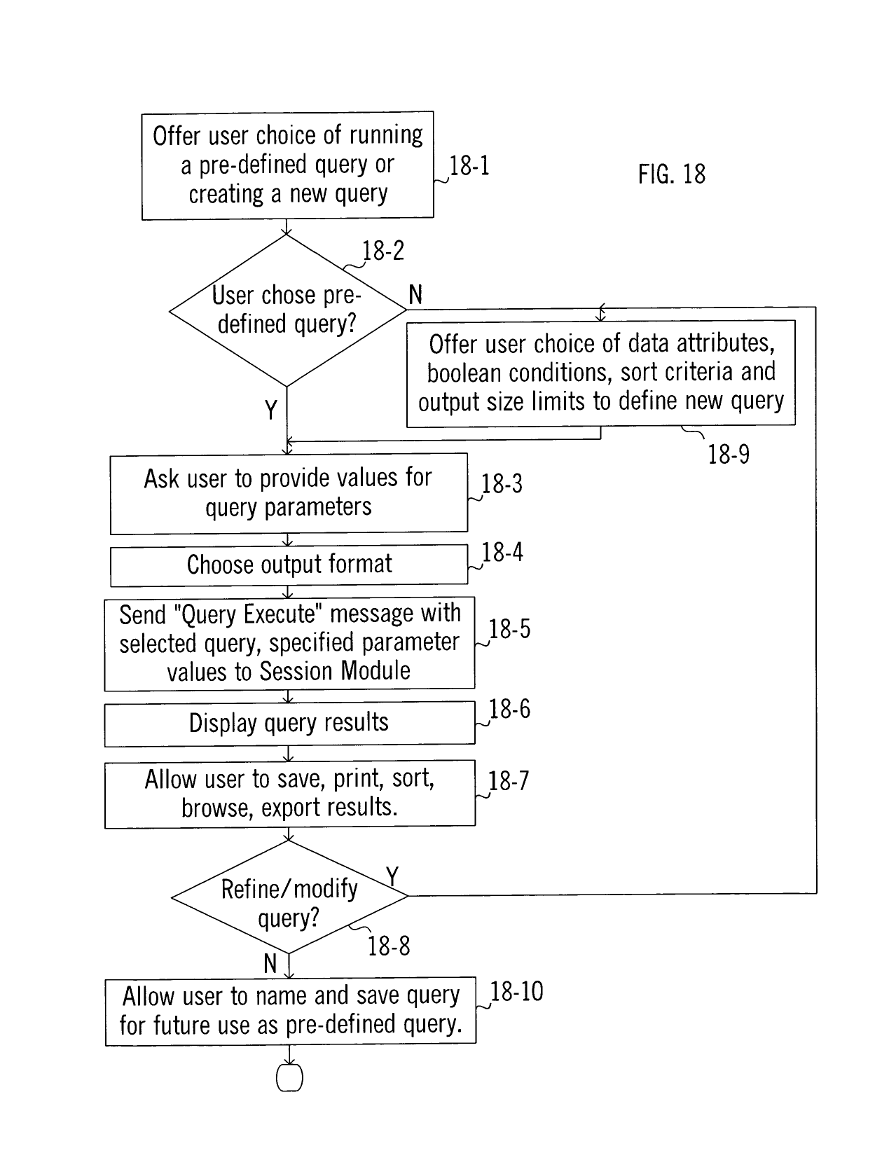

FIG. 18 is a simplified flow chart describing one example embodiment of the query module 606 according to the example embodiment of FIG. 6. Users of the example embodiment of the present invention invoke the query module 606 to examine and analyze the previously recorded change history from the change tracer database 301. In step 18-1, the query module offers a user a choice of running an existing pre-defined query or creating a new query. User choice may be input in many forms, including data input through a command-line interface, data files, network stream data or from a graphical user interface with selection lists, text entry fields, menus, buttons, radio-buttons, checkboxes or other widely used input forms. The form of user input does not restrict the scope of the present invention. The list of available pre-defined queries is obtained from system storage 108 or provided with the program modules representing the example embodiment of the present invention. All queries are expressed in Structured Query Language (SQL) in the example embodiment of the present invention, but the scope of the present invention is not limited by the choice of query language or query specification. Pre-defined queries are also stored in system storage 108 and include a list of query parameters that will be requested from the user before the query may be executed. After accepting the user choice, execution proceeds to step 18-2, which checks if the user chose a pre-defined query. If so, the query chosen by the user is referred to as the specified query and execution proceeds to step 18-3 in which the specified query is examined for any parameters that are required before the query may be executed. The user is asked to provide these parameters. Some parameters may have default values, which can be over-ridden by the user. The example embodiment of the present invention checks the parameters provided by the user to verify that their values fall within acceptable bounds. If the user chose not to use a pre-defined query, execution proceeds instead to step 18-9 in which the user is provided a query editor to create a new query by choosing or defining the query in terms of data fields or attributes from different tables in the change tracer database 301, boolean logic conditions, sort criteria, limits of the size of the output from the query, or other aspects of the query language provided by embodiments of the present invention. The user may also indicate in the query editor that certain parts of the query are query parameters that must be provided by the user for every query execution, and may provide default values for such query parameters. After step 18-9, execution proceeds to step 18-3 to provide query parameters for the newly created query.

After step 18-3, execution then proceeds to step 18-4 in which the user is offered a choice of any formats or devices that the query module can display output from queries. Within the example embodiment of the present invention, such formats may be graphical tabular displays, textual tabular displays, or textual structured formats such as comma-separated files or file package archive formats. Many forms of pre-defined query and output formats may be added or removed without departing from the scope of the present invention, including visual changes like natural language, character set, color, font, spacing, separation or encoding characters, comments, tabular or paragraph formatting, data compression or other transformation functions, etc.

Step 18-5 sends a “Query Execute” message to the session module 603 along with the complete query and specified parameter values. The session module 603 executes the query on the change tracer database 301 and responds with the results of the query. Many embodiments of database query, implementation, communication, security, access control and format are possible without departing from the scope of the present invention. Embodiments may choose to implement direct access from the query module 606 to the change tracer database 301 without departing from the scope of the present invention. Step 18-6 displays the results of the query in a suitable output format on the previously selected output device. In step 18-7, based on the query device, the user is permitted to perform operations on the query output, including saving the output to system storage 108 or to a network destination via available transport such as e-mail, printing the query output to suitable printer devices, sort the query output data, display the query output interactively in records, groups or pages so that the user may browse sections of the results, or export the query results to other program modules via standard data interchange formats such as SQL, XML, comma-separated value lists or the data formats of various script programming languages.

Step 18-8 offers the user the opportunity to refine or modify the query, to expand or reduce or completely alter the results of the query. If the user chooses to refine or modify the query, execution loops back to step 18-9 to permit the user to edit the query, including offering a choice of any combination of data attributes from any of the tables in the change tracer database 301 as well as boolean logic conditions, sort criteria, string or sub-string concatenation, slicing, combination, search or matching operators or functions, date and time arithmetic or search functions, or general mathematical and computational operators or functions on any data attributes or combinations thereof, and output size limits or other SQL language forms that comprise a query. The set of operators, functions, logic conditions, sort criteria and other SQL language forms may be varied without departing from the scope of the present invention. If the user chooses not to refine or modify the query in step 18-8, execution proceeds to step 18-10 in which the user is allowed to provide an identifying name for the query and a location to save it in system storage 108 for future use as a pre-defined query. By providing no such name, the user may skip this step in the example embodiment of the present invention. Execution of the query module 606 then completes.

A wide range of queries may be specified and provided without departing from the scope of the present invention. Such queries are not restricted only to diagnosis and analysis. When combined with the output format flexibility offered by the example embodiment of the present invention, queries that obtain some or all changes from a specified change session or to a specified data item sorted such that the output format may be used to automatically reverse the changes, provide a copy of such changes to repeat the same changes on remote hosts, reverse the changes from an incomplete change session that failed because of interruption or failure in some underlying component in the computing environment, compare the change history of different items or sets of items, etc. Queries may be executed one or more times with pre-stored parameters from scheduled or batch command execution facilities. The output of queries may be transported to remote hosts by a variety of network transport mechanisms and protocols, including e-mail, Hyper Text Transport Protocol (HTTP), remote procedure call (RPC) or remote shell or copy (RSH, RCP) or secure remote shell or copy (SSH, SCP) or file transfer protocol (FTP). Thus, the query facility provides users of the present invention access to the items, links, changes, change processes, change sessions and other associated information stored in the change tracer database with which the users may then construct or integrate with additional systems for their own use.

Session Module

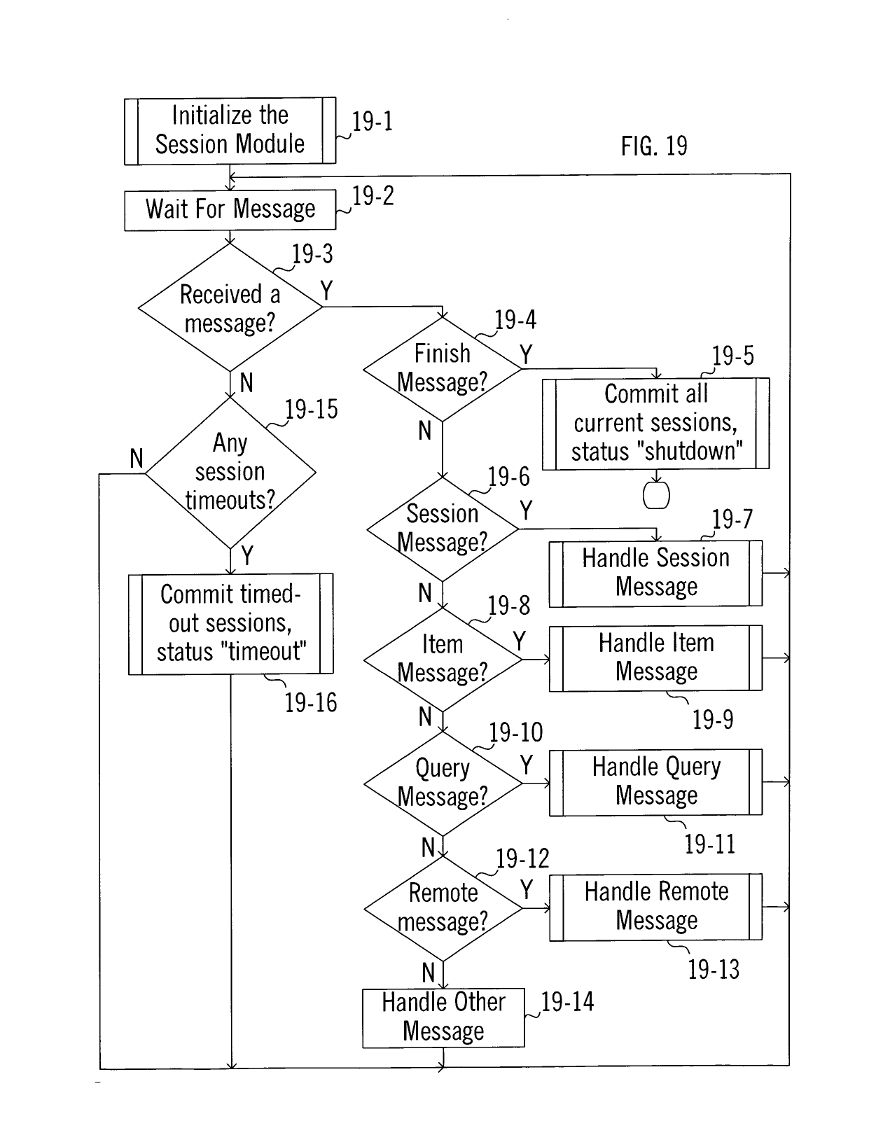

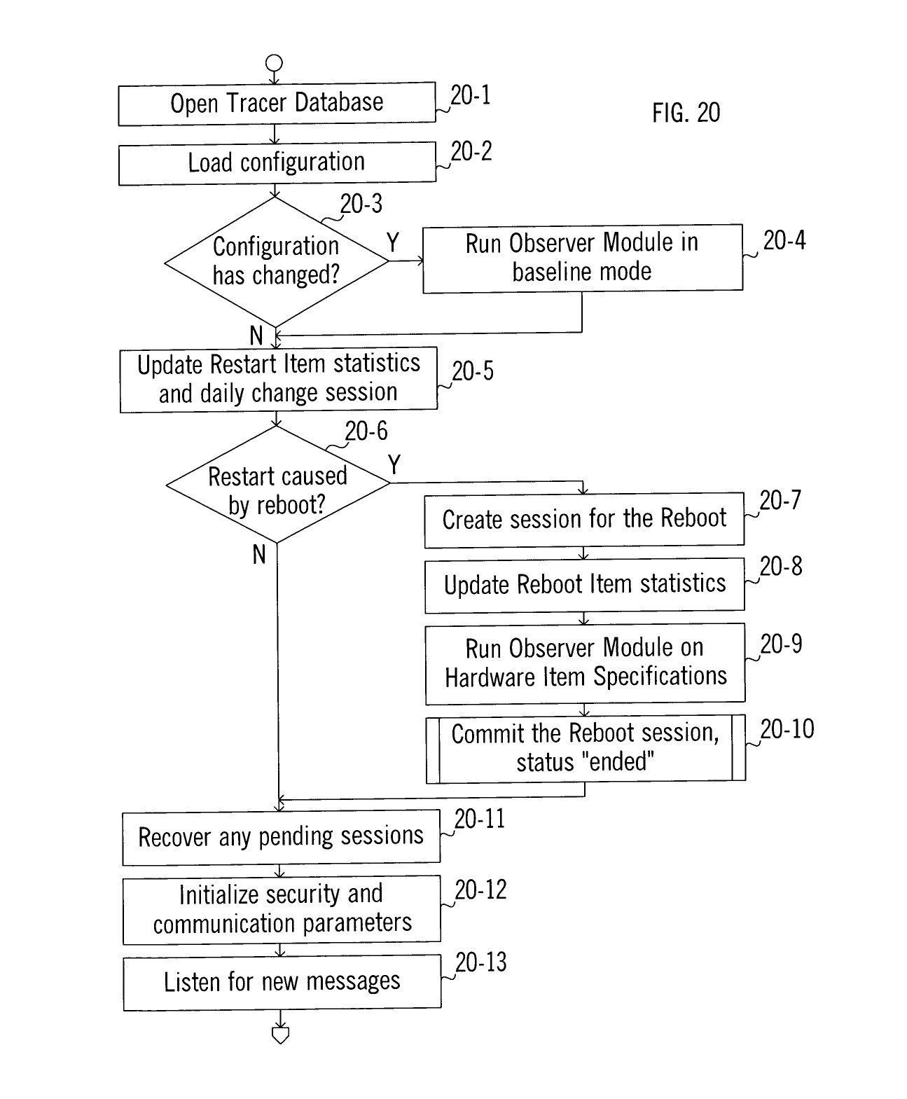

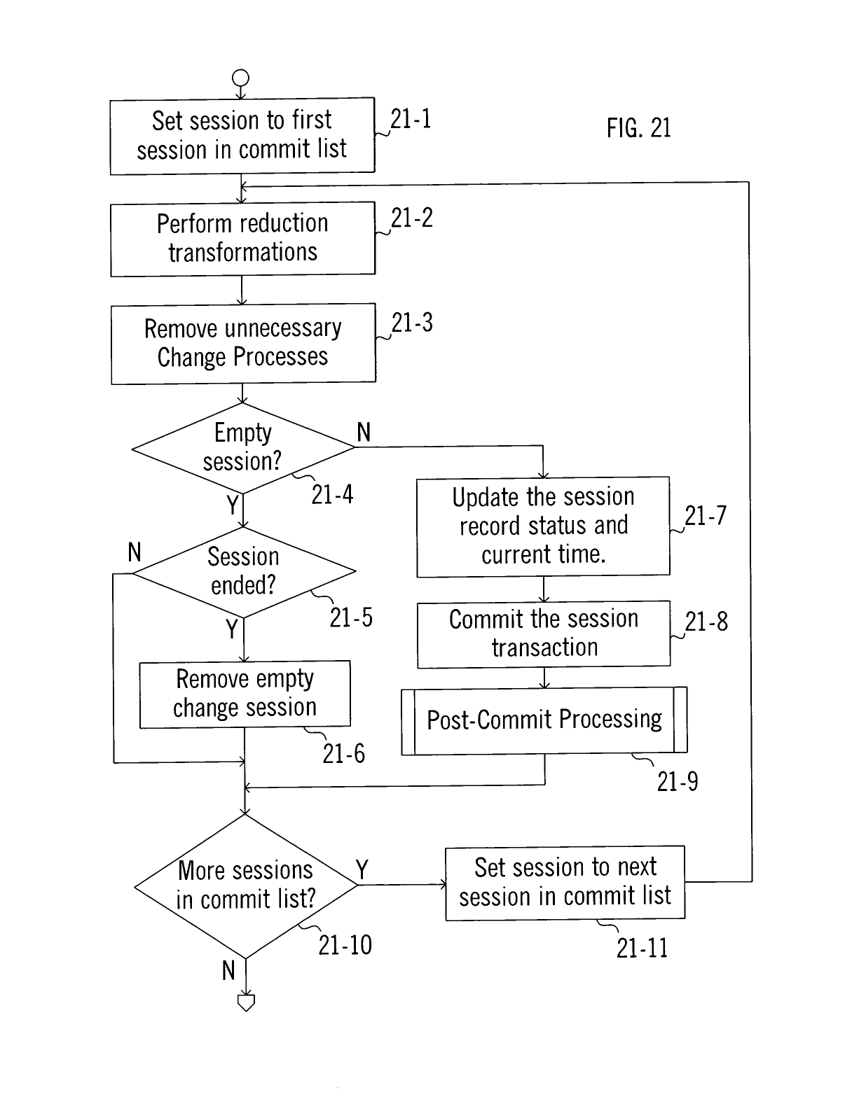

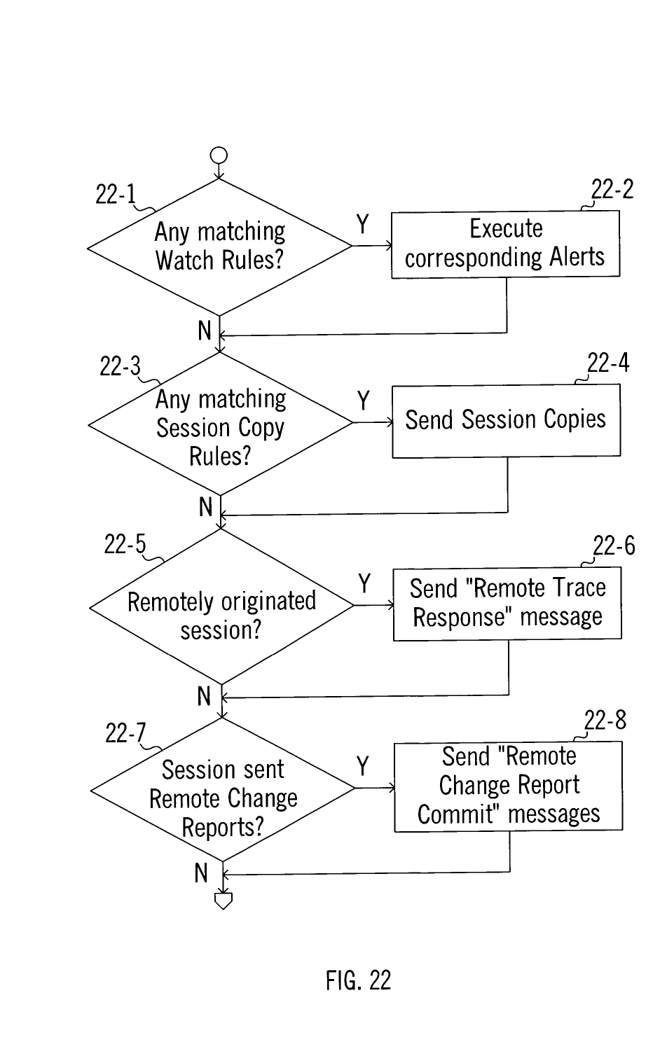

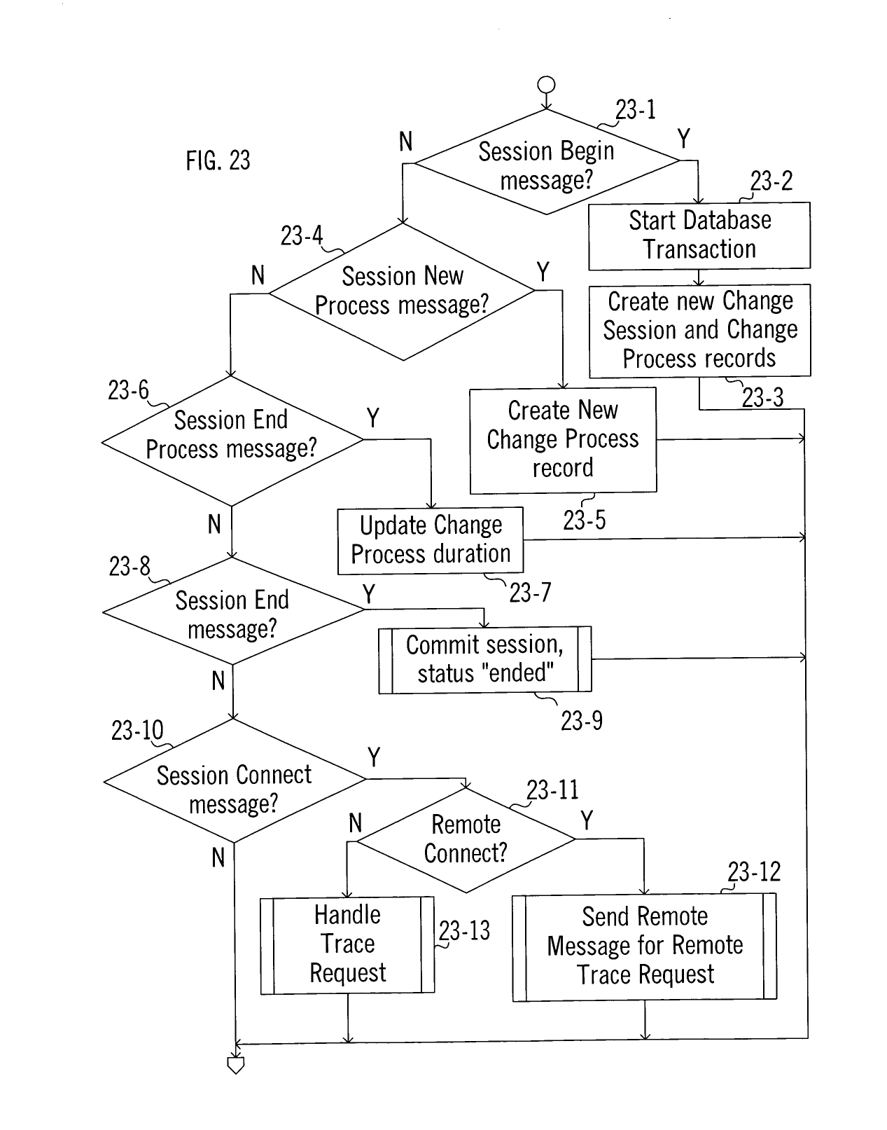

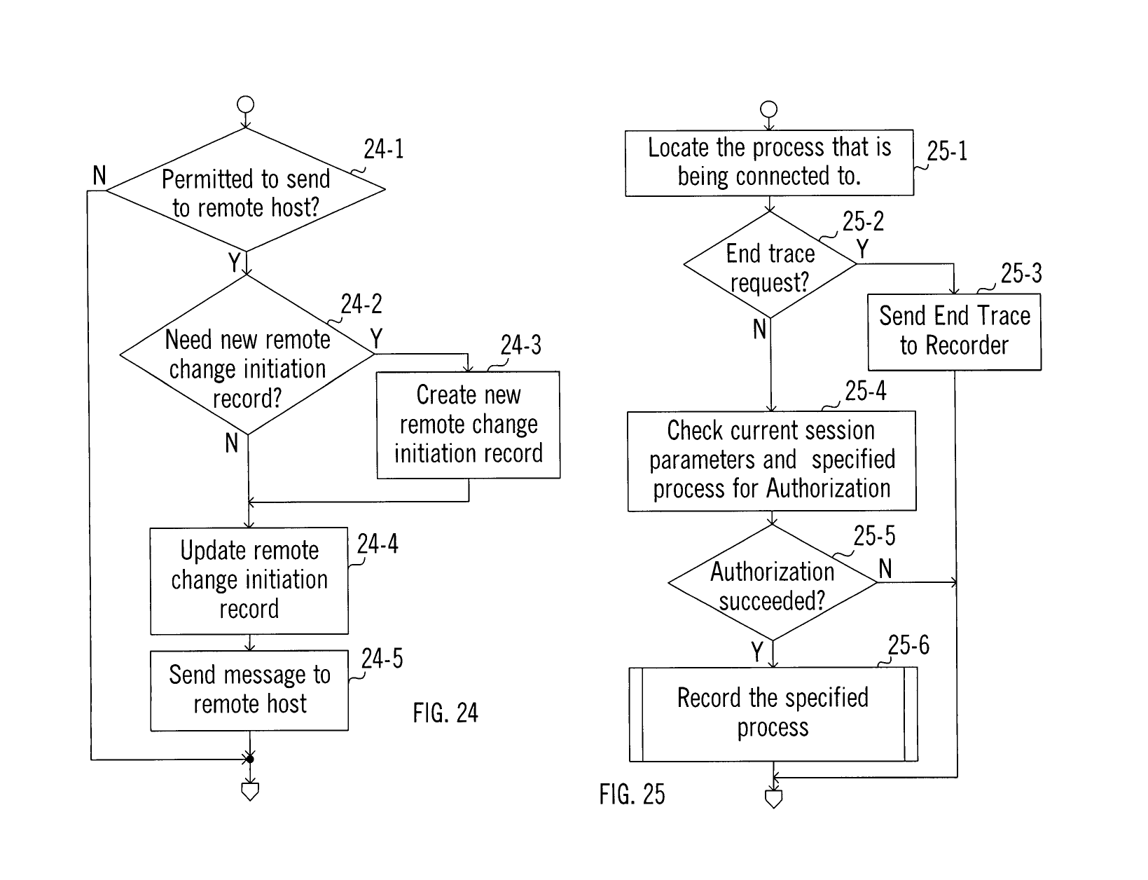

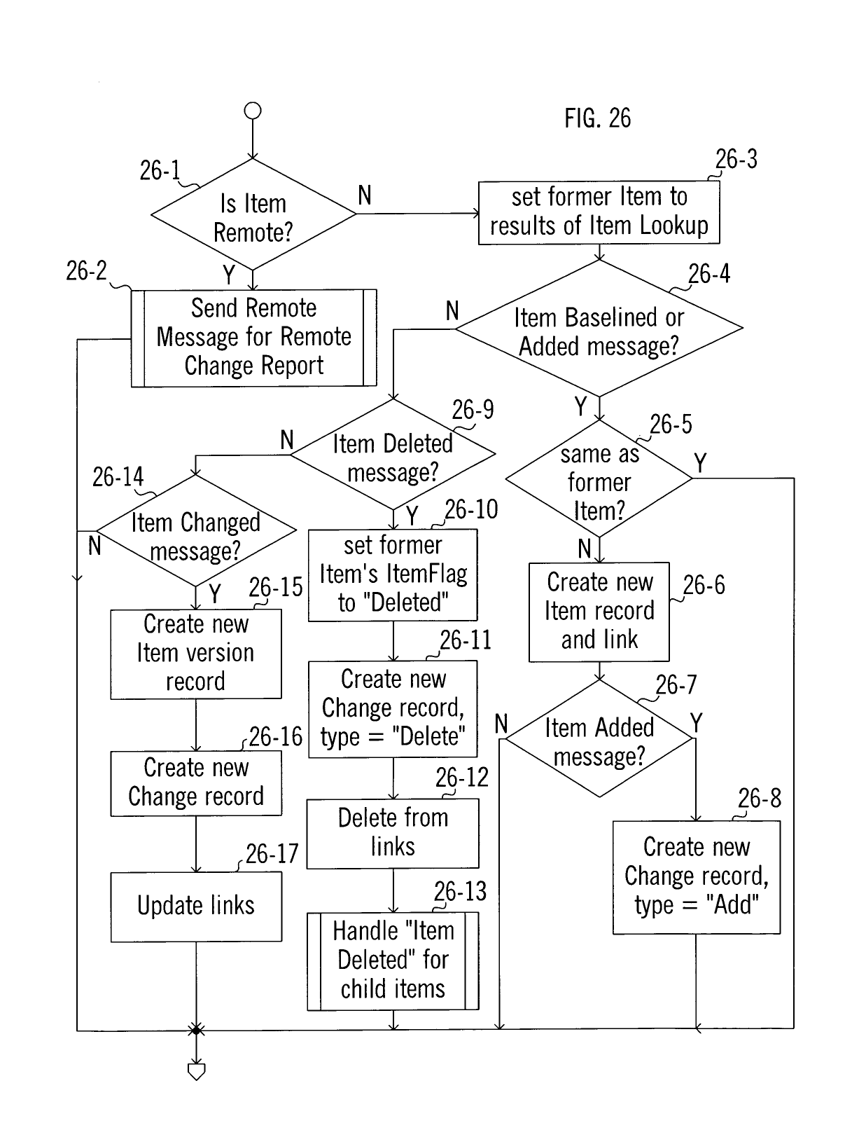

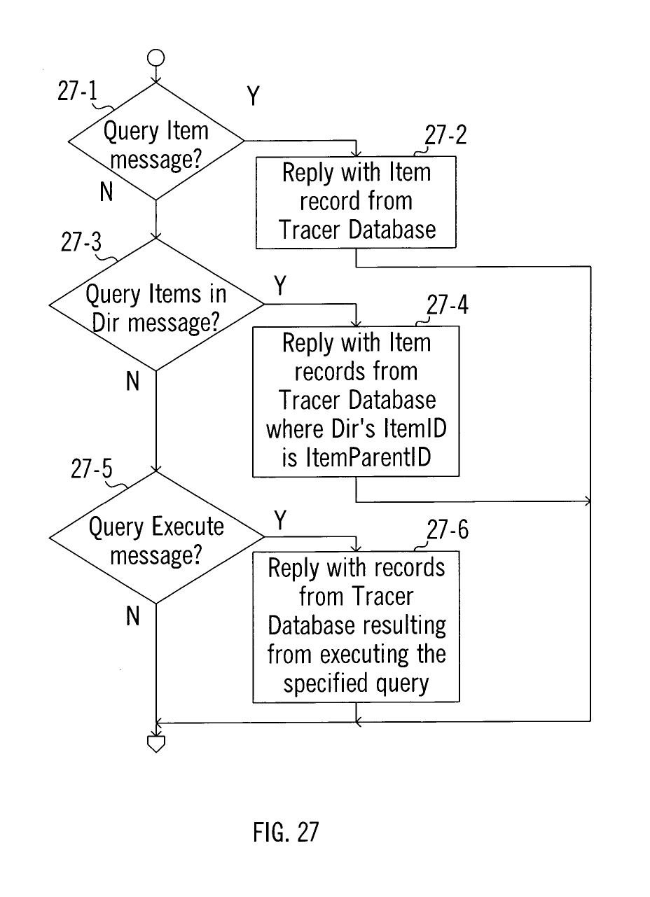

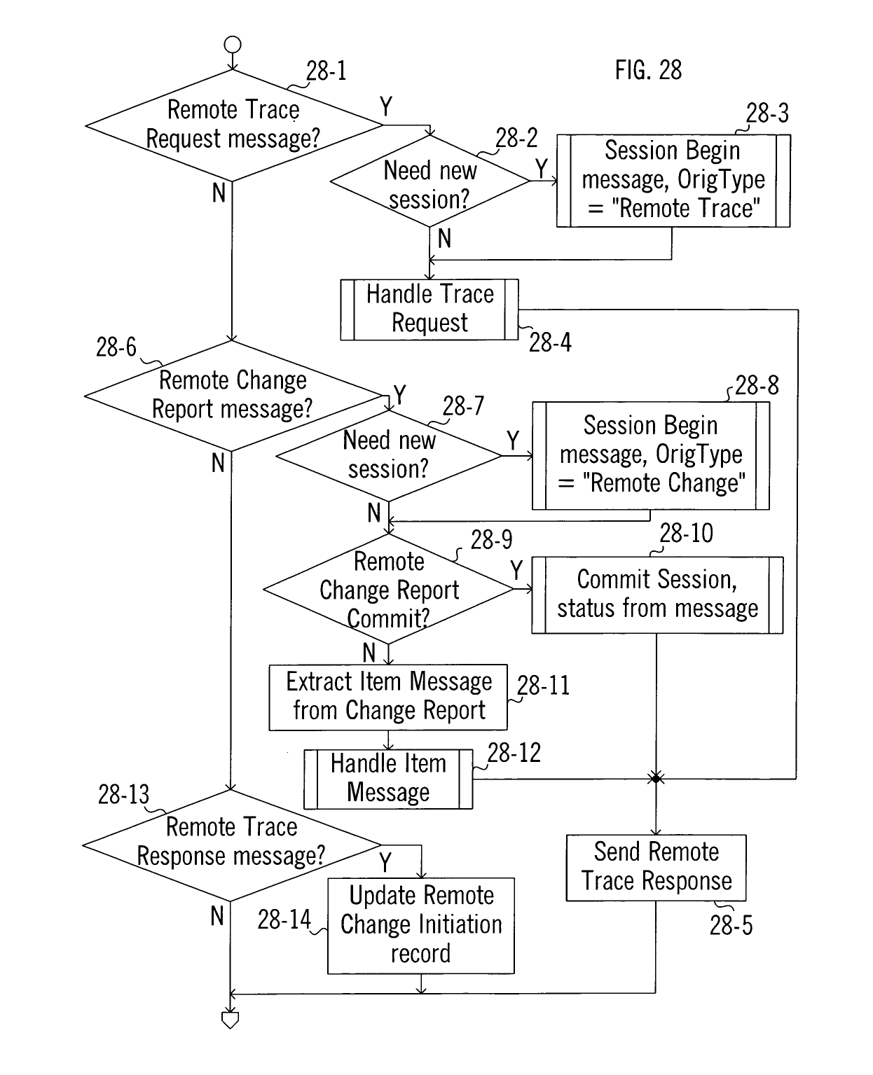

FIG. 19 is a simplified flow chart describing the session module 603 according to the example embodiment of FIG. 6, with sub-functions further described in simplified flow charts as FIG. 20, FIG. 21, FIG. 22, FIG. 23, FIG. 24, FIG. 25, FIG. 26, FIG. 27 and FIG. 28.

The session module 603, receives communication from all the other modules in the example embodiment of the present invention and organizes all changes to data items into change sessions and is responsible for all transactions required to store and retrieve change session data from the change tracer database 301 in the example embodiment of the present invention. The session module 603 maintains a list of all current sessions for all modules presently executing, so that it can process each message received within the context of the appropriate session.

In step 19-1, the session module 603 is initialized to provide access to the change tracer database 301, invoke the configuration module 601 and prepare communications to start listening for local and remote messages. The details of session module initialization are shown in FIG. 20, described subsequently. After initialization, step 19-2 waits for new messages, signals or timer events that indicate no new messages have been received for an interval. Step 19-3 checks if a message has been received. If so, execution proceeds to step 19-4, but if no message has been received, then execution proceeds to step 19-15. Step 19-4 checks if the message or signal received indicates that the session module should finish its operations and terminate. If so, execution proceeds to step 19-5 in which the session module invokes a sub-module to commit all current sessions as described subsequently in FIG. 21. A commit of a change session involves all change tracer database records for change processes, remote change initiations, changes and affected items associated with the change session to be written to the database, change session statistics and status update, and various post-processing performed on the session if any alerts, session copies or remote messages are required.

In step 19-5, the commit uses status code of “shutdown”, augmented with the type of finish message received. This status code serves as an indicator in the database that the session may not have ended normally and may need to be resumed if the session module 603 is restarted with the change sessions still executing. If the session module 603 is terminated while any observer or recorder modules are still running, then those modules may temporarily hold or discard data from sessions until a new session module is started. After the sub-module for committing sessions is executed, the session module 603 completes its execution.

Since the session module supports a wide variety of messages, messages are classified into a variety of categories, using the first word of the message as a designator. The four major categories are “Session”, “Item”, “Query” and “Remote”. Step 19-6 checks if a message falls into the “Session” category, which includes “Session Begin”, “Session End”, “Session New Process”, “Session End Process” and “Session Connect” messages. If so, execution proceeds to step 19-7, which invokes a sub-module described subsequently in FIG. 23 to handle the “Session” message, after which execution loops back to step 19-2 to wait for another message.

Step 19-8 checks if a message falls into the “Item” category, which includes “Item Baselined”, “Item Added”, “Item Deleted” and “Item Changed” messages. If so, execution proceeds to step 19-9, which invokes a sub-module described subsequently in FIG. 26 to handle the “Item” message, after which execution loops back to step 19-2 to wait for another message.

Step 19-10 checks if a message falls into the “Query” category, which includes “Query Item”, “Query Items in Dir”, and “Query Execute” messages. If so, execution proceeds to step 19-11, which invokes a sub-module described subsequently in FIG. 27 to handle the “Query” message, after which execution loops back to step 19-2 to wait for another message.

Step 19-12 checks if a message falls into the “Remote” category, which includes “Remote Trace Request”, “Remote Change Report” and “Remote Trace Response” messages. If so, execution proceeds to step 19-13, which invokes a sub-module described subsequently in FIG. 28 to handle the “Remote” message, after which execution loops back to step 19-2 to wait for another message.

Step 19-14 is executed if message falls into none of the previous categories. In the example embodiment of the present invention, there exist maintenance messages, which may be sent by a user of the example embodiment of the present invention to request operating parameters and statistics from the session module 603, report module status, request that a consistent backup of the change tracer database be made or that the log files to which the change tracer writes debugging or error messages be rolled over to new copies to permit the old log files to be compressed, deleted or archived. The maintenance message is processed in step 19-14. Unrecognized messages cause step 19-14 to record an error in the operating system log. After step 19-14, execution loops back to step 19-2 to wait for another message. The form and function of maintenance messages may be varied to suitably control the operation of the change tracer without departing from the scope of the present invention.

If step 19-13 does not detect any received message, execution proceeds to step 19-15, which checks if any sessions have reached timeout values. Session timeouts are configuration time interval values that are used to detect any sessions that may have gone idle for a long time, or have sent a large amount of data since the beginning of the session or the last commit of the session, as well as sessions that may have terminated or aborted before notifying the session module 603 via a “Session End” message. If any sessions are detected to have reached timeout values, execution proceeds to step 19-16 in which such timed-out sessions are committed to the database by invoking a sub-module, described subsequently in FIG 21. The status “timeout” is used for these committed sessions. Execution then loops back to step 19-2 to wait for another message.

Many categorizations of messages and sequences for message handling may be used, message types added or deleted, and various forms of inter-process communication, security, sub-module organization and prioritization may be used within the scope of the present invention. All database operations resulting from a single message are executed as a single atomic update or sub-transaction within the context of the overall change session transaction by the example embodiment of the present invention. Many implementations of atomic update aid the associated serialization are possible to ensure coherency and integrity of the database, without departing from the scope of the present invention.

Session Module initialization

FIG. 20 shows in simplified block diagram form a sub-module to initialize the session module 603 of the example embodiment of the present invention. Step 20-1 opens the change tracer database and initializes any database parameters. In the example embodiment of the present invention, only one session module 603 is permitted to execute at any time, since the session modlie 603 coordinates the data activity of all other modules. Execution of multiple session nodules, synchronized with each other using widely understood synchronization primitives is also possible within the scope of the present invention. Step 20-2 invokes the configuration module 601 to load any configuration parameters. Step 20-3 checks if the configuration parameters have changed since the last execution of the session module. If so, execution proceeds to step 20-4 to start the observer module 604 with the baseline parameter set in order to update the baseline since any item specifications may have changed. In the example embodiment of the present invention, the observer module 602 continues to execute asynchronously so that the session module 603 can proceed without needing to wait for the observer module 602 to complete execution. Execution of the session module proceeds to step 20-5. If the configuration parameters were not changed, execution proceeds from step 20-3 to step 20-5.

Step 20-5 updates various data items that represent operating statistics about change tracer restarts, maintained by the session module 603. In the example embodiment of the present invention, the number of restarts of the session module, the times of the first execution and most recent restart of the session module, and any detectable reason for the restart are recorded as items within the change tracer database 301. On its first execution, the session module 603 also creates a change session for recording such statistics with a timeout set to one day, so that a new session is automatically created every day. The session module 603 may record any other exceptional events such as device status changes in this daily change session. Execution proceeds to step 20-6 to check if the restart was caused by a reboot, cold-start or re-initialization of the operating system process environment. If so, a new change session is created in the database to record any changes associated with the reboot. Execution proceeds to step 20-7 in which various reboot statistics items are updated. In the example embodiment of the present invention, the number of reboots of the operating system process environment detected by the session module 603, the times of most recent reboot, and any detectable reason for the reboot are recorded as items within the change tracer database 301. Many other forms of statistics for restarts and reboots may be stored or calculated without departing from the scope of the present invention. Execution proceeds to step 20-9 in which an observer module 602 is invoked asynchronously to check for any changes in any item specifications associated with device hardware. In the example embodiment of the present invention, concurrently executing observer modules synchronize with each other using widely understood synchronization primitives to avoid multiple observer modules examining the same item specification concurrently. Execution proceeds to step 20-10 in which the change session created in step 20-7 is committed with a status of “ended” by invoking the sub-module subsequently described in FIG. 21. Execution proceeds to step 20-11.

If step 20-6 detects that the restart was not caused by a reboot, then execution proceeds directly to step 20-11. In step 20-11, any pending sessions are recovered. Such sessions may have been left uncommitted if a preceding invocation of the session module 603 terminated or interrupted abruptly, without a proper finish message or time to commit all current sessions as in step 19-5 in FIG. 19, or if any observer or recorder modules are still executing from a previous invocation of the session module 603. Execution proceeds to step 20-12 in which security and communication parameters are initialized from the configuration read in by the configuration module 601. Execution proceeds to step 20-13 in which the session module 603 starts listening for new messages from either local or remote processes. Execution of the sub-module completes and returns to the module that invoked it.

Session Module Commit Processing

FIG. 21 shows in simplified block diagram form a sub-module to commit a specified list of sessions as part of the session module 603 of the example embodiment of the present invention. Step 21-1 sets the session to be committed to the first session in a list provided by the module that invokes this sub-module. The session to be committed is now referred to as the session. Step 21-2 analyzes the changes reported within the session to locate and condense intermediate changes by removing redundant intermediate changes, or replacing sequences of intermediate changes with equivalent sequences of changes to facilitate storage or subsequent understanding when such changes are viewed or queried. An example of a redundant intermediate change is the creation or addition of an item under one name after which the same item is renamed to a new name. This sequence may be condensed to the direct creation or addition of the item under the new name at the time of the rename. Another example of a redundant intermediate change is the renaming of an item atter which the newly named item is removed, which may be reduced to the direct removal of the item at the time of the rename. Another example is the creation of a temporary data item which is subsequently deleted within the same session. This may be condensed by removal of both the creation and deletion. Such redundant intermediate changes are often performed as part of the sequence of changes during the installation or update of software within an operating system process environment as a safety precaution to permit partial recovery after interruption of the installation or updates. Condensing such sequences retains the intent and scope of the change but reduces the “noise” perceived by a user when sequences of changes are viewed, queried or subsequently analyzed. Comparison of change sequences is made more accurate when sequences are condensed to a consistent canonical form.

Execution proceeds to step 21-3, which examines the change processes recorded during the change session and removes any change processes that are not associated with any changes in the session, since such change processes are unnecessary for analysis of the change session. Execution proceeds to step 21-4, which checks if the session has no changes, change processes or remote change initiations associated it in which case it is considered empty. If the session is empty, execution proceeds to step 21-5 in which any database transactions associated with the session in the change tracer database 301 are rolled back. Execution then proceeds to step 21-8. In step 21-4, if the session is not associated with at least one change, change process, or remote change initiation, it is considered empty. If the session is empty, execution proceeds to step 21-5, which checks if the session is being committed has ended. If so, execution proceeds to step 21-6, in which the empty change session is removed since it is no longer relevant. If the session being committed has not yet ended, then the empty session is allowed to remain and execution skips ahead to step 21-10. The reduction of redundant changes as well as the removal of unnecessary change processes and empty sessions will be appreciated as unique features that make the analysis of change sessions easier for the user of the present invention by automatically reducing unnecessary data.

If step 21-4 determines that the session is not empty, execution proceeds to step 21-7 to update the change session record in the ChangeSessions table 700 in the change tracer database 301 with the status as provided by the invoking module in the Status field 700-j, the current time as the StatusTime field 700-k, the Duration field 700-c as the difference between the current time and the StartTime field 700-b, the NumProcs field 700-q as the number of change processes associated with the session, the NumChanges field 700-r field as the number of changes associated with the session, and the NumRemote field 700-s as the number of remote change initiations associated with the session. Execution proceeds from step 21-7 to step 21-8 in which all change process, remote change initiation, change and affect records associated with the session as well as the change session record are committed to the change tracer database 301. At commits, any final digital signature or keyed hash updates may be performed to verify integrity and authenticity of the data. Execution then proceeds to step 21-9 to invoke a sub-module to perform post-commit processing on the change session, described subsequently in FIG. 22. After the sub-module execution completes, execution proceeds to step 21-10 to check if there are more sessions remaining in the list of sessions provided by the module that invoked this sub-module. If so, execution proceeds to step 21-11 to refer to the next session in the list as the session. Execution then loops back to step 21-2 in order to process all sessions in the commit list. If step 21-10 finds no sessions left in the commit list, execution of the sub-module completes and returns to the invoking module.

FIG. 22 shows in simplified block diagram form a sub-module to perform post-commit processing on a session as part of the session module 603 of the example embodiment of the present invention. Step 22-1 checks if any watch rules match any of the changes within the session being processed. If so, execution proceeds to step 22-2, which executes the alert actions that correspond to the matching watch rules after which execution proceeds to step 22-3. If no watch rules matched any changes within the session, execution proceeds to step 22-3, which checks if any session copy rules match any of the changes within the session. If so, execution proceeds to step 22-4, which sends copies of the session and all associated change processes, remote change initiations, changes and affected items to the corresponding session copy destinations, after which execution proceeds to step 22-5. If no session copy rules match any changes within the session, execution proceeds to step 22-5, which checks if the session was created in response to a remote trace request. If so, execution proceeds to step 22-6, which sends a remote trace response to a remote change tracer on the remote host that sent the remote trace request. After step 22-6, execution proceeds to step 22-7. If the session was not created in response to a remote trace request, execution proceeds to step 22-7 which checks if the session has sent any “Remote Change Report” messages 611 because items that were modified within this change session were accessed from any remote hosts. If so, “Remote Change Report Commit” messages are sent to any remote hosts that were sent remote change reports as part of this change session. “Remote Change Report Commit” messages identify this change session and include the status provided to the commit sub-module to indicate to a remote change tracer process that a corresponding remote commit should occur. After step 22-8, execution of the sub-module for post-commit processing completes and returns to the invoking module. If step 22-7 detects no “Remote Change Report” messages sent because of changes within this session, execution of the sub-module completes and returns to the invoking module.

Session Module Session Messages

FIG. 23 shows in simplified block diagram form a sub-module to process a “Session” message as part of the session module 603 of the example embodiment of the present invention. Step 23-1 checks if the message provided by the invoking module is a “Session Begin” message. If so, execution proceeds to step 23-2 to begin a new database transaction after which step 23-3 creates a record for the new change session in the ChangeSessions table 700 of the change tracer database 301 as shown in FIG. 7. A new unique value is generated for the CSID field 700-a in the record for the new change session and the StartTime field 700-b is set to the time the “Session Begin” message was sent, while the Duration field 700-c is set to 0. If the session is being created because of a user request on the local computer, then the OrigType field 700-f is set to indicate the session is created in response to a user command, the OrigHost field 700-e and OrigCSID field 700-g are set to null. If the session is being created in response to a remote message from a remote change tracer executing on a remote host, then the OrigType field 700-f indicates that the type of remote message that has caused the session to be created, the OrigHost field 700-e is set to the unique identifier of the remote host, and the OrigCSID field 700-g is set to the unique identifier of the remote change session that sent the remote message to cause the creation of this change session. The User field 700-d, Command field 700-h, StartDirectory field 700-i, TagType field 700-l, TagDescription field 700-m, TagChangeID field 700-n, Tag1 field 700-o and Tag2 field 700-p are all provided by the “Session Begin” message. The Status field 700-j indicates “new” and the StatusTime 700-k is set to the current time. The NumProcs field 700-q, NumChanges field 700-r, and NumRemote field 700-s are all set to 0. For locally originated sessions, the NumOrigHops field 700-t is set to 0. For sessions caused by a remote message, the value of the NumOrigHops field 700-t is set to the value sent by the remote change session, incremented by 1. Step 23-3 also creates a new change process record in the ChangeProcesses table 701, with a newly generated unique identifier in the CPID field 701-a, the OSProcInfo field 701-b and Command Field 701-e are set to any information provided in the remote message, the StartTime field 701-c is set to the time that the remote message was received, the Duration field 701-d is set to 0, and the OrigCPID field 701-f is set to the CPID provided in the remote message of the remote change process on the remote host that sent the message. The CSID field of the new change session record or some equivalently unique value that can be uniquely mapped back to this newly created change session record is included in the response returned to the sender of the Session Begin message. The CPID field of the new change process record or some equivalently unique value that can be uniquely mapped back to this newly created change process record is also included in the response returned to the sender of the Session Begin message. Embodiments may initialize counters, state variables, digital signature or keyed hash records in order to begin recording change session data and managing its integrity and authenticity. In order to enhance recovery of sessions after interruption, the example embodiment of the present invention creates a temporary file in system storage 108 to journal or spool information about change processes, remote change initiations, changes and affected items associated with this session as they occur so that reboots or restarts do not cause significant loss of data. Many other forms or no form of journaling or spooling may be used without departing from the scope of the present invention. Referring back to FIG. 23, after step 23-3, execution of the sub-module completes and returns to the invoking module.

If step 23-1 detects that the message is not a “Session Begin”, execution proceeds to step 23-4 to check if the message is a “Session New Process”. If so, execution proceeds to step 23-5, in which a new change process record is created in the ChangeProcesses table 701 in the change tracer database 301 as shown in FIG. 7. The identifier of the change session to associate with this new change process record, the OSProcInfo field 701-b, and the Command field 701-e are provided by the message. The StartTime field 701-b is set to the time reported by the “Session New Process” message and the Duration field 701-d is set to 0. A unique identifier for this new change process record is generated for CPID field 701-a and returned to the sender of the “Session New Process” message. Referring back to FIG. 23, after step 23-5, execution of the sub-module completes and returns to the invoking module.

If step 23-4 detects that the message is not a “Session New Process”, execution proceeds to step 23-6 to check if the message is a “Session End Process”. If so, execution proceeds to step 23-7, in which the change process whose end is being reported is located using a unique identifier included with the message. The Duration field 701-d in the change process record in the ChangeProcesses table 701 in the change tracer database 301 as shown in FIG. 7 is updated to the difference between the current time and the StartTime field 701-c for this change process record. Referring back to FIG. 23, after step 23-7, execution of the sub-module completes and returns to the invoking module.

If step 23-6 detects that the message is not a “Session New Process”, execution proceeds to step 23-8 to check if the message is a “Session End”. If so, execution proceeds to step 23-9, in which the session identified by the message is committed according the sub-module already described in FIG. 21, using status “ended”. After step 23-9, execution of the sub-module to process a “Session” message completes and returns to the invoking module.

If step 23-8 detects that the message is not a “Session End”, execution proceeds to step 23-10 to check if the message is a “Session Connect”. If so, execution proceeds to step 23-11. If step 23-11 determines that the “Session Connect” message indicates a remote destination host, execution proceeds to step 23-12. Step 23-12 invokes a sub-module to send a “Remote” message to a remote change tracer process on the remote host identified by the “Session Connect” message. This sub-module is subsequently described in FIG. 24. The “Remote” message sent is a “Remote Trace Request” message to the session module 603 of the remote change tracer process on the remote host. The “Remote Trace Request” message contains a unique identifier for the change session and change process identified by the “Session” message, as the value in the NumOrigHops field 700-t of the associated change session and any additional information about the connection attempt needed by the remote change tracer to identify the remote data modification process being connected to, typically identifying the communication protocol and port numbers or service names being used for the connection attempt. After step 23-12, execution of the sub-module completes and returns to the invoking module. “Session Connect” messages and the “Remote Trace Requests” which are generated allow the transparent, automatic tracing of processes within distributed networks.

If step 23-11 determines that the destination identified in the “Session Connect” message is a local process, execution proceeds to step 23-13. Step 23-13 invokes a sub-module described subsequently in FIG. 25 to perform a trace request for the local process. Thus, “Session Connect” messages also perform transparent, automatic tracing of processes involved in inter-process communication. After step 23-13, execution of the sub-module to process a “Session” message completes and returns to the invoking module. FIG. 24 shows in simplified block diagram form a sub-module to send a “Remote” message as part of the session module 603 of the example embodiment of the present invention. Step 24-1 first checks the Remote Host Permissions read in by configuration module 601 to ensure that communication is permitted with the remote host specified by the invoking module. If communication is permitted, execution proceeds to step 24-2, otherwise execution of the sub-module completes immediately and returns to the invoking module. In order to control and limit propagation of tracing, Remote Host Permissions may include a user-specified limit on the number of change tracers that may successively send “Remote” messages from change sessions that are in turn created in response to “Remote” messages. Such limits on the number of hops or the propagation depth prevent the remote trace from expanding recursively across remote hosts far beyond the original intent. The NumOrigHops field 704-j of the change session sending this remote message may be checked to verify that it is less than a specified user-specified hop limit in order to permit communication. The value in the NumOrigHops field 704-j is included with the “Remote Change Report” message to permit this check to be verified by successive change tracers that might themselves send a remote message. Well-understood mechanisms for associating hop counts with change sessions, setting the hop count of change sessions created in response to a “Remote” message to one greater than the hop count of the change session sending the “Remote” message, or other forms of propagation depth limits and loop detection may be used without departing from the scope of the present invention.

Step 24-2 checks if a new remote change initiation record is needed in the RemoteChangeInitiations table 702 associated with the session and change process sending the “Remote” message for the remote host. If so, execution proceeds to step 24-3 in which a new record is created in the RemoteChangeInitiations table 702. The new record identifies the RemoteHost to which the “Remote” message is being sent, after which execution proceeds to step 24-4. If step 24-2 finds that a remote change record associated with the change session and change process already exists, execution proceeds to step 24-4 in which the existing remote change initiation record is updated to indicate that another “Remote” message is being sent. If the message being sent is a “Remote Trace Message”, the “NumRemTraceRequests” field 702-e is updated. If the message being sent is a “Remote Change Report”, the “NumRemChangeReports” field 702-d is incremented by one. After step 24-4, execution proceeds to step 24-5 in which the message is sent to the remote host, following all the encoding, formatting, error-checking and encapsulation steps necessary for the communication protocol used by the example embodiment. Many communications protocols many be chosen over any form of network without departing from the scope of the present invention.

FIG. 25 shows in simplified block diagram form a sub-module to perform a trace request of a local process as part of the session module 603 of the example embodiment of the present invention. In step 25-1, the session module 603 locates the process that is being connected to, using information about the communication port, protocol and service provided to it by the “Session Connect” message by which the recorder module 604 notified the session module 603 about the attempted communication. The example embodiment builds and searches a list the communication ports, protocols and services listened to by all processes within the operating system process environment to find the process corresponding to the specified port, protocol and service. Step 25-2 checks if the trace request is for ending tracing of the process. If so, execution proceeds to step 25-3, which notifies the recorder module to end tracing of the specified process. After step 25-3, execution of the sub-module completes and returns to the invoking module. If step 25-2 determined that the trace request was not to end a trace, then execution proceeds to step 25-4 to check all the authorization policies and if necessary, the remote host permissions from the configuration module 601 to verify that a request to trace the process located by step 25-1 with the current session parameters is acceptable for tracing according to the authorization policies and any relevant remote host permissions. In step 25-5, if all the authorization policies and any relevant remote host permissions successfully confirm that this trace is acceptable, execution proceeds to step 25-6, which invokes the sub-module previously described in FIG. 16 to request the recorder module 604 start tracing the specified process as part of the same change session that reported the “Session Connect” message. Once the recorder module begins tracing the specified process, execution of this sub-module to perform a trace request completes and returns to the invoking module.

Session Module Item Messages

FIG. 26 shows in simplified block diagram form a sub-module to handle an “Item” message as part of the session module 603 of the example embodiment of the present invention. Step 26-1 uses the name of the item referred to within the “Item” message and the full pathname of the item's parent to check if the item described in the message is really being accessed from a remote host. For file items, the example embodiment of the preferred invention checks the list of filesystems mounted from remote hosts to determine if an item is local or remote. Similarly, any other type of remote item may be determined by resolving the path name of the item and its parent and matching the resolved path name to a list of remotely accessible data item types and sets. If the item referred to by the “Item” message is remote, execution proceeds to step 26-2.

Step 26-2 invokes the sub-module already described in FIG. 24 to send a “Remote” message for a “Remote Change Report” to the remote host from which the data item is being accessed. The “Remote Change Report” contains the “Item” message information as well as an identifier for the current change session and change process. After step 26-2, execution of the sub-module completes and returns to the invoking sub-module.

If step 26-1 determines that the item is not remote, execution proceeds to step 26-3, in which the record for the most recent version for the item is looked up in the change tracer database 301, using the item parent path and item name. The item version found in the database is referred to as the former Item. If the item referred to by the “Item” message does not exist within the change tracer database 301, or has the ItemDeleted bit set in the ItemFlags field 704-j, the former Item will refer to a null item. In the example embodiment of the present invention, items are identified in messages by their name and full pathname or their parent. Item messages do not include any ItemID or ItemVersion fields because these fields are only used by the change tracer database 301 and session module 603 to uniquely identify an item version record within the Changes table 703, Items table 704 and Links table 705. All other modules refer to items using the item name and the full pathname of the item's parent item. Therefore, step 26-3 maps the item name and full pathname of the item's parent item from the “Item” message to the ItemID field 704-a and ItemVersion field 704-b of the most recent item version record representing the item.

Execution proceeds to step 26-4, which checks if the message is either of “Item Baselined” or “Item Added”. If so, execution proceeds to step 26-5 which checks if the new item information described in the item message is the same as the former Item obtained from the change tracer database 301 in step 26-3. Two items are considered the same if all fields of the item described in the item message are the same as corresponding fields from the change tracer database. If step 26-5 determines the new item information in the item message same as the item in the database, execution of the sub-module completes since no detectable change has occurred. If step 26-5 determines the item information in the message is not the same as the former item, then execution proceeds to step 26-6, which creates a new item record in the Items table 704 for the item identified in the message. This new item record will have a newly generated ItemID field 704-a and an ItemVersion field 704-b set to 0 if the former Item is null. If the former Item is not null, the new item record will have the same ItemID field 704-a as the former Item and the ItemVersion field 704-b of the former Item incremented by one. In this step, and in all steps of this sub-module where an item record is created or updated, the ItemParentID field 704-c, ItemName field 704-d, ItemValue field 704-e, ItemType field 704-f, ItemSize field 704-g, ItemTime field 704-h and ItemMetadata field 704-l are all set using the current values of the item, as provided in the “Item” message. Based on the size and type of the item, the example embodiment of the preferred invention determines whether the ItemValue field 704-e is stored as a full value, a hash code or a reverse delta difference. If stored as a delta, then the most recent version of the item is always updated to be the complete, current contents or value of the item and a new reverse delta from the current contents to the ItemValue field 704-e of the former Item replaced the ItemValue field 704-e of the former Item. The ItemDeleted bit in the ItemFlags field 704-j is cleared. If the item type is any form of link, then the ItemLinked bit in the ItemFlags field 704-j is set, otherwise it is cleared. Further, if the item type is any form of link, the value of the item as described in the “Item” message will the target of the link, which is used to identify the link target ItemID and then create or update two records in the Links table 705, one for the new ItemID and one for the target ItemID as field 705-a, with the LinkType field 705-b set to the type specified in the “Item” message, and the LinkInfo field containing any information indicating the direction of the link, if the link is an asymmetric shortcut or symbolic link or other such reference. Hard links in any POSIX® system are considered symmetric since all the linked items are just names linked to the same underlying data contents and metadata. If any shortcut or symbolic link records in the Links table 705 refer to the former item, they are updated to refer to the newly created item record and their LinkInfo field 705-c is updated to remove any dangling or unresolved status.

Execution proceeds to step 26-7, which checks if the “Item” message is an “Item Added” message. If so, execution proceeds to step 26-8, which creates a new change record in the “Changes” table 703 of the change tracer database 301, with the ItemID field 703-a and itemVersion field 703-b set to the ItemID field 704-a and ItemVersion field 704-b of the newly created item record from step 26-6. The ChangeTime field 703-c is set to the time that the “Item” message was sent, and the ChangeType field 703-d is set to “Add”. The ChangeInfo field 704-e will be set to null, or may indicate if any links were updated. After the new change record is created, execution of the sub-module completes and returns to the invoking module. If step 26-7 determines that the “Item” message is not an “Item Added”, it must be an “Item Baselined” message, therefore no change record is necessary so execution of the sub-module completes and returns to the invoking module.

If the “Item” message is neither an “Item Baselined” nor an “Item Added” message in step 26-4, execution proceeds to step 26-9, which checks if the “Item” message is an “Item Deleted” message. If so, execution proceeds to step 26-10 in which the ItemDeleted bit of the former Item's ItemFlags field 704-j is set. Execution proceeds to step 26-11, in which a new change record is created in the Changes table 703, with the ItemID field 704-a set to the ItemID field 704-a of the former Item. The ItemVersion field 704-b is set to the ItemVersion field 704-b of the former Item. The ChangeTime 704-e is set to the time that the “Item” message was sent, and the ChangeType field 703-d is set to “Delete”. The ChangeInfo field 703-e may be updated if the item is a parent of any child items to indicate that the child items will be deleted as part of this change. Execution proceeds to step 26-12, in which the item is deleted from the Links table 705. If any symbolic links or shortcuts are linked to the deleted item, their LinkInfo field 705-c is updated to indicate that they are now dangling or un-resolvable links. If the item being deleted results in only a single remaining item in a set of linked items, then the reference to the remaining item is removed from the Links table 705 and the ItemLinked flag is cleared from the ItemFlags field 704-j of the remaining item. Execution proceeds to step 26-13, which checks if the deleted item is the parent of any other items and recursively invokes this same sub-module to perform “Item Deleted” operations on all child items that have this deleted item as a parent. After the recursive invocations to this sub-module complete, execution of the sub-module completes and returns to the invoking module.

If step 26-9 determines that the “Item” message is not an “Item Deleted”, execution proceeds to step 26-14, which checks if the “Item” message is an “Item Changed” message. If so, execution proceeds to step 26-15, in which a new item record is created, using the fields from the “Item” message, the same ItemID field 704-a as the former Item, the ItemVersion field 704-b as the next sequence value after the ItemVersion field 704-b of the former Item, an increment of one in the example embodiment. All other fields are set from the “Item” message. Execution proceeds to step 26-16 in which a new change record is created in the Changes table 703, with the ItemID field 704-a and ItemVersion field 704-b set to the ItemID field 703-a and ItemVersion field 703-b of the newly created item record from step 26-15. The ChangeTime 704-c is set to the time that the “Item” message was sent, and the ChangeType field 703-d is set to “Change”. The ChangeInfo field 703-e is set to a description listing the type and scope of the change, indicating whether the item value or metadata or both changed, whether the item grew, shrank or was truncated or renamed, whether any child nodes or links were affected and an indicator of the size difference of the change in terms of number of characters and lines added or deleted between the two items. Additional information describing the change may be added to or removed from the ChangeInfo field 703-e without departing from the scope of the invention. After the new change record is created, execution proceeds to step 26-17 in which the Links table 705 is updated if the item change resulted in any changes in the target of a link. After checking the Links table 705, execution of the sub-module completes and returns to the invoking module.

“Item” messages may be optimized within the scope of the invention to only contain those fields that are detected as different if the item already exists, since the remaining fields may be copied from the former Item. Combinations of operations on multiple items, either remote or local may be handled without departing from the scope of the present invention by decomposition into the operations described in the example embodiment of the present invention. Embodiments of the present invention may choose to limit the number of changes in various ways, by setting a maximum on the number of changes for any item, by time periods, by parent, or by types of items or changes, or other conditions without departing from the scope of the present invention. Embodiments of the present invention may choose various ways to reduce storage of changes by removing older changes, more frequent changes, or by implementing other user-specified policies to prune or age records from the database. Any sequence of changes that may be condensed to an equivalent change sequence may be stored as the equivalent change sequence or as the original change sequence without departing from the scope of the present invention. The links table may be used to provide information about multiple interlinked data items affected by a single change, which may be reported as a single change for all interlinked items, one change for each linked item or any grouped combination thereof without departing from the scope of the invention.

Session Module Query Messages

FIG. 27 shows in simplified block diagram form a sub-module to handle “Query” messages as part of the session module 603 of the example embodiment of the present invention. Step 27-1 checks if the message is a “Query Item” message. If so, step 27-2 looks up the information for the item name and parent path specified in the message from the change tracer database 301 and responds with the information from the most recent item version in the Items table. Since multiple sessions may be active at any time, and some sessions may have reported changes to an item as part of a still-continuing but not-yet-committed session, the change tracer database contains caching logic to keep track of the most recent version of the item, even if the change session with the most recent change has not yet been committed. After responding with the information about the queried item, execution of this sub-module completes and returns to the invoking module.

If the message was not a “Query Item” message in step 27-1, execution proceeds to step 27-3, which checks if the message is a “Query Items in Dir” message for a specified parent item. If so, step 27-4 looks up information for the most recent item version for all items which have an ItemParentID field 704-c corresponding to the specified parent, and responds with information for all those matching child items. Execution of the sub-module then completes and returns to the invoking module.

If the message was not a “Query Items in Dir” message in step 27-3, execution proceeds to step 27-5, which checks if the message is a “Query Execute” message. If so, step 27-5 executes the specified general query from the message and responds with the results of that query. General queries may include a limit, or embodiments may have a maximum limit imposed on elapsed time, memory or size of response without departing from the scope of the present invention. In order to provide the most current results, embodiments may perform a commit of all uncommitted sessions before executing the specified query without departing from the scope of the present invention. After step 27-5 or step 27-6, execution of the sub-module completes and returns to the invoking module.

Many forms of encoding queries and results, as well as executing queries may be used without departing from the scope of the present invention. Various forms of cache management, indexing, compression, normalization or de-normalization of database tables, objects or entries may be used to improve query speed or reduce storage or memory requirements without departing from the scope of the present invention.

Session Module Remote Messages

FIG. 28 shows in simplified block diagram form a sub-module to handle “Remote” messages as part of the session module 603 of the example embodiment of the present invention. The “Session”, “Item” and “Query” messages described thus far are all sent by other modules of the same change tracer, executing on the same computer as the session module. The “Remote” messages handled by the sub-module described in FIG. 28 are sent by the session module of a remote change tracer, executing on a different computer. Step 28-1 checks if the message is a “Remote Trace Request” message. If so, execution proceeds to step 28-2, which checks if this “Remote Trace Request” message is the first from a remote change session on a remote host. If so, then a new change session needs to be created, therefore execution proceeds to step 28-3, which invokes the sub-module previously described in FIG. 23 to handle a “Session Begin” message to create a new change session, with the OrigHost field 700-e set to the identifier of the remote host that sent the “Remote Trace Request” message, the OrigType field 700-f set to indicate the change session is originated in response to a “Remote Trace Request” message and the OrigCSID field 700-g set to indicate the remote CSID identifier of the change session within which the “Remote Trace Request” originated. All Remote Trace Request messages contain the number of preceding change sessions started by remote messages that led up to the transmission of this “Remote Change Request” message, as stored in the NumOrigHops 700-t field of the remote change session from which the message was sent. The local change session record stores this number incremented by one. The initial change process record created with the new change session will use the remote CPID identifier of the change process within which the “Remote Trace Request” originated as the OrigCPID field 701-f. After the sub-module for the “Session Begin” completes and returns, execution proceeds to step 28-4. If step 28-2 determines that a new change session record is not needed because a change session record corresponding for this <remote host, remote CSID, remote CPID>tuple already exists, the new trace will be part of the existing change session. Execution proceeds to step 28-4, which invokes the sub-module previously described in FIG. 25 to handle the remote trace request. In the example embodiment of the present invention, the recorder module to handle the trace request will execute asynchronously, permitting the sub-module that handles the “Remote” message to proceed to step 28-5 in which it responds with the unique identifier of the local change session CSID, the unique identifier of the local change process CPID, and the NumProcs field 700-q, NumChanges field 700-r and NumRemote field 700-s. After step 28-5, execution of the sub-module completes and returns to the invoking module. If the remote host permissions do not allow the trace specified in the message, then execution of the sub-module completes and returns to the invoking module.

If step 28-i determines the message is not a “Remote Trace Request” message, execution proceeds to step 28-6, which checks if the message is a “Remote Change Report” message. If so, execution proceeds to step 28-7, which checks if this is the first Remote Change Report message from the specified change session on the remote host sending the message. If so, a new change session is created in step 28-8 by invoking the sub-module previously described in FIG. 23 to handle a “Session Begin” message to create a new change session, with the OrigHost field 700-e set to the identifier of the remote host that sent the “Remote Change Report” message, the OrigType field 700-f set to indicate the change session is originated in response to a “Remote Change Report” message and the OrigCSID field 700-g set to indicate the remote CSID identifier of the change session within which the “Remote Change Report” originated. All Remote Change Report messages contain the number of preceding change sessions started by remote messages that led up to the transmission of this “Remote Change Request” message, as stored in the NumOrigHops 700-t field of the remote change session from which the message was sent. The local change session record stores this number incremented by one. The initial change process record created with the new change session will use the remote CPID identifier of the change process within which the “Remote Change Report” originated as the OrigCPID field 701-f. After the sub-module for the “Session Begin” completes and returns, execution proceeds to step 28-9. If step 28-7 determined that this was not the first remote change report from the change session on the remote host that sent this message, then execution proceeds to step 28-9, which checks if this remote change report is caused by a commit from the change session which sent it. If so, execution proceeds to step 28-10, invoking the sub-module described in FIG. 21 to commit the local change session that corresponds to the remote change session from the remote host that sent the message. The status for the commit is extracted from the message. After the commit, execution proceeds to step 28-5, as described already. If step 28-9 determines that the message is not a remote change report caused by a commit, then execution proceeds to step 28-11, which extracts from the remote message an encapsulated “Item” message containing information describing the item changed by the remote host. Step 28-12 invokes the sub-module previously described in FIG. 26 is invoked to handle the “Item” message that was encapsulated in the “Remote Change Report” message from the remote change tracer. After the sub-module for handling the “Item” message completes and returns, execution proceeds to step 28-5. If step 28-6 determines the message is not a “Remote Change Report” message, then execution proceeds to step 28-13, which checks if the message is a “Remote Trace Response”, received from a remote change tracer to indicate the completion of either a “Remote Trace Request” message or “Remote Change Report” message. If so, execution proceeds to step 28-14. If this message is the first response to a remote change initiation, then step 28-14 uses the remote change session identifier and remote change process identifier from the message to update the RemoteCSID field 702-b and RemoteCPID field 702-c respectively in the record representing the message that the response corresponds to, in the RemoteChangeInitiations table. The statistics in the message are used to update the RemoteNumProcs field 702-f, RemoteNumChanges 702-g, RemoteNumRemote field 702-h fields in the remote change initiation record. After either step 28-13 or 28-14, execution of the sub-module completes and returns to the invoking module.

Various forms of encoding, compressing, encrypting, authenticating, integrity-checking or sequencing the messages between remote change tracers may be used without departing from the scope of the present invention. Various data errors and exceptional conditions reported by the operating system process environment in embodiments of the present invention may need to be implemented to provide a user of the present invention with suitable error messages without departing from the scope of the invention.

In the example embodiment of the present invention, all modules of the change tracer provide the user of the invention with various informational displays describing the progress of the invention and indications of success or failure. The level of verbosity of such messages may be controlled by options to the change tracer program modules, in order to permit interactive user from either a text-oriented command line interface or a graphical user interface, as well as to permit use from scheduled or batch command execution facilities. Multiple sets of such informational messages in different natural languages, character sets, symbols, colors, fonts and other visual attributes may be provided for user-selection as part of embodiments of the present invention. Various forms of implementing such informational displays may be used without departing from the scope of the present invention.

Components of an embodiment of the present invention or a complete embodiment may be implemented as part of or embedded within an operating system, network interface or data store. Moreover, although the embodiments disclosed herein are implemented in software, the inventions herein set forth are in no way limited exclusively to implementation in software, and expressly contemplate implementation as a system in firmware and silicon-based or other forms of hard-wired logic, or combinations of hard-wired logic, firmware and software or any suitable substitutes therefore.

Advantages

The essential advantages of the present invention are that it builds and maintains a complete change history database of changes to data items within a computer system, automatically recording the processes that make the changes, allowing the user to organize changes and processes as sessions and record the rationale for changes, as well as other identifiers or tag fields. The type of data items for which changes are recorded is not limited, therefore the invention can be used to record changes to files, registry entries, hardware devices and their configuration, structured data, etc. The invention has clear namespace and identification conventions for different types of data items, permitting the easy addition of new data item types to the system. The change history organization provides powerful query capabilities to find, examine and select changes based on user-specified logical combinations of boolean operations on any data item, change, change process or change session attributes. By recording the actual content differences for changes within data items, and not merely recording the fact that a change happened, the invention provides the insight necessary for diagnosis of a wide variety of system problems. Since changes and the content of such changes may be searched and selected by query in a variety of output formats, the invention makes the comparison, reversal or repetition of selected changes easy.

By tracing system call API activity of the process making the change, logical relationships between changes are preserved, identifying precisely where, when, how and in what sequence changes happen. Renames of items are immediately identified and their effect is easily noted, unlike prior snapshot-based approaches, in which renaming often causes the illusion of many items being deleted and then being added back under a different name. By detecting and recording linkage and dependencies between items explicitly, the invention tracks the impact of change effects across different items, thus following, recording and reporting any changes that may cascade from one item to another across links.

Tag fields on sessions and authorization rules provide identification, description, authorization, authentication and other information for changes within a change session and allow integration of the present invention within workflow approaches commonly used to dispatch and manage systems administration personnel. The organization of changes in sessions with user tag fields also allows any periodic scans to easily observe any changes that were not made within an authorized session, thus indicating that policies or guidelines are not being followed. Immediate alerts based on rule conditions being matched on a change can notify users of changes, such alerts are efficiently grouped using change session organization to avoid flooding a user with alerts when many data items change within a single session. The invention provides copies of session data to facilitate integration into other system management software and systems, as well as provide backup or centralized copies of change data in a distributed network environment.

Since the invention only needs to be activated when a user begins a change session and automatically deactivates at the end of a session, it is very efficient in its use of CPU or disk bandwidth. By storing a baseline and a change history, the invention is also very efficient in its use of system storage. Logical transformations and reductions performed on changes condense and reduce intermediate or redundant changes, both for storage efficiency and to make the actual change clearer to the user upon presentation, display or query.

The dynamic, automatic remote change update and remote change tracer activation upon remote trace request messages makes the invention very effective within a distributed, networked computing environment. Changes are always recorded at the source of the change, on every intervening node and on the system holding the actual item. Linkage across remote systems is preserved so that the trail of a remotely initiated change can be easily followed when analyzing or reversing changes.

Conclusions, Ramifications and Scope

Thus, the present invention provides a system for recording and managing an efficient, accurate and complete history of changes made to data items within a computer system and a network of computer systems. The users of the invention may control the set of data items in which changes should be recorded. System call activity of specified processes is traced and analyzed to detect changes as they are made and to record only those changes of interest, organized as. Periodic scans of all specified data items can be used to obtain initial baselines as well as check for changes that were made outside authorized or properly traced sessions.

While the present invention has been particularly shown and described with many specific details with reference to an example embodiment of the present invention within an exemplary operating system process environment and computer hardware, various changes in form and details may be made therein without departing from the spirit and scope of the invention.

1. A method for managing changes in a computer system comprising the steps of:
selecting processes on the computer system in accordance with input specifications, detecting changes made by the selected processes to data items, and storing the detected changes as records in a database.

2. The method of claim 1 further comprising the step of limiting the detection of changes to only data items matching specified criteria.

3. The method of claim 1 further comprising the step of selecting change records from the database pursuant to specified criteria.

4. The method of claim 3 further comprising the step of producing the selected change records in a specified output format.

5. The method of claim 3 further comprising the steps of:
determining the reverse of the changes stored in the selected change records, and
applying the reverse of the selected change records to the data items referred to by the selected change records in order to return the data items to their state prior to the occurrence of the changes stored in the selected change records.

6. The method of claim 3 further comprising the step of applying the changes stored in the selected change records to similar data items on a different computer system to cause the same changes on the different computer system.

7. The method of claim 1 further comprising the step of storing the reverse of the detected changes as change records in the database.

8. The method of claim 7 further comprising the steps of:
selecting change records from the database pursuant to specified criteria, applying the reverse of the selected change records to the data items referred to by the selected change records in order to return the data items to their state prior to the occurrence of the changes stored in the selected change records.

9. The method of claim 1 further comprising the steps of:
condensing sequences of change records to eliminate intermediate changes, and storing the condensed sequences in the database.

10. The method of claim 1 further comprising the step of adding a user-specified field to a change record in the database.

11. The method of claim 1 further comprising the step of terminating the detection of changes upon the occurrence of any of (i) user request, (ii) the satisfaction of conditions specified by the user, or (iii) termination of all selected processes.

12. The method of claim 1, further comprising the step of detecting links from a data item to other data items.

13. The method of claim 1, further comprising the step of detecting changes made by one or more of the selected processes to a first data item resulting from changes to a second data item linked to the first data item.

14. The method of claim 1 further comprising the step of alerting a user when changes matching specified criteria are detected.

15. The method of claim 1 further comprising the step of transmitting information about the detected changes to a specified destination.

16. The method of claim 1 further comprising the steps of:
detecting changes to data items on a remote computer system by selected processes on the computer system prior to storing the changes as change records in the database,
recording the identity of the remote computer system in the database, and associating the identity of the remote computer system with the change in the stored change record.

17. The method of claim 1 further comprising the step of detecting communication attempts by the selected processes.

18. The method of claim 17 further comprising the steps of:
determining any processes that are the destination of the communication attempts,
detecting changes made by the destination processes to data items, and
storing the detected changes as change records in the database.

19. The method of claim 17 further comprising the steps of:
detecting that the communication attempts are to processes on a remote computer system,
determining any processes on the remote computer system that are the destination of the communication attempts,
detecting changes made by the destination processes to data items, and
storing the detected changes as change records in the database.

20. The method of claim 1 further comprising the steps of:
recording selected processes or detected changes in a session history, and
storing the session history as a session record in the database.

21. The method of claim 20 further comprising the steps of:
searching the database for any session records matching specified criteria, selecting change records referred to by the matching session records, and
producing the selected change records in a specified output format.

22. The method of claim 20 further comprising the steps of:
condensing sequences of change records in the session history to eliminate intermediate changes, and
storing the condensed session history as a session record in the database.

23. The method of claim 20 further comprising the step of adding a user-specified field to the session record.

24. The method of claim 20 further comprising the step of adding additional processes to an existing session history.

25. The method of claim 20 further comprising the step of terminating the session history upon the occurrence of any of (i) user request, (ii) the satisfaction of conditions specified by the user, or (iii) termination of all selected processes.

26. The method of claim 20 further comprising the step of alerting a user when a session history matching specified criteria is detected.

27. The method of claim 20 further comprising the step of transmitting information about the session history to a specified destination.

28. The method of claim 20 further comprising the steps of:
detecting changes within the session history to data items on a remote computer system,
recording the identity of the remote computer system in the database, and
associating the session history with the identity of the remote computer system in the database.

29. The method of claim 20 further comprising the step of detecting communication attempts by the selected processes.

30. The method of claim 29 further comprising the steps of
determining any processes that are the destination of the communication attempts,
detecting changes made by the destination processes to data items,
recording the detected changes in a session history, and
storing the session history as a session record in the database.

31. The method of claim 29 further comprising the steps of
detecting that the communication attempts are to processes on a remote computer system,
determining any processes on the remote computer system that are the destination of the communication attempts,
detecting changes made by the destination processes to data items,
recording the detected changes in a session history, and
storing the session history as a session record in the database.

32. A computer program product for managing changes in a computer system, comprising a computer program encoded on a computer-readable media and executable on a computer to:
select processes on the computer system in accordance with input specifications,
detect changes made by the selected processes to data items, and
store the detected changes as change records in a database.

33. The computer program product of claim 32 wherein said computer program limits the detection of changes to only data items matching specified criteria.

34. The computer program product of claim 32 wherein said computer program selects change records from the database pursuant to specified critieria.

35. The computer program product of claim 34 wherein said computer program provides the selected change records in a specified output format.

36. The computer program product of claim 34 wherein said computer program:
determines the reverse of the changes stored in the selected change records, and
applies the reverse of the selected change records to the data items referred to by the selected change records in order to return the data items to their state prior to the occurrence of the selected change records.

37. The computer program product of claim 35 wherein said computer program applies the selected change records to similar data items on a different computer system to cause the same changes on the different computer system.

38. The computer program product of claim 32 wherein said computer program stores the reverse of the detected changes as change records in the database.

39. The computer program product of claim 38 wherein said computer program:
selects specified change records from the database pursuant to specified criteria,
applies the reverse of the selected change records to the data items referred to by the selected change records in order to return the data items to their state prior to the occurrence of the selected change records.

40. The computer program product of claim 32 wherein said computer program:
condenses sequences of change records to eliminate intermediate changes, and
stores the condensed sequences in the database.

41. The computer program product of claim 32 wherein said computer program adds a user-specified field to a change record in the database.

42. The computer program product of claim 32 wherein said computer program terminates the detection of changes upon the occurrence of any of (i) user request, (ii) the satisfaction of conditions specified by the user, or (iii) termination of all selected processes.

43. The computer program product of claim 32, wherein said computer program detects links from a data item to other data items.

45. The computer program product of claim 32, wherein said computer program detects changes made by one or more of the selected processes to a first data item resulting from changes to a second data item linked to the first data item.

46. The computer program product of claim 32 wherein said computer program alerts a user when changes matching specified criteria are detected.

47. The computer program product of claim 32 wherein said computer program transmits information about the detected changes to a specified destination.

48. The computer program product of claim 32 wherein said computer program detects changes to data items on a remote computer system by selected processes on the computer system prior to storing the changes in the database,
records the identity of the remote computer system in the database, and
associates the identity of the remote computer system with the change in the stored change record.

49. The computer program product of claim 32 wherein said computer program detects communication attempts by the selected processes.

50. The computer program product of claim 49 wherein said computer program
determines any processes that are the destination of the communication attempts,
detects changes made by the destination processes to data items, and
stores the detected changes as change records in the database.

51. The computer program product of claim 49 wherein said computer program
detects that the communication attempts are to processes on a remote computer system,
determines any processes on the remote computer system that are the destination of the communication attempts,
detects changes made by the destination processes to data items, and
stores the detected changes as change records in the database.

52. The computer program product of claim 32 wherein said computer program
records specified changes in a session history, and
stores the session history as a session record in the database.

53. The computer program product of claim 52 wherein said computer program:
searches the database for any session records matching specified criteria,
selects change records referred to by the matching session records, and
produces the selected change records in a specified output format.

54. The computer program product of claim 52 wherein said computer program:
condenses sequences of changes in the session history to eliminate intermediate changes, and
stores the condensed session history as a session in the database.

55. The computer program product of claim 52 wherein said computer program adds a user-specified field to the session history.

56. The computer program product of claim 52 wherein said computer program adds additional processes to an existing session history.

57. The computer program product of claim 52 wherein said computer program terminates the session history upon the occurrence of any of (i) user request, (ii) the satisfaction of conditions specified by the user, or (iii) termination of all selected processes.

58. The computer program product of claim 52 wherein said computer program alerts a user when a session history matching specified criteria is detected.

59. The computer program product of claim 52 wherein said computer program transmits information about the session history to a specified destination.

60. The computer program product of claim 52 wherein said computer program detects changes in the session history to data items on a remote computer system prior to storing the session record in the database,
records the identity of the remote computer system in the database, and
associates the identity of the remote computer system with the session record in the searchable database,

61. The computer program product of claim 52 wherein said computer program detects communication attempts by the selected processes.

62. The computer program product of claim 61 wherein said computer program
determines any processes that are the destination of the communication attempts,
detects changes made by the destination processes to data items,
records the detected changes in a session history, and
stores the session history as a session in the searchable database.

63. The computer program product of claim 61 wherein said computer program detects that the communication attempts are to processes on a remote computer system,
determines any processes on the remote computer system that are the destination of the communication attempts,
detects changes made by the destination processes to data items,
records the detected changes in a session history, and
stores the session history as a session in the searchable database.

64. A data structure for facilitating management of changes in a computer system, comprising a database stored on a computer-readable media, the database having a plurality of change records, wherein each change record corresponds to a change to a data item by a process, comprising information that refers to the identity of data item changed, the process or processes effecting the change, and the nature of the change.

65. The data structure of claim 64 in which the change record further comprises information referring to the user initiating a change.

66. The data structure of claim 64 in which the change record further comprises descriptive or identifying information about the change.

67. The data structure of claim 64 in which the database further comprises link records, wherein each link record comprises information that refers to a relationship between data items.

68. The data structure of claim 64 in which the database further comprises session records, wherein each session record comprises information that refers to a plurality of changes in a session history.

69. The data structure of claim 68 in which the session record further comprises information referring to the user initiating the session history.

70. The data structure of claim 68 in which the session record further comprises descriptive or identifying information about the session history.

71. The data structure of claim 68 in which the session record further comprises information generated during the session history whereby the session record contains a count of any of (i) the number of changes detected (ii) the number of processes selected (iii) the number of linked data items changed (iv) the number of remote change sessions initiated.

72. The data structure of claim 68 in which the session record further comprises information with the identity of remote computer systems that were affected by changes in the session history referred to by the session record.

73. The data structure of claim 72 in which the session record further comprises information referring to remote session records on remote computer systems that were affected by changes in the session history referred to by the session record.

74. A computer program product for managing changes in a computer system, comprising a computer program encoded on a computer-readable media and executable on a computer to:
perform searches in a database containing historical information of changes made by processes within the computer system to data items or links to data items, and produce the results of said searches in a specified output format.

75. The computer program product of claim 74 wherein a plurality of changes in the database are recorded in sessions which are stored as session records in the database.

76. The computer program product of claim 75 wherein remote computer systems are associated with session records in the database.
